(19) United States
(12) Patent Application Publication
(10) Pub. No.: US 2026/0025888 A1
(43) Pub. Date: Jan. 22, 2026

(54) METHOD OF CONTROLLING A MULTI-CHANNEL LIGHT-EMITTING DIODE LIGHT SOURCE

(71) Applicant: Lutron Technology Company LLC, Coopersburg, PA (US)

(72) Inventors: Mark A. Benning, Allentown, PA (US); Ryan M. Bocock, Austin, TX (US); Venkatesh Chitta, Center Valley, PA (US); Jaxon S. Coward, Austin, TX (US); Mark Eiding, Quakertown, PA (US); Mark Ryan Lopez, Lansdale, PA (US); Harsh Hitesh Mehta, Bethlehem, PA (US); Jaykrishna A. Shukla, Mays Landing, NJ (US); David L. Wykes, JR., Quakertown, PA (US); John F. Yamrick, Souderton, PA (US)

(73) Assignee: Lutron Technology Company LLC, Coopersburg, PA (US)

(21) Appl. No.: 19/274,374

(22) Filed: Jul. 18, 2025

Related U.S. Application Data
(60) Provisional application No. 63/673,476, filed on Jul. 19, 2024.
(60) Provisional application No. 63/749,815, filed on Jan. 27, 2025.
(60) Provisional application No. 63/803,285, filed on May 9, 2025.

(51) Int. Cl. H05B 45/325; H05B 45/10; H05B 45/20; H05B 47/16

(52) U.S. Cl. CPC H05B 45/325; H05B 45/10; H05B 45/20; H05B 47/16

(57) ABSTRACT

A load control device may include first, second, and third drive circuits for controlling respective ones of the emitter circuits, and may generate first, second, and third drive signals for controlling each of the first, second, and third drive circuits, respectively, to adjust a present color of the cumulative light emitted by the emitter circuits towards a target color. The control circuit may be configured to pulse-width modulate the first, second, and third drive signals on a periodic basis at an operating period, where each period comprises at least three time slots. The control circuit may be configured to determine first, second, and third on times of the first, second, and third drive signals of the first, second, and third pulses, respectively, based on the target color.

### CROSS-REFERENCE TO RELATED APPLICATIONS

This application claims priority from Provisional U.S. Patent Application No. 63/803,285, filed May 9, 2025, Provisional U.S. Patent Application No. 63/749,815, filed Jan. 27, 2025, and from Provisional U.S. Patent Application No. 63/673,476, filed Jul. 19, 2024, the entire disclosures of which are hereby incorporated by reference herein in their entirety.

### BACKGROUND

During the installation of typical load control systems, standard mechanical switches, such as traditional toggle switches or decorator paddle switches, may be replaced by more advanced load control devices, such as dimmer switches, that control the amount of power delivered from an alternating current (AC) power source to one or more electrical loads. Such an installation procedure typically requires that the existing mechanical switch be disconnected from the electrical wiring and removed from a wallbox in which it is mounted, and that the load control device then be connected to the electrical wiring and installed in the wallbox. An average consumer may not feel comfortable performing the electrical wiring required in such an installation. Accordingly, such a procedure may typically be performed by an electrical contractor or other skilled installer. However, hiring an electrical contractor may be cost prohibitive to the average consumer.

Controllable light sources, such as controllable screw-in light-emitting diode (LED) lamps, may provide an easier solution for providing advanced control of lighting. For example, an older incandescent lamp may simply be unscrewed from a socket and the controllable light source may be screwed into the socket. The controllable light sources may be controlled by remote control devices. However, the sockets in which the controllable light sources are installed may be controlled by an existing wall-mounted light switch. When the wall-mounted light switch is operated to an off position, power to the controllable light source may be cut, such that the controllable light source may no longer respond to commands transmitted by the remote control devices. Accordingly, it is desirable to prevent operation of such a wall-mounted light switch to ensure that the delivery of power to the controllable light source continues uninterrupted.

### SUMMARY

Examples of a load control device for controlling a light source having two or more emitter circuits are described herein. The load control device may include first, second, and third drive circuits for controlling respective ones of the emitter circuits. The control circuit may be configured to generate first, second, and third drive signals for controlling each of the first, second, and third drive circuits, respectively, to adjust a present color of the cumulative light emitted by the emitter circuits towards a target color. The control circuit may be configured to pulse-width modulate the first, second, and third drive signals on a periodic basis at an operating period, where each cycle of operation comprises at least three time slots. The control circuit may be configured to generate a first pulse in the first drive signal for at least a portion of a first time slot of each cycle of operation, generate a second pulse in the second drive signal for at least a portion of a second time slot of each cycle of operation, and generate a third pulse in the third drive signal for at least a portion of a third time slot of each cycle of operation. The control circuit may be configured to determine first, second, and third on times of the first, second, and third drive signals of the first, second, and third pulses, respectively, based on the target color.

The control circuit may be configured to generate the first, second, and third pulses to be characterized by the first, second, and third on times, respectively, and where each of the first, second, and third time slots are characterized by first, second, and third slot times, respectively. A peripheral direct-memory access controller of the control circuit may be configured to reconfigure the timer peripheral for generation of at least one of the first, second, and third drive signals during a subsequent time slot. The load control device may include a memory configured to store data for reconfiguring the timer peripheral. The peripheral direct-memory access controller of the control circuit may be configured to retrieve data representing the first, second, and third on times of the first, second, and third pulses, respectively from memory for reconfiguring the timer peripheral.

The data retrieved from the memory may represent the first, second, and third on times of the first, second, and third pulses, respectively, and the first, second, and third slot times of the first, second, and third time slots, respectively. In response to a change in the target color, the control circuit may be configured to store updated data in the memory for subsequent retrieval by the peripheral direct-memory access controller of the control circuit. The control circuit may be configured to determine duty cycles for determining the first, second, and third on times of the first, second, and third pulses, respectively, in response to the target color. When a target intensity level for controlling the cumulative light emitted by the light source is less than a high-end intensity level, the control circuit may be configured to set the duty cycles such that a dead time exists during which the control circuit does not generate any of the first, second, and third pulses of the first, second, and third drive signals, respectively. When the target intensity level is less than the high-end intensity level, the control circuit may be configured to set the duty cycles such that the dead time exists during the one of the first, second, and third time slots that has the one of the first, second, and third pulses that has the shortest on time, respectively. When the target intensity level is less than the high-end intensity level, the control circuit may be configured to set the duty cycles such that at least one of the first, second, and third on times is less than at least one of the first, second, and third slot times, respectively.

When a target intensity level for controlling the cumulative light emitted by the light source is equal to a high-end intensity level, the control circuit may be configured to set the duty cycles such that the sum of the first, second, and third on times of the first, second, and third pulses, respectively, is approximately equal to the operating period. When the target intensity level is equal to the high-end intensity level, the control circuit may be configured to set the duty cycles such that the sum of the first, second, and third on times are approximately equal to the first, second, and third slot times, respectively. When one of the first, second, and third on times is less than a minimum slot time, the control circuit may be configured to generate the first, second, and third drive signals, such that two of the first, second, and third pulses at least partially overlap.

In some examples, the one of the first, second, and third on times that is less than the minimum slot time is also less than a maximum overlap time.

The control circuit may be configured to use a timer peripheral to generate the first, second, and third drive signals. For example, during the second time slot, the control circuit may be configured to configure the timer peripheral for generation of the third drive signal during the third time slot. During the second time slot, a peripheral direct-memory access controller of the control circuit may reconfigure the timer peripheral for generation of the third drive signal during the third time slot. During the second time slot, the peripheral direct-memory access controller of the control circuit may be configured to reconfigure the timer peripheral for generation of the third drive signals during the third time slot in response to a timer overflow event during the first time slot.

In some examples, the first, second, and third pulses are non-overlapping.

The control circuit may be configured to adjust a present color temperature of the cumulative light emitted by the emitter circuits towards a target color temperature when operating in a color-temperature-control mode, and adjust a present color value of the cumulative light emitted by the emitter circuits towards a target color value when operating in a full-color-control mode.

The load control device may include fourth and fifth drive circuits one controlling respective ones of the emitter circuits. The control circuit may be configured to first, second, and third drive signals for controlling each of the first, second, and third drive circuits, respectively.

When the light source comprises two emitter circuits, the control circuit may be configured to control two of the first, second, and third drive circuits to control the two emitter circuits of the light source.

The control circuit may be configured to hold the operating period constant and adjust the first, second, and third on times by a minimum step size to generate the first, second, and third drive signals, respectively, based on the target color.

The control circuit may be configured to adjust at least one of the first, second, or third drive signals between two adjacent, achievable on times that are separated by the minimum step size during a number of consecutive cycles of operation based on the target color. The target color may be associated with an on time that is not associated with an achievable on time as defined by the minimum step size. In some examples, the control circuit may be configured to store a pattern of on times associated with the first, second, and third drive signals in a memory of the load control device, wherein the pattern defines a plurality of sections, and wherein data stored in each section of the pattern represents the on times and the time slots for generating the first, second, and third drive signals during one period. The control circuit may be configured to adjust the first, second, and third on times to discrete values that are spaced apart by the minimum step size, and wherein the target color is associated with an on time that is between two discrete values. In some examples, one of the discrete values is zero seconds, and the other of the discrete values is a minimum on time. The control circuit may be configured to store a pattern of on times associated with the first, second, and third drive signals in a memory of the load control device. The pattern may define a plurality of sections. Data stored in each section of the pattern may represent the time slots and discrete values of the on times for generating the first, second, and third drive signals during one period. Consecutive sections of the pattern that are associated with a drive signal of the first, second, or third drive signal may define different, discrete values for the on time over the number of consecutive cycles of operation. For example, the control circuit may be configured to determine that the on time for a time slot is greater than or equal to a limited minimum on time within all of the sections of the pattern (e.g., where the limited minimum on time is greater than the minimum on time), and define the pattern such the on times for the time slot are at least as long as the limited minimum on time or are set to zero second within each of the sections of the pattern. The limited minimum on time may be a multiple of the minimum on time.

The control circuit may be configured to compare the number of sections of the pattern during which the on time for the time slot is greater than or equal to the limited minimum on time to the number of sections in the pattern to determine whether the on time for the time slot is less than the limited minimum on time within all of the sections of the pattern.

The control circuit may be configured to determine a first number of the sections of the pattern to set the on time to the limited minimum on time, and determine a second number of sections of the pattern to set the on time to zero seconds (e.g., such that none of the sections have a time duration that is less than the limited minimum on time and greater than zero seconds). For examples, the control circuit may be configured to determine a partial on time that remains after the first number of sections of the pattern are determined (e.g., where the partial on time represents a difference between the total on time for the time slot during the pattern and the time associated to the first number of the sections of the pattern). The control circuit may be configured to store the partial on time in a single section of the pattern.

The control circuit may be configured to add an adjustment amount to one or more of the first number of the sections of the pattern that have on times for the time slot set to the limited minimum on time such that the partial on time is added across the one or more of the first number of the sections of the pattern. The partial on time may equal the adjustment amount times a number of the one or more of the first number of the sections of the pattern. The control circuit may be configured to equally distribute the first number of the sections and the second number of the sections across the pattern. The control circuit may be configured to group the first number of the sections together in the pattern.

In some examples, a load control device for controlling a light source comprising a plurality of emitter circuits may include any combination of the following. The load control device may include a first drive circuit configured to control a first emitter circuit and a second drive circuit configured to control a second emitter circuit. The load control device may include a control circuit that is configured to generate first and second drive signals for controlling the first and second drive circuits, respectively, to adjust a present color of cumulative light emitted by the plurality of emitter circuits towards a target color. The control circuit may be configured to pulse-width modulate the first and second drive signals on a periodic basis at an operating period. The control circuit may be configured to generate a first pulse in the first drive signal and a second pulse in the second drive signal. For example, the control circuit configured to determine first and second on times of the first and second pulses of the first and second drive signals, respectively, based on the target color and/or target intensity level (e.g., such that the first and second pulses of the first and second drive signals are non-overlapping).

In some examples, a load control device for controlling a light source comprising a plurality of emitter circuits may include any combination of the following. The load control device may include a first drive circuit configured to control a first emitter circuit and a second drive circuit configured to control a second emitter circuit. The load control device may include a control circuit that is configured to generate first and second drive signals for controlling the first and second drive circuits, respectively, to adjust a present color of cumulative light emitted by the plurality of emitter circuits towards a target color. The control circuit may be configured to pulse-width modulate the first and second drive signals on a periodic basis at an operating period. Further, the control circuit may be configured to generate a first pulse in the first drive signal and a second pulse in the second drive signal to be characterized by a first on time and a second on time, respectively. For examples, based on the target color and/or target intensity level, the control circuit may be configured to determine the first and second on times of the first and second pulses of the first and second drive signals, respectively. In some examples, the control circuit may be configured to adjust the first, second, and third on times of the first, second, and third pulses, respectively, from one period to a next period (e.g., from one cycle of operation to the next).

### BRIEF DESCRIPTION OF THE DRAWINGS

FIG. 1 depicts an example load control system that includes one or more example remote control devices.

FIG. 2 is a simplified block diagram of an example load control system.

FIG. 3 is a diagram illustrating examples of drive signals generated by a control circuit during a cycle of operation of a driver module for controlling a light source having two emitter circuits.

FIG. 4A is a diagram illustrating examples of drive signals generated by a control circuit during a cycle of operation of a driver module for controlling a light source having five emitter circuits.

FIG. 4B is a diagram illustrating examples of drive signals generated by a control circuit during a cycle of operation of a driver module.

FIG. 4C is a diagram illustrating examples of drive signals generated by a control circuit during a cycle of operation of a driver module.

FIG. 5A is a diagram illustrating examples of drive signals generated by a control circuit a during a cycle of operation of a driver module for controlling a light source having three emitter circuits.

FIG. 5B is a diagram illustrating examples of drive signals generated by a control circuit during a cycle of operation of a driver module.

FIG. 5C is a diagram illustrating examples of drive signals generated by a control circuit during a cycle of operation of a driver module.

FIG. 6 is a diagram illustrating examples of drive signals generated by a control circuit during a cycle of operation of a driver module for controlling a light source having two emitter circuits.

FIG. 7A is a diagram illustrating examples of drive signals generated by a control circuit during multiple cycles of operation of a driver module.

FIG. 7B is a diagram illustrating examples of drive signals generated by a control circuit during multiple cycles of operation of a driver module.

FIG. 8 is a flowchart of an example procedure for controlling a light source at a load control device.

FIG. 9 is a flowchart of an example procedure for controlling a light source at a load control device.

FIGS. 10A and 10B flowcharts of example procedures for controlling a light source at a load control device.

FIGS. 11A and 11B are diagrams of blocks of memory for storing data for controlling a light source at a load control device.

FIGS. 12A and 12B show a flowchart of another example procedure for controlling a light source at a load control device.

FIG. 13 is a flowchart of an example procedure for controlling a light source at a load control device

### DETAILED DESCRIPTION

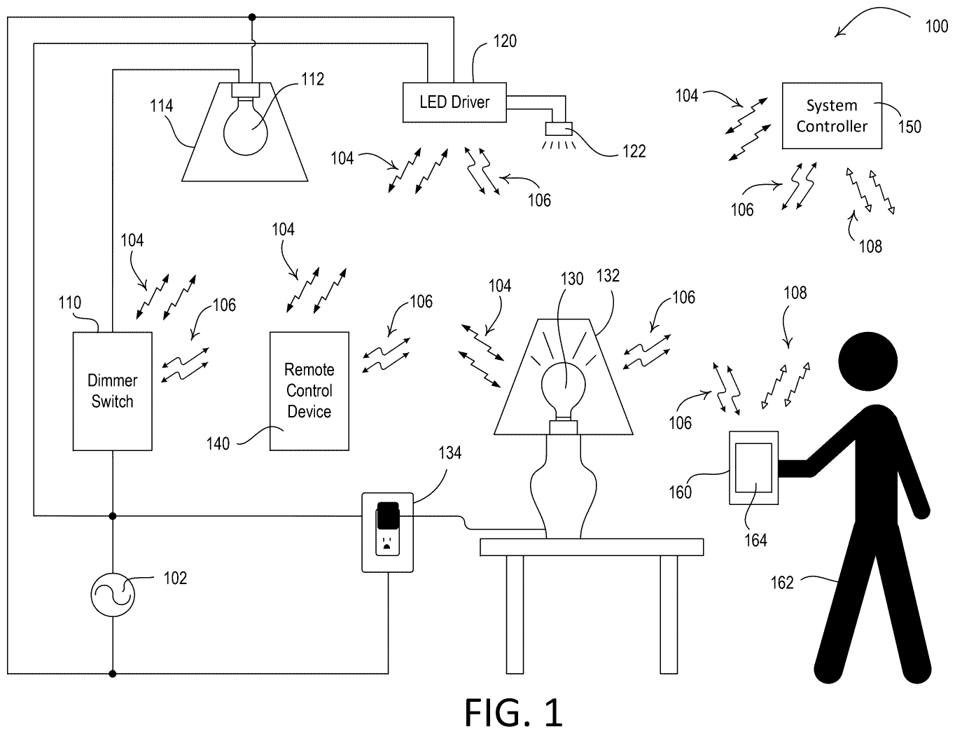

FIG. 1 is a simplified block diagram of an example load control system 100 (e.g., a lighting control system). The load control system 100 may comprise one or more load control devices (e.g., such as lighting control devices) for controlling one or more electrical loads (e.g., such as lighting loads). For example, the load control devices of the load control system 100 may comprise a wall-mounted load control device, such as a dimmer switch 110, which may be electrically coupled between a power source 102 and a light source, such a lighting load 112 (e.g., an external lighting load). The power source 102 may comprise, for example, an alternating-current (AC) power source (e.g., as shown in FIG. 1) and/or a direct-current (DC) power source. The lighting load 112 may comprise a dimmable light source (e.g., such as an incandescent lamp, a halogen lamp, and/or a dimmable light-emitting diode (LED) light source) installed in a lighting fixture 114, such as a ceiling-mounted downlight fixture. The dimmer switch 110 may be configured to control the lighting load 112 using a phase-control dimming technique (e.g., the lighting load 112 may be responsive to a phase-control signal generated by the dimmer switch 110). For example, the dimmer switch 110 may be configured to adjust an intensity level (e.g., a brightness) of the lighting load 112 using the phase-control dimming technique. The dimmer switch 110 may be configured to adjust the intensity level of the lighting load 112 between a low-end intensity level (e.g., a minimum intensity level) and a high-end intensity level (e.g., a maximum intensity level).

The lighting load 112 may be configured to adjust the intensity level of light emitted by the lighting load 112 in response to a firing angle of the phase-control signal received from the dimmer switch 110. In some examples, the lighting load 112 may be configured to also adjust a color (e.g., a color temperature on a black body curve and/or a color value for providing full color control) of the light emitted by the lighting load 112 in response to the phase-control signal according to a relationship between the color temperature and the intensity level set by the phase-control signal (e.g., according to a warm-dim curve). The dimmer switch 110 may comprise a user interface, including one or more buttons configured to be actuated by a user for controlling the lighting load 112. In addition, the dimmer switch 110 may be configured to receive messages (e.g., digital messages) via communication signals, such as wireless signals, e.g., radio-frequency (RF) signals 104, 106. For example, the message may include commands for causing the dimmer switch 110 to control the lighting load 112. In some examples, in addition to generating the phase-control signal, the dimmer switch 110 may be configured to transmit messages including commands for controlling the lighting load 112 (e.g., and/or other lighting loads in the load control system 100). For example, the lighting load 112 may be configured to adjust the intensity level and/or the color (e.g., color temperature and/or color value) of the light emitted by the lighting load 112 in response to the commands received in the messages (e.g., from the dimmer switch 110) via the RF signals 104, 106.

The load control devices of the load control system 100 may also comprise a remotely-located load control device, such as an LED driver 120, for controlling a lighting load, such as LED light source 122 (e.g., an external lighting load). The LED driver 120 may be electrically coupled to the power source 102 for receiving power and may be configured to control the amount of power delivered to the LED light source 122 for controlling an intensity level and/or color (e.g., color temperature and/or color value) of the LED light source 122. For example, the LED light source 122 may comprise one more LED circuits of different colors (e.g., wavelengths and/or color temperatures) that may be mixed together to control a cumulative light emitted by the LED light source 122. The LED light source 122 may comprise, for example, an LED light engine that is external to a housing of the LED driver 120 and installed with the LED driver 120 in a lighting fixture 124, such as a ceiling-mounted downlight fixture. In some examples, the LED light source 122 may comprise a linear light source, such as strip lighting (e.g., tape lighting), which may be characterized by a maximum length L_{STRIP-MAX} (e.g., that may define a maximum distance that one of the LED circuits of the LED light source may extend from the LED driver 120). For example, the LED driver 120 may be a multi-channel LED driver having multiple channels (e.g., outputs) for controlling the differently-colored LED circuits of the LED light source 122. The LED driver 120 may be configured to control the magnitude of drive currents conducted through each of the LED circuits of the LED light source 122 to control the intensity level and/or color of the light emitted by the LED light source 122. The LED driver 120 may be configured to adjust the intensity level of the LED light source 122 between a low-end intensity level (e.g., a minimum intensity level) and a high-end intensity level (e.g., a maximum intensity level). The LED driver 120 may be configured to receive messages (e.g., digital messages) via the RF signals 104, 106. For example, the message may include commands for causing the LED driver 120 to control the LED light source 122. The LED driver 120 may be configured to adjust the intensity level and/or the color (e.g., color temperature and/or color value) of the light emitted by the LED light source 122 in response to the commands received in the messages via the RF signals 104, 106. In some examples, the LED driver 120 may be integrated into the LED light source 122, and the LED light source 122 may be responsive to the command received in the messages via the RF signals 104, 106.

In addition, the load control devices of the load control system 100 may comprise a controllable light source 130 (e.g., such as a smart lamp or smart bulb). The controllable light source 130 may comprise an integral lighting load (e.g., an integral LED light source) included in the same housing as a load control circuit (e.g., an LED drive circuit) for controlling the integral LED light source. For example, the integral LED light source may comprise one more LED circuits of different colors (e.g., wavelengths and/or color temperatures) that may be mixed together to control a cumulative light emitted by the integral LED light source. The controllable light source 130 may be installed into, for example, a table lamp 132 that may be plugged into an electrical outlet 134 (e.g., an electrical receptacle), which may receive power from the power source 102 for powering the controllable light source 130. For example, the electrical outlet 134 may be electrically coupled to the power source 102 via a toggle switch 136 (e.g., a mechanical switch). When the toggle switch 136 is on (e.g., is in a conductive state), the controllable light source 130 may receive power from the power source 102 (e.g., be powered). When the toggle switch 136 is off (e.g., is in a non-conductive state), the controllable light source 130 may be disconnected from the power source 102 (e.g., be unpowered). The load control circuit of the controllable light source 130 may be configured to control an intensity level (e.g., a brightness) and/or a color (e.g., color temperature and/or color value) of the cumulative light emitted by the integral lighting load. The controllable light source 130 may be configured to receive messages (e.g., digital messages) via the wireless signals, e.g., the RF signals 104, 106. For example, the message may include commands for causing the controllable light source 130 to control the integral lighting load. The controllable light source 130 may be configured to adjust the intensity level and/or the color (e.g., color temperature and/or color value) of the light emitted by the integral LED light source in response to the commands received in the messages via the RF signals 104, 106.

The lighting loads of the load control system 100 (e.g., the lighting load 112 controlled by the dimmer switch 110, the LED light source 122 controlled by the LED driver 120, and/or the LED light source of the controllable light source 130) may be capable of multiple means of control. For example, one or more of the lighting loads may be intensity-control capable when the lighting loads are capable of adjusting the intensity level of the light emitted by the lighting load in response to intensity-adjustment commands. In addition, one or more of the lighting loads may be color-temperature-control capable when the lighting loads are capable of adjusting the color temperature of the light emitted by the lighting load in response to color-temperature-adjustment commands. Further, one or more of the lighting loads may be full-color-control capable when the lighting loads are capable of adjusting the color value of the light emitted by the lighting load in response to full-color-adjustment commands. For example, the lighting load 112 controlled by the dimmer switch 110 may be intensity-control capable (e.g., only intensity-control capable) when the lighting load 112 may be controlled via a phase-control signal (e.g., only via a phase-control signal). In addition, the LED light source 122 controlled by the LED driver 120 and the LED light source of the controllable light source 130 may be intensity-control capable as well as color-temperature-control capable and/or full-color-control capable. For example, some lighting loads may be color-temperature-control capable (e.g., only color-temperature-control capable) when the color of the light emitted by the lighting load may be controlled (e.g., only be controlled) to colors (e.g., white colors) along the black body curve. In addition, some lighting loads may be color-control capable when the color of the light emitted by the lighting load may be controlled to multiple color values (e.g., as determined by an x-chromaticity coordinate and a y-chromaticity coordinate) within a gamut in the red-green-blue (RGB) color space (e.g., the CIE 1931 RGB color space), such that the color of the light emitted by the lighting load is not limited to white colors on the black body curve. Typically, those lighting loads that are full-color-control capable are also color-temperature-control capable. A load control device that is controlling a lighting load that is both color-temperature-control capable and full-color-control capable may operate (e.g., only operate) in one or the other of the color-temperature-control mode or the full-color-control mode at a time.

The load control devices of the load control system 100 (e.g., the dimmer switch 110, the LED driver 120, and/or the controllable light source 130) may be configured to communicate (e.g., transmit and/or receive) messages (e.g., digital message) via wired signals or wireless signals, such as radio-frequency (RF) signals 104, 106. For example, the load control devices may be configured to control the respective lighting loads (e.g., the lighting load 112 controlled by the dimmer switch 110, the LED light source 122 controlled by the LED driver 120, and/or the LED light source of the controllable light source 130) in response to control data (e.g., commands) received in the messages via the RF signals 104, 106. The load control devices may each comprise one or more wireless communication circuits for transmitting and/or receiving messages via the RF signals 104, 106. A first wireless communication circuit of each of the load control devices may be capable of communicating on a first wireless communication link (e.g., a wireless network communication link) and/or communicating using a first wireless protocol (e.g., a wireless network communication protocol, such as the CLEAR CONNECT protocol (e.g., the CLEAR CONNECT A and/or the CLEAR CONNECT X protocols) and/or the THREAD protocol) via the RF signals 104. A second wireless communication circuit of each of the load control devices may be capable of communicating on a second wireless communication link (e.g., a short-range wireless communication link) and/or communicating using a second wireless protocol (e.g., a short-range wireless communication protocol, such as the BLUETOOTH and/or BLUETOOTH LOW ENERGY (BLE) protocols) via the RF signals 106.

The load control system 100 may include one or more input control devices for controlling the load control devices (e.g., controlling the intensity levels of the lighting load 112 controlled by the dimmer switch 110, the LED light source 122 controlled by the LED driver 120, and/or the LED light source of the controllable light source 130). For example, the input control devices of the load control system 100 may comprise a remote control device 140. The load control devices (e.g., the dimmer switch 110, the LED driver 120, and/or the controllable light source 130) may be controlled substantially in unison, or be controlled individually. The remote control device 140 may be configured to generate control data (e.g., commands) for controlling the load control devices to turn on and off the lighting load 112 controlled by the dimmer switch 110, the LED light source 122 controlled by the LED driver 120, and/or the controllable light source 130. The remote control device 140 may be configured to generate control data (e.g., commands) for adjusting the intensity levels of the lighting load 112 controlled by the dimmer switch 110, the LED light source 122 controlled by the LED driver 120, and/or the controllable light source 130. The remote control device 140 may be configured to generate control data (e.g., commands) for controlling the color of light emitted by the lighting load 112 and/or the controllable light source 130 (e.g., by controlling a color temperature of the lighting loads or by adjusting a color value of the lighting loads using full-color control). The remote control device 140 may be configured to generate control data (e.g., commands) for controlling the intensity level and/or the color temperature of each of the lighting load 112, the LED light source 122, and the controllable light source 130 to an absolute level (e.g., to a particular intensity level, such as to 50%), and/or by a relative amount (e.g., by a particular amount, such as by 10%). The remote control device 140 may be configured to use full color control to control the color value of each of the lighting load 112, the LED light source 122, and the controllable light source 130 to an absolute level (e.g., to a particular color value).

The remote control device 140 may be configured to be responsive to an input and transmit the control data in one or more messages via the RF signals 104, 106 for controlling the lighting load 112, the LED light source 122, and/or the controllable light source 130 based on the input. For example, the input may comprise a detection of an actuation of a button of the input control device by a user. The control data may include commands and/or other information (e.g., such as identification information) for controlling the lighting load 112, the LED light source 122, and/or the controllable light source 130. In some examples, the dimmer switch 110 may be configured to transmit messages via the RF signals 104, 106 for controlling other lighting loads, such as the LED light source 122 and/or the integral LED light source of the controllable light source 130. The remote control device 140 may be configured to receive an input and may generate and transmit a message (e.g., including control data, such as commands) for controlling the lighting load 112, the LED light source 122, and/or the controllable light source 130 in response to the input. The remote control device 140 may be powered by a direct-current (DC) power source (e.g., a battery or an external DC power supply plugged into an electrical outlet). In some examples, the remote control device 140 may be configured to be electrically connected to the power source 102 for receiving power (e.g., when the remote control device 140 is mounted to the electrical wallbox).

The load control system 100 may also comprise one or more system processing devices, such as a system controller 150, that may be configured to transmit and/or receive messages via wired and/or wireless communications. For example, the system controller 150 may operate as an intermediary device and/or a central processing device for one or more other devices in the load control system 100. The system controller 150 may be configured to communicate messages (e.g., digital messages) to and from the control devices (e.g., the input control devices and the load control devices of the load control system 100). The system controller 150 may be configured to receive messages from the input control devices (e.g., the remote control device 140) and transmit messages to the load control devices (e.g., the dimmer switch 110, the LED driver 120, and/or the controllable light source 130) in response to the messages received from the input control devices. The system controller 150 may route the messages based on the association information stored thereon. The messages from the input control devices and/or to the load control devices may be communicated via the RF signals 104, 106.

The system controller 150 may be configured to transmit messages to the load control devices for controlling the lighting loads (e.g., the lighting load 112, the LED light source 122, and/or the LED light source of the controllable light source 130) in response to the messages received from the input control devices (e.g., via the RF signals 104, 106). For example, the system controller 150 may receive a message indicating an actuation of a button from an input control device (e.g., such as the remote control device 140), and transmit a message to one or more of the load control devices for controlling the lighting loads. For example, the input control devices may be configured to control (e.g., indirectly control) the lighting loads (e.g., the lighting load 112, the LED light source 122, and/or the LED light source of the controllable light source 130) by transmitting messages to the system controller 150 that cause the system controller 150 to transmit messages including commands for controlling the lighting loads to the load control devices. Though the system controller 150 is described as communicating messages between devices in the load control system 100, messages may be communicated directly between devices (e.g., between the input control devices and/or the load control devices). The messages may include configuration data for configuring the input control devices and/or the load control devices, and/or the messages may include control data (e.g., one or more commands) for controlling the lighting loads.

The system controller 150 may also, or alternatively, be capable of communicating on a third wireless communication link (e.g., a network communication link) and/or communicating using a third wireless protocol (e.g., a network communication protocol, such as Internet protocol, Ethernet-based protocols, WI-FI protocols, or other suitable network protocols), via RF signals 108. For example, the system controller 150 may be configured to transmit and/or receive messages on a network (e.g., a local area network and/or a wide area network, such as the Internet), via the RF signals 108. The system controller 150 may transmit messages to the load control devices in response to messages received via the network. The messages may include configuration data for configuring the load control devices and/or control information (e.g., commands) for controlling the load control devices.

The load control devices (e.g., the dimmer switch 110, the LED driver 120, and/or the controllable light source 130) may be configured to be controlled by one or more of the input control devices (e.g., the remote control device 140) and/or the system controller 150. For example, one or more of the load control devices may be associated with one of the input control devices during a configuration procedure of the load control system 100. During normal operation of the load control system 100, the load control devices may be responsive to messages received from the input control devices to which the respective load control devices are associated.

The input control devices and/or the system controller 150 may be configured to activate a scene (e.g., a preset) associated with the lighting loads (e.g., the lighting load 112, the LED light source 122, and/or the LED light source of the controllable light source 130). A scene may be associated with one or more predetermined settings of the lighting loads, such as an intensity level and/or a color (e.g., a color temperature and/or a color value) of the lighting loads. The scenes may be configured via the input control devices and/or the system controller 150. The input control devices may be configured to switch between different operational modes. An operational mode may be associated with controlling different types of electrical loads or different operational aspects of one or more electrical loads of the load control system 100 (e.g., electrical loads including and/or other than the lighting loads shown in FIG. 1). Examples of operational modes may include a lighting control mode for controlling one or more lighting loads (e.g., which in turn may include an intensity-adjustment mode, a color-temperature-adjustment mode, and/or a full-color-adjustment mode), an entertainment system control mode (e.g., for controlling music selection and/or the volume of an audio system), an heating, ventilation, and air-conditioning (HVAC) system control mode, a window treatment device control mode (e.g., for controlling one or more shades), and/or the like.

The load control devices (e.g., the dimmer switch 110, the LED driver 120, and/or the controllable light source 130) may be configured to control the respective lighting loads (e.g., the lighting load 112, the LED light source 122, and/or the LED light source of the controllable light source 130) in response to scenes selected by the input control devices and/or the system controller 150 For example, the messages transmitted by the input control devices in response to a scene being selected may include an indication of the selected scene. The load control devices may have stored in memory thereon the particular intensity levels, color temperatures, and/or color values to which to control the respective lighting loads in response to the selected scenes. For example, the load control devices may be configured to provide absolute control of the intensity level, color temperature, and/or color values (e.g., to control the intensity level, color temperature, and/or color values to absolute levels) in response to the selection of scenes. In response to the selection of a particular scene, the load control devices may be configured to control either the color temperature and/or the color value of a particular lighting load that is a part of the scene. For example, the LED driver 120 and/or the controllable light source 130 may be configured to operate in a color-temperature-control mode to control the color temperature of the controlled lighting load, or may operate in a full-color-control mode to control the color value of the controlled lighting load (e.g., as determined by an x-chromaticity coordinate and a y-chromaticity coordinate).

A network device 160 may be in communication with the load control devices and/or the system controller 150 for configuring and/or controlling the control devices of the load control system 100. The network device 160 may comprise a wireless phone, a tablet, a laptop, a personal digital assistant (PDA), a wearable device (e.g., a watch, glasses, etc.), or other computing device. The network device 160 may be operated by a user 162. For example, the network device 160 may comprise a visible display 164 for displaying a graphical user interface (GUI) for displaying information for the user 162 and receiving inputs from the user 162. The network device 160 may be configured to communicate with the load control devices via the RF signals 106 (e.g., using the short-range wireless communication protocol on the short-range wireless communication link). In addition, or alternatively, the network device 160 may be configured to communicate with the system controller 150 via the RF signals 104 (e.g., using the network communication protocol on the network communication link). Further, the network device 160 may be configured to transmit and/or receive beacon signals that may be used to commission the load control system 100 via the short-range wireless communication link (e.g., using the RF signals 106).

The load control devices of the load control system 100 (e.g., the dimmer switch 110, the LED driver 120, and/or the controllable light source 130) may be configured to control the respective lighting loads (e.g., the lighting load 112, the LED light source 122, and/or the LED light source of the controllable light source 130) in response to inputs received from the input devices (e.g., the remote control device 140) and/or the system processing devices (e.g., the system controller 150) based on system configuration data (e.g., programming data and/or association data), which may be stored in a system configuration database. The system configuration database and/or portions of the system configuration database may be stored on one or more of the devices of the loads control system 100. A computing device, such as the network device 160 or other suitable network device, may be configured to define the system configuration data in response to inputs received from the user 162. For example, the network device 160 may be configured to execute a design configuration application (e.g., design configuration software) to display the graphical user interface on the visible display 164 for displaying configuration options and/or receiving the inputs from the user 162 to generate the system configuration data.

After the control devices of the load control system 100 (e.g., the load control devices, the input devices, and/or the system processing devices) are installed, the load control system 100 may be enabled for operation during a commissioning procedure. For example, the network device 160 may be configured to coordinate the commissioning procedure in response to inputs received from the user 162. The network device 160 may be configured to define the system configuration data prior to and/or during the commissioning procedure of the load control system 100. The system configuration data may comprise a device object for each of the control devices in the load control system 100. The device objects of the system configuration data may each comprise one or more of a device name, a device location, a system configuration identifier (e.g., a configuration address), one or more operational settings, and/or programming data. For example, the one or more operational settings may comprise high-end and/or low-end intensity levels (e.g., for a lighting control device), a light source type (e.g., for a lighting control device), raised and/or lowered limit positions (e.g., for a motorized window treatment), a sensitivity level (e.g., for an input device, such as a sensor), etc. The programming data may define how the control devices operate to control the electrical loads of the load control system 100. In addition, each of the device objects of the system configuration data may be configured to store a device identifier (e.g., a unique identifier of the control device of the load control system 100, such as a serial number) that allows the control device of that device object to communicate with the other control devices of the load control system 100. For example, the device identifier of each of the device objects of the system configuration data may be received and stored in the system configuration data during the commissioning procedure.

The control devices of the load control system 100 may be activated (e.g., as a step of the commissioning procedure) to establish the control devices in the load control system 100 (e.g., during an activation process), such that the control devices may be configured to communicate with each other (e.g., via the RF signals 104, 106). During the activation process, the network device 160 may be configured to transmit a discovery initiation message (e.g., a discovery initiation beacon message) to the control devices of the load control system 100. In some examples, the network device 160 may be configured to repetitively (e.g., periodically) transmit the discovery initiation message during the activation procedure. The discovery initiation message may include a discovery initiation identifier, which may be a unique identifier (e.g., a serial number) of the network device 160 and/or the design configuration application executed by the network device 160. In response to receiving the discovery initiation message, the control devices of the load control system 100 may be configured to enter a discovery mode. In some examples, the control devices of the load control system 100 may be configured to enter the discovery mode, when a received signal magnitude (e.g., a received signal strength indicator) of the received discovery initiation message exceeds a discovery threshold. When in the discovery mode, the control devices of the load control system 100 may be configured to transmit a discovery request message (e.g., a discovery request beacon message) to the network device 160. In some examples, the control devices of the load control system 100 may be configured to repetitively (e.g., periodically) transmit the discovery request message while in the discovery mode. The discovery request message may include a device identifier, which may be a unique identifier (e.g., a serial number) of the control device that transmitted the discovery request message. The discovery request message may include a device type (e.g., lighting control device, motorized window treatment, etc.).

After the control devices of the load control system 100 are activated, the system controller 150 and/or the network device 160 may be configured to transmit at least a portion of the system configuration data to each of the control devices in the load control system 100. The network device 160 may be configured to transmit the configuration data to the system controller 150 and the system controller 150 may be configured to transmit portions of the system configuration data to the appropriate control devices of the load control system 100. For example, the system controller 150 may be configured to transmit a portion of the system configuration data that includes a light source type to the LED driver 120, and the LED driver 120 may use the light source type to configure itself for controlling the LED light source 122. For example, the light source type may indicate a number of emitter circuits included in the LED light source 122 and/or an emitter color of the emitters in each of the emitter circuits of the LED light source 122 (e.g., as will be described in greater detail below).

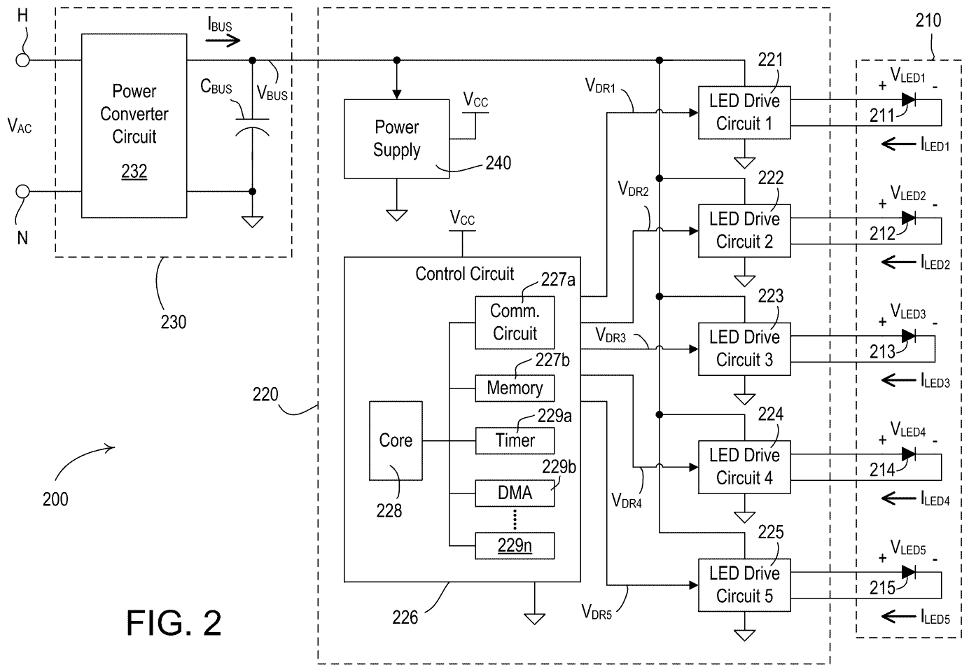

FIG. 2 is a simplified block diagram of an example load control system, such as a light-emitting diode (LED) driver system 200. The LED driver system 200 may comprise a load control device, such as a driver module 220 (e.g., a dimming module), for controlling a light source 210 (e.g., the LED light source 122). The LED driver system 200 may also comprise a power converter module 230 for powering the light source 210 and/or the driver module 220. For example, the light source 210 of the LED driver system 200 may comprise one or more emitter circuits 211, 212, 213, 214, 215 (e.g., LED circuits). Each of the emitter circuits 211-215 may include one or more emitters. The emitters of each emitter circuit 211-215 may be electrically coupled together in series and/or parallel connection. As such, the emitters of each emitter circuit 211-215 may be controlled in unison. The driver module 220 may control the emitter circuits 211-215 to adjust an intensity level (e.g., lighting intensity level and/or brightness) and/or a color (e.g., a color temperature and/or a color value) of a cumulative light emitted by the light source 210. In some examples, the light source 210, the driver module 220, and the power converter module 230 may be separate devices (e.g., housed in separate enclosures and/or fixtures, such as with the LED driver 120 and the LED light source 122 shown in FIG. 1). Further, the light source 210, the driver module 220, and the power converter module 230 may be housed in a single enclosure, or some combination thereof (e.g., when the LED driver system 200 is a controllable light source, such as the controllable light source 130 shown in FIG. 1). In some examples, the light source 210 may comprise a linear light source, such as strip lighting (e.g., tape lighting), which may be characterized by a maximum length L_{STRIP-MAX} (e.g., that may define a maximum distance that the emitters of each emitter circuit 211-215 of the light source 210 may be located from the driver module 220).

Each of the emitter circuits 211-215 is shown in FIG. 2 as a single LED, but, as noted above, may each comprise a plurality of LEDs connected in series (e.g., a string or chain of LEDs), a plurality of LEDs connected in parallel, or a suitable combination thereof, depending on the particular lighting system. The emitter circuits 211-215 may each represent a string of one or more LEDs, where the LEDs in each string are all configured to emit light at the same color (e.g., color temperature and/or color value). The strings of LEDs represented by each of the emitter circuits 211-215 may be configured to emit light at different colors (e.g., different color temperatures and/or color values). Further, the emitter circuits of the light source 210 are not limited to LEDs, and in some examples, other technology, such as OLEDs may be used. When the light source 210 is strip lighting, each strip of lighting may be housed separately or may be housed together in one housing or some combination thereof. While the light source 210 is shown as including five emitter circuits 211-215 in FIG. 2, in some examples, the light source 210 may include less than or more than five emitter circuits. For example, the light source 210 may comprise two emitter circuits or three emitter circuits.

Each of the emitter circuits 211-215 may be configured to emit light at a different color (e.g., color temperature and/or color value). For example, one or more of the emitters circuits 211-215 may include broad-spectrum LEDs that may each be configured to produce light (e.g., white light) at a particular color temperature, which may be on the black body curve. For example, one of the emitter circuits 211-215 may represent a string of emitters at a first color temperature T₁ (e.g., a cool-white color temperature, such as approximately 3000 K) and another one of the emitter circuits 211-215 may represent a string of emitters at a second color temperature T₂ (e.g., a warm-white color temperature, such as approximately 1800 K). In some examples, one or more of the emitter circuits 211-215 may include non-broad-spectrum LEDs that may each be configured to produce light at a peak emission wavelength, which may specify the color (e.g., the color value) of the light emitted by the respective emitter circuit. For example, one of the emitter circuits 211-215 may represent a string of red emitters, one of the emitter circuits 211-215 may represent a string of green emitters, and/or one of the emitter circuits 211-215 may represent a string of blue emitters. Although described in context of these colors (e.g., color temperatures and/or color values), the emitter circuits 211-215 may be configured to emit light accordingly to any color (e.g., at any wavelength and/or color temperature).

The power converter module 230 may include a power converter circuit 232, which may receive a source voltage, such as an AC mains line voltage V_{AC}, via a hot connection H and a neutral connection N. The power converter circuit 232 may generate a DC bus voltage V_{BUS} (e.g., approximately 15-50V) across a bus capacitor C_{BUS}. The power converter circuit 232 may be configured to conduct a bus current I_{BUS} for generating the bus voltage V_{BUS} across the bus capacitor C_{BUS}. The power converter circuit 232 may comprise, for example, a boost converter, a buck converter, a buck-boost converter, a flyback converter, a single-ended primary-inductance converter (SEPIC), a Ćuk converter, or any other suitable power converter circuit for generating an appropriate bus voltage. The power converter circuit 232 may provide electrical isolation between the AC power source and the driver module 220 and/or the light source 210. The power converter circuit 232 may also operate as a power factor correction (PFC) circuit to adjust the power factor of the LED driver system 200 towards a power factor of one. Although illustrated as connected to an AC power source (e.g., the AC mains line voltage V_{AC}), in other examples the LED driver system 200 may be coupled to a direct current (DC) power source. Here, the power converter module 230 may not be needed or may convert a DC source voltage of the DC power source to the DC bus voltage V_{BUS} (e.g., at a desired magnitude between approximately 15-50V). The driver module 220 may receive the bus voltage V_{BUS} and conduct current from the bus capacitor C_{BUS} and/or through the power converter module 230. The power converter circuit 232 may be configured to limit the magnitude of the bus current I_{BUS} to a current limit I_{LIMIT} (e.g., approximately 4 A). For example, an overcurrent protection circuit in the power converter circuit 232 may be configured to cause the power converter circuit 232 to stop generating the bus voltage V_{BUS} when the magnitude of the bus current I_{BUS} exceeds the current limit I_{LIMIT}.

The driver module 220 may comprise respective LED drive circuits 221, 222, 223, 224, 225 for controlling (e.g., individually controlling) an amount of power delivered to each of the respective emitter circuits 211-215 of the light source 210. As such, the driver module 220 may comprise respective LED drive circuits 221, 222, 223, 224, 225 for controlling (e.g., individually controlling) an individual intensity level L_{IND1}, L_{IND2}, L_{IND3}, L_{IND4}, L_{IND5} (e.g., lighting intensity level and/or luminous flux) of the light emitted by each of the respective emitter circuits 211-215 of the light source 210. The LED drive circuits 221-225 may receive (e.g., all receive) the bus voltage V_{BUS} (e.g., which may be generated by the power converter circuit 232). Each of the LED drive circuits 221-225 may be configured to adjust (e.g., independently adjust), for example, a magnitude (e.g., an average magnitude) of a respective LED voltage V_{LED1}, V_{LED2}, V_{LED3}, V_{LED4}, V_{LED5} produced across the respective emitter circuit 211-215 (e.g., such that each of the emitter circuits 211-215 may conduct a respective LED current I_{LED1}, I_{LED2}, I_{LED3}, I_{LED4}, I_{LED5}). For example, each of the LED drive circuits 221-225 may be configured to pulse-width modulate (PWM) the respective LED voltage V_{LED1}-V_{LED5} for adjusting the individual intensity level L_{IND1}-L_{IND5} of the light emitted by the respective emitter circuit 211-215. The LED currents I_{LED1}-I_{LED5} conducted by each of the LED drive circuits 221-225 may be configured to have a peak magnitude up to the current limit I_{LIMIT} of the power converter circuit 232 (e.g., without the power converter circuit 232 limiting the magnitude of the LED currents I_{LED1}-I_{LED5}). In some examples, each of the LED drive circuits 221-225 may receive the bus voltage V_{BUS} and may adjust magnitudes (e.g., average magnitudes) of the respective LED currents I_{LED1}-I_{LED5} conducted through the emitter circuits 211-215. For example, each of the LED drive circuits 221-225 may control an instantaneous magnitude of the respective LED voltage V_{LED1}-V_{LED5} of the respective emitter circuit 211-215 to approximately the magnitude of the bus voltage V_{BUS} (e.g., based on a PWM technique). Each of the LED circuits 211-215 may comprise a regulation circuit, such as a switching regulator (e.g., a buck converter) for controlling the magnitudes of the respective LED voltages V_{LED1}-V_{LED5} and/or the respective LED drive currents I_{LED1}-I_{LED5}.

The driver module 220 may comprise a control circuit 226 for controlling the LED drive circuits 221-225 to control the individual intensity level L_{IND1}-L_{IND5} of each of the emitter circuits 211-215 of the light source 210. The control circuit 226 may comprise one or more of, for example, one or more microprocessors, one or more microcontrollers, one or more programmable logic devices (PLD), one or more application specific integrated circuits (ASIC), one or more field-programmable gate arrays (FPGA), or any other suitable processing device(s) or processor(s).

The control circuit 226 may comprise one or more cores 228 and/or one or more peripherals 229a-229n. Alternatively, the one or more peripherals 229a-229n (e.g., and, possibly, one or more cores) may be separate from the control circuit 226. As such, in some examples, the control circuit may be a logical representation of several components that may or may not be housed together in a single device or package. The core 228 may include electronic circuitry that executes instructions comprising a computer program(s) stored in memory, such as memory 227b. The core 228 may perform one or more functions, such as logic, controlling, and input/output (I/O) operations specified by one or more computer programs. The peripherals 229a-229n may be configured to perform one or more functions independent of the core 228. Each peripheral 229a-229n may be configured with various operational settings. For example, the control circuit 226 may include any combination of a timer peripheral 229a, a peripheral direct memory access (DMA) controller (PDC) 229b, a Universal Synchronous/Asynchronous Receiver/Transmitter (USART), a Synchronous Serial Controller (SSC), a Serial Peripheral Interface (SPI), logic gates, flip-flops, filters, latches, etc. The timer peripheral 229a may be configured to maintain and update with respect to time a timer count in order to trigger a specific action after a certain length of time and/or a certain amount of clock cycles. For example, the timer peripheral 229a may be configured to generate timer signals, such as pulse-width modulated (PWM) signals, which may enable control of components and/or circuits external to the control circuit 226 (e.g., for controlling the LED drive circuits 221-225 to generate the respective LED voltage V_{LED1}-V_{LED5}, as will be described in greater detail below). In some examples, the timer peripheral 229a may comprise a buffer (e.g., a dedicated buffer). The peripheral DMA controller 229b may include a first-in first-out (FIFO) buffer with control features for driving one or more software modules included in the control circuit 226 (e.g., universal asynchronous receiver-transmitters (UARTs)).

The control circuit 226 may be configured to control the LED drive circuits 221-225 to control a present intensity level L_{PRES} (e.g., a present brightness) of a cumulative light emitted by the light source 210. For example, the control circuit 226 may be configured to control the present intensity level L_{PRES} of the cumulative light emitted by the light source 210 between a high-end intensity level L_{HE} (e.g., a maximum intensity level, such as approximately 100%) and a low-end intensity level L_{LE} (e.g., a minimum intensity level, such as approximately 0.1%-1.0%)). In addition, the control circuit 226 may be configured to control the LED drive circuits 221-225 to adjust a color (e.g., color temperature and/or color value) of the cumulative light emitted by the light source 210. For example, the control circuit 226 may be configured to control the LED drive circuits 221-225 to adjust a present color temperature T_{PRES} of the cumulative light emitted by the light source 210. Further, the control circuit 226 may be configured to control the LED drive circuits 221-225 to adjust a present color value (e.g., which may be defined by a present x-chromaticity coordinate X_{PRES} and a present y-chromaticity coordinate Y_{PRES}) of the cumulative light emitted by the light source 210. While the LED driver system 200 is described herein with the present color value defined by the present x-chromaticity coordinate X_{PRES} and the present y-chromaticity coordinate Y_{PRES}, the present color value could be defined by other color values (e.g., as defined in other color spaces). For example, the present color value by be a red-green-blue (RGB) color value (e.g., as defined by a red value, a green value, and a blue value, and/or a hex value in the RGB color space) a UVW color value (e.g., as defined by a u-chromaticity value, a v-chromaticity value, and a lightness index (e.g., w) value in the UVW color space), a wavelength, and/or other suitable color value.

While not shown in FIG. 2, the LED drive circuits 221-225 may generate one or more feedback signals that may be received by the control circuit 226 and may indicate magnitudes of respective operating characteristics (e.g., drive currents and/or luminous flux) of the respective emitter circuits 211-215 of the light source 210. In addition, the driver module 220 may comprise one or more feedback circuits (not shown), which may be external to the LED drive circuits 221-225 and may generate the one or more feedback signals that are received by the control circuit 226. The control circuit 226 may control the LED drive circuits 221-225 to adjust the average magnitude of each of the LED voltages V_{LED1}-V_{LED5} towards respective target voltages in response to the feedback signals. In some examples, the control circuit 226 may adjust the average magnitude of each of the LED currents I_{LED1}-I_{LED5} towards respective target currents in response to the feedback signals.

The control circuit 226 may be configured to adjust (e.g., dim) the present intensity level L_{PRES} of the cumulative light emitted by the light source 210 towards a target intensity level L_{TRGT} (e.g., a target brightness), which may range across a dimming range of the controllable lighting device, e.g., between the low-end intensity level L_{LE} and the high-end intensity level L_{HE}. In some examples, the individual intensity level L_{IND1}-L_{IND5} of the light emitted by each of the emitter circuits 211-215 may be dependent upon the magnitude of the LED voltages V_{LED1}-V_{LED5} developed across and/or the LED currents I_{LED1}-I_{LED5} conducted through the emitter circuits 211-215. In addition, the control circuit 226 may be configured to adjust the present color temperature T_{PRES} of the cumulative light emitted by the light source 210 towards a target color temperature T_{TRGT}, which may range between a warm-white color temperature (e.g., approximately 1800 K) and/or a cool-white color temperature (e.g., approximately 3000 K). Further, the control circuit 226 may be configured to adjust the present color value (e.g., as defined by the present x-chromaticity coordinate X_{PRES} and the present y-chromaticity coordinate Y_{PRES}) of the cumulative light emitted by the light source 210 towards a target color value (e.g., as defined by a target x-chromaticity coordinate X_{TRGT} and a target y-chromaticity coordinate Y_{TRGT}).

The LED driver system 200 may comprise a communication circuit 227a that may be part of the control circuit 226 and/or coupled to the control circuit 226. The communication circuit 227a may comprise one or more wired and/or wireless communication circuits. For example, the one or more wireless communication circuits of the communication circuit 227a may comprise a radio-frequency (RF) transceiver coupled to an antenna for transmitting and/or receiving RF signals. The one or more wireless communication circuits of the communication circuit 227a may further comprise an RF transmitter for transmitting RF signals, an RF receiver for receiving RF signals, or an infrared (IR) transmitter and/or receiver for transmitting and/or receiving IR signals. Alternatively or additionally, the communication circuit 227a may be coupled to the hot connection H and the neutral connection N of the LED driver system 200 for transmitting a control signal via the electrical wiring using, for example, a power-line carrier (PLC) communication technique. The communication circuit 227a may be implemented as one or more external integrated circuits (ICs) external to the control circuit 226 and/or as one or more internal circuits of the control circuit 226. The control circuit 226 may be configured to receive configuration data and/or control data (e.g., commands) via the message received via the communication circuit 227a. The control circuit 226 may be configured to receive configuration data that includes a light source type that may be used to configure the control circuit 226 for controlling the light source 210 (e.g., as will be described in greater detail below). For example, the light source type may indicate a number of emitter circuits included in the light source 210 and/or an emitter color of the emitters in each of the emitter circuits of the light source 210. The emitter color may be a color temperature of the emitters in the respective emitter circuit (e.g., when the emitters are broad-spectrum LEDs) or a color value (e.g., as indicated by an x-chromaticity coordinate and a y-chromaticity coordinate) of the emitters in the respective emitter circuit (e.g., when the emitters are non-broad-spectrum LEDs).

The control circuit 226 may be configured to receive and/or determine a commanded intensity level L_{CMD}, a commanded color temperature T_{CMD}, and/or a commanded color value (e.g., as defined by a commanded x-chromaticity coordinate X_{CMD} and a commanded y-chromaticity coordinate Y_{CMD}) from one or more messages (e.g., digital messages) received via the communication circuit 227a. The control circuit 226 may be configured to determine the target intensity level L_{TRGT} for the light source 210 in response to the commanded intensity level L_{CMD} from the received message. In addition, control circuit 226 may be configured to determine the target color temperature T_{TRGT} for the light source 210 in response to the commanded color temperature T_{CMD} from the received message. Further, the control circuit 226 may be configured to determine the target x-chromaticity coordinate X_{TRGT} and the target y-chromaticity coordinate Y_{TRGT} for the light source 210 in response to the commanded x-chromaticity coordinate X_{CMD} and the commanded y-chromaticity coordinate Y_{CMD} from the received message, respectively. While not shown in FIG. 2, the LED driver system 200 (e.g, the driver module 220) may additionally or alertnatively comprise a user interface having one or more actuators (e.g., buttons, sliders, etc.) for receiving user inputs, and the control circuit 226 may be configured to determine the target intensity level L_{TRGT}, the target color temperature T_{TRGT}, and/or the target x-chromaticity coordinate X_{TRGT} and the target y-chromaticity coordinate Y_{TRGT} for the light source 210 in response to actuation of the actuators of the user interface.

The LED driver system 200 (e.g., the control circuit 226) may comprise a memory 227b configured to store operational characteristics (e.g., such as operational settings, control parameters, operating modes of the LED driver system 200, etc.), association information for associations with other devices, and/or instructions for controlling electrical loads. As such, the memory may be accessed by the core 228, and/or DMA 229b, or other components of the LED driver system 200. For example, the memory 227b may be configured to store the target intensity level L_{TRGT}, the target color temperature T_{TRGT}, the target color value (e.g., as defined by the target x-chromaticity coordinate X_{TRGT} and the target y-chromaticity coordinate Y_{TRGT}), the low-end intensity level L_{LE}, and/or the high-end intensity level L_{HE}. The memory 227b may be implemented as one or more external integrated circuits (ICs) external to the control circuit 226 and/or as one or more internal circuits of the control circuit 226. The memory 227b may comprise a computer-readable storage media or machine-readable storage media that maintains computer-executable instructions for performing one or more procedure and/or functions as described herein. For example, the memory 227b may comprise computer-executable instructions or machine-readable instructions that when executed by the control circuit (e.g., the core 228, and/or DMA 229b, etc.) configure the control circuit to provide one or more portions of the procedures described herein. The control circuit 226 may access the instructions from the memory 227b for being executed to cause the control circuit 226 to operate as described herein, or to operate one or more other devices as described herein. The memory 227b may comprise computer-executable instructions for executing configuration software. For example, the operational characteristics and/or the association information stored in the memory 227b may be configured during a configuration procedure of the LED driver system 200. The control circuit 226 may be configured to store in the memory 227b configuration data, such as the light source type, that may be received via the communication circuit 227a. As mentioned above, the light source type may indicate a number of emitter circuits included in the light source 210, an emitter color (e.g., a color temperature and/or a color value) of the emitters in each of the emitter circuits of the light source 210, and/or a brightness of the emitters.

The LED driver system 200 may comprise a power supply 240 that may receive the bus voltage V_{BUS} and generate a supply voltage V_{CC} for powering the control circuit 226 and other low-voltage circuitry of the LED driver system 200.

The control circuit 226 may be configured to generate one or more drive signals V_{DR1}, V_{DR2}, V_{DR3}, V_{DR4}, V_{DR5} for controlling the respective LED drive circuits 221-225. The control circuit 226 may be configured to generate each of the one or more drive signals V_{DR1}-V_{DR5} at an operating frequency for (e.g., approximately 2.05 kHz), such that each of the one or more drive signals V_{DR1}-V_{DR5} are characterized by an operating period T_{OP} (e.g., approximately 488 μsec). The control circuit 226 may be configured to pulse-width modulate one or more of the drive signals V_{DR1}-V_{DR5} (e.g., using the timer peripheral) according to respective duty-cycles d₁-d₅ for controlling the LED drive circuit 221-225, such that the LED voltages V_{LED1}-V_{LED5} have duty cycles that are approximately equal to the respective duty-cycles d₁-d₅ of the drive signals V_{DR1}-V_{DR5}. For example, the control circuit 226 may be configured to adjust the duty cycle d₁ of the first drive signal V_{DR1} to adjust the individual intensity level L_{IND1} of the first emitter circuit 211, adjust the duty cycle d₂ of the second drive signal V_{DR2} to adjust the individual intensity level L_{IND2} of the second emitter circuit 212, adjust the duty cycle d₃ of the third drive signal V_{DR3} to adjust the individual intensity level L_{IND3} of the third emitter circuit 213, adjust the duty cycle d₄ of the fourth drive signal V_{DR4} to adjust the individual intensity level L_{IND4} of the fourth emitter circuit 214, and adjust the duty cycle d₅ of the fifth drive signal V_{DR5} to adjust the individual intensity level L_{IND5} of the fifth emitter circuit 215.

The control circuit 226 may be configured to adjust the duty cycles d₁-d₅ of the respective drive signal V_{DR1}-V_{DR5} to adjust the individual intensity levels L_{IND1}-L_{IND5} of the respective emitter circuits 211-215 while maintaining the operating frequency f_{OP} and/or the operating period T_{OP} at constant values. The control circuit 226 may be configured to adjust (e.g., independently adjust) the duty cycles d₁-d₅ of one or more of the respective drive signal V_{DR1}-V_{DR5} to adjust the present intensity level L_{PRES}, the present color temperature T_{PRES}, and/or the present color value (e.g., as defined by the present x-chromaticity coordinate X_{PRES} and the present y-chromaticity coordinate Y_{PRES}) of the cumulative light emitted by the lighting load. Based on the duty cycles d₁-d₅, the control circuit 226 may be configured to drive magnitudes of the respective drive signals V_{DR1}-V_{DR5} high towards the supply voltage V_{CC} (e.g., or drive low toward ground or circuit common) during respective on times T_{ON1}, T_{ON2}, T_{ON3}, T_{ON4}, T_{ON5} that occur with each cycle of operation of the driver module 220 (e.g., each instance of the operating period T_{OP}).

The control circuit 226 may be configured to hold the operating period T_{OP} constant and adjust the on times T_{ON1}-T_{ON5} to adjust the duty cycles d₁-d₅ of the respective drive signals V_{DR1}-V_{DR5}. The driver module 220 (e.g., the LED drive circuits 221-225) may be characterized by a minimum on time T_{ON-MIN} and a maximum on time T_{ON-MAX} to which the control circuit 226 may adjust the on times T_{ON1}-T_{ON5} of the respective drive signals V_{DR1}-V_{DR5}. For example, the minimum on time T_{ON-MIN} may represent an on time below which each of the emitter circuits 211-215 may not emit light that is visible to the human eye (e.g., approximately 150 nanoseconds). The minimum on time T_{ON-MIN} may be zero seconds or some value above zero seconds (e.g., approximately 150 nanoseconds). The maximum on time T_{ON-MAX} may be equal to, for example, the operating period T_{OP}. The control circuit 226 may be configured to adjust the on times T_{ON1}-T_{ON5} by an adjustment amount Δ_{T-ON} (e.g., a minimum step size, such as, approximately 26 nanoseconds) such that the control circuit 226 may adjust the on times T_{ON1}-T_{ON5} to discrete values (e.g., achievable on times) that are spaced apart by the adjustment amount Δ_{T-ON} (e.g., multiples of the adjustment amount Δ_{T-ON} between the minimum on time T_{ON-MIN} and the maximum on time T_{ON-MAX}).

In some examples, even though the light source 210 comprises the five emitter circuits 211-215, the control circuit 226 may control the LED drive circuits 221-225 to illuminate less than the five emitter circuits 211-215 (e.g., two to four of the emitter circuits 221-225). For example, the control circuit 226 may be configured to control the LED drive circuits 221-225 to illuminate three of the emitter circuits 211-215 to adjust the color (e.g., color temperature and/or color value) of the cumulative light emitted by the light source 210. When illuminating three of the emitter circuits 211-215, the control circuit 226 may be configured to generate three of the drive signals V_{DR1}-V_{DR5} for controlling the three of the LED drive circuits 221-225 that are connected to the three of the emitter circuits 211-215 that are illuminated.

The LED driver system 200 may be configured to operate with light sources that have different numbers of emitter circuits and/or having emitter circuits of different colors (e.g., wavelengths and/or color temperatures). In some examples, the light source 210 controlled by the LED driver system 200 may comprise two emitter circuits, such as the emitter circuits 211, 212 (e.g., the light source 210 may not comprise the emitter circuits 213, 214, 215). Each of the emitter circuits 211, 212 may include broad-spectrum LEDs configured to emit light (e.g., white light), for example, at a color temperature (e.g., a different color temperature) that is along a black body curve. For example, the first emitter circuit 211 may represent a string of broad-spectrum LEDs at a first color temperature T₁, and the second emitter circuit 212 may represent a string of broad-spectrum LEDs at a second color temperature T₂. The first color temperature may be greater than the second color temperature. For example, the first color temperature may be a cool-white color temperature (e.g., such as approximately 3000 K) and the second color temperature may be a warm-white color temperature (e.g., such as approximately 1800 K). Although described in context of these color temperatures, the emitter circuits 211, 212 may be configured to emit light accordingly to any color temperature. When the light source 210 comprises just the two emitter circuits 211, 212, the emitter circuits 211, 212 may be electrically coupled to and controlled by the first LED drive circuit 221 and the second LED drive circuit 222, respectively (e.g., and the LED drive circuits 223, 224, 225 may be unused when controlling the light source 210). The control circuit 226 may be configured to generate (e.g., only generate) the first drive signal V_{DR1} and the second drive signal V_{DR2} for controlling the first and second LED drive circuits 221, 222, respectively, to control (e.g., only control) the present color temperature T_{PRES} of the cumulative light emitted by the light source 210.

In addition, the light source 210 controlled by the LED driver system 200 may comprise three emitter circuits, such as the emitter circuits 211, 212, 213 (e.g., the light source 210 may not comprise the emitter circuits 214, 215). In a first example, each of the emitter circuits 211, 212, 213 may include one or more broad-spectrum LEDs configured to emit light (e.g., white light) at a color temperature (e.g., a different color temperature) that is along the black body curve. For example, the first emitter circuit 211 may represent a string of broad-spectrum LEDs at a first color temperature T₁, the second emitter circuit 212 may represent a string of broad-spectrum LEDs at a second color temperature T₂. and the third emitter circuit 213 may represent a string of broad-spectrum LEDs at a third color temperature T₃. In a second example, the first and second emitter circuits 211, 212 may include one or more broad-spectrum LEDs configured to emit light (e.g., white light) at a color temperature (e.g., a different color temperature) that is along the black body curve, while the third emitter circuit 213 may include one or more non-broad-spectrum LEDs configured to emit light, for example, at a color value (e.g., such as a green color value) that is not along the black body curve. In a third example, each of the emitter circuits 211, 212, 213 may include one or more non-broad-spectrum LEDs configured to emit light at a color value (e.g., not limited to white colors on the black body curve). For example, the first emitter circuit 211 may represent a string of non-broad-spectrum LEDs at a first color value (e.g., a red color value), the second emitter circuit 212 may represent a string of non-broad-spectrum LEDs at a second color value (e.g., a blue color value) and the third emitter circuit 213 may represent a string of non-broad-spectrum LEDs at a third color value (e.g., a green color value). When the light source 210 comprises just the three emitter circuits 211, 212, 213, the emitter circuits 211, 212, 213 may be electrically coupled to and controlled by the first LED drive circuit 221, the second LED drive circuit 222, and the third LED drive circuit 223, respectively (e.g., and the LED drive circuits 224, 225 may be unused when controlling the light source 210). The control circuit 226 may be configured to generate (e.g., only generate) the first drive signal V_{DR1}, the second drive signal V_{DR2}, and the third drive signal V_{DR3} for controlling the first, second, and third LED drive circuits 221, 222, 223, respectively, to control the present color temperature T_{PRES} and/or the present color value (e.g., as defined by the present x-chromaticity coordinate X_{PRES} and the present y-chromaticity coordinate Y_{PRES}) of the cumulative light emitted by the light source 210.

Further, the light source 210 controlled by the LED driver system 200 may comprise five emitter circuits, such as the emitter circuits 211-215 (e.g., as shown in FIG. 2). For example, the two of the emitter circuits 211-215 may include broad-spectrum LEDs configured to emit light (e.g., white light) at a color temperature (e.g., a different color temperature) that is along the black body curve, and three of the emitter circuits 211-215 may include one or more non-broad-spectrum LEDs configured to emit light at a color value (e.g., not limited to white colors on the black body curve). For example, the first emitter circuit 211 may represent a string of broad-spectrum LEDs at a first color temperature T₁ and the second emitter circuit 212 may represent a string of broad-spectrum LEDs at a second color temperature T₂. In addition, the third emitter circuit 213 may represent a string of non-broad-spectrum LEDs at a first color value (e.g., a red color value), the fourth emitter circuit 214 may represent a string of non-broad-spectrum LEDs at a second color value (e.g., a blue color value) and the fifth emitter circuit 215 may represent a string of non-broad-spectrum LEDs at a third color value (e.g., a green color value). When the light source 210 comprises all five of the emitter circuits 211-215 (e.g., as shown in FIG. 2), the emitter circuits 211-215 may be electrically coupled to and controlled by the respective LED drive circuits 221-225. The control circuit 226 may be configured to generate the drive signals V_{DR1}-V_{DR5} for controlling the respective LED drive circuits 211-215 to control the present color temperature T_{PRES} and/or the present color value (e.g., as defined by the present x-chromaticity coordinate X_{PRES} and the present y-chromaticity coordinate Y_{PRES}) of the cumulative light emitted by the light source 210. Finally, it should be appreciated that the LED driver system 200 may be configured to operate with light sources that include more or less than five emitter circuits (e.g., and, for example, the LED driver system 200 may include more or less than five LED drive circuits). Further, in examples where the light source includes less emitter circuits that the number of LED drive circuits of the LED driver system 200, the emitter circuits may be coupled to a subset of the LED drive circuits of the LED driver system 200.

The control circuit 226 may be configured to operate in either a color-temperature-control mode or a full-color-control mode to control either the present color temperature T_{PRES} or the present color value (e.g., as defined by the present x-chromaticity coordinate X_{PRES} and the present y-chromaticity coordinate Y_{PRES}), respectively. When operating in the color-temperature-control mode, the control circuit 226 may be configured to control the LED drive circuits 221-225 to adjust the present color temperature T_{PRES} of the cumulative light emitted by the light source 210 towards the target color temperature T_{TRGT}. When operating in the full-color-control mode, the control circuit 226 may be configured to control the LED drive circuits 221-225 to adjust the present x-chromaticity coordinate X_{PRES} and the present y-chromaticity coordinate Y_{PRES} (e.g., that define the present color) of the cumulative light emitted by the light source 210 towards the target x-chromaticity coordinate X_{TRGT} and the target y-chromaticity coordinate Y_{TRGT} (e.g., that define the target color). The control circuit 226 may be configured to determine to operate in one of the color-temperature-control mode or the full-color-control mode based on the last color-adjustment command received in a message via the communication circuit 227a. For example, the control circuit 226 may be configured to operate in the color-temperature-control mode when the last received color-adjustment command is a color-temperature-adjustment command including a commanded color temperature T_{CMD}, and in the full-color-control mode when the last received color-adjustment command is a full-color-adjustment command including a commanded color value (e.g., as defined by a commanded x-chromaticity coordinate X_{CMD} and a commanded y-chromaticity coordinate Y_{CMD}).

The control circuit 226 may be configured to determine which of the emitter circuits 211-215 to control based on the color-control mode in which the control circuit is presently operating and/or the light source type that is stored in the memory 227b. When the LED driver system 200 has a greater number of LED drive circuits 221-225 than the number of emitter circuits of the light source 210 (e.g., when the light source 210 has less than five emitter circuits), the control circuit 226 may be configured to determine which of the LED drive circuits 221-225 to control based on the number of emitter circuits in the light source 210 as indicated by the light source type. For example, when the light source 210 has two emitter circuits, the control circuit 226 may be configured to determine to generate the first and second drive signals V_{DR1}-V_{DR2} to control the first and second LED drive circuits 221-222, respectively, to adjust the present color temperature T_{PRES} of the cumulative light emitted by the light source 210 to the target color temperature T_{TRGT} (e.g., when in the color-temperature-control mode). In addition, when the light source 210 has three emitter circuits, the control circuit 226 may be configured to determine to generate the first, second, and third drive signals V_{DR1}-V_{DR3} to control the first, second, and third LED drive circuits 221-223, respectively, to adjust the present color temperature T_{PRES} of the cumulative light emitted by the light source 210 to the target color temperature T_{TRGT} (e.g., when in the color-temperature-control mode) and/or to adjust the present color value of the cumulative light emitted by the light source 210 to the target color value (e.g., when in the full-color-control module).

In some examples, the control circuit 226 may control the LED drive circuits 221-225 to illuminate less than the five emitter circuits 221-225 (e.g., three or four of the emitter circuits 211-215) based on the color-control mode in which the control circuit is presently operating and/or the emitter color of the emitters in each of the emitter circuits of the light source 210. For example, when the light source 210 includes five emitter circuits 211-215, where two of the emitter circuits include broad-spectrum LEDs configured to emit light at different color temperatures and three of the emitter circuits include non-broad-spectrum LEDs configured to emit light at different color values, the control circuit 226 may be configured to determine to control (e.g., only control) three of the emitter circuits 211-215 to adjust the present color temperature T_{PRES} of the cumulative light emitted by the light source 210 to the target color temperature T_{TRGT} when in the color-temperature-adjustment mode and to adjust the present color of the cumulative light emitted by the light source 210 to the target color when in the full-color-control mode. When operating in the color-temperature-control mode, the control circuit 226 may be configured to determine to control three of the LED drive circuits 221-225 to illuminate the two of the emitter circuits that are configured to emit light at different color temperatures and one of the emitter circuits that are configured to emit light at different color values. In addition, when operating in the full-color-control mode, the control circuit 226 may be configured to determine to control three of the LED drive circuits 221-225 to illuminate the three of the emitter circuits that are configured to emit light at different color values when operating in the full-color-control mode.

The control circuit 226 may be configured to determine the duty cycles d₁-d₅ (e.g., desired duty cycles) for the respective drive signals V_{DR1}-V_{DR5} based on which of the five LED drive circuits 221-225 that the control circuit 226 has determined to control (e.g., based on the color-control mode in which the control circuit is presently operating and/or based on the light source type, as described above). In addition, the control circuit 226 may be configured to determine the duty cycles d₁-d₅ for the respective drive signals V_{DR1}-V_{DR5} based on either the target color temperature T_{TRGT} (e.g., when operating in the color-temperature-control mode) or the target x-chromaticity coordinate X_{TRGT} and the target y-chromaticity coordinate Y_{TRGT} (e.g., when operating in the full-color-control mode). The determined duty cycles d₁-d₅ for the respective drive signals V_{DR1}-V_{DR5} may define ratios between the individual intensity level L_{IND1}-L_{IND5} of the respective emitter circuits 211-215 to cause the cumulative light emitted by the light source 210 to be controlled towards the target color temperature T_{TRGT} (e.g., when operating in the color-temperature-control mode) or the target color value as defined by the target x-chromaticity coordinate X_{TRGT} and the target y-chromaticity coordinate Y_{TRGT} (e.g., when operating in the full-color-control mode). When the control circuit 226 has determined to control less than the five LED drive circuits 221-225, the control circuit 226 may be configured to set the duty cycles d₁-d₅ for the respective drive signals V_{DR1}-V_{DR5} for those of the LED drive circuits 221-225 that are not being controlled to 0%. In some examples, the control circuit 226 may be configured to determine the duty cycles d₁-d₅ for the respective drive signals V_{DR1}-V_{DR5} based on the desired intensity level and/or brightness of the emitters.

The control circuit 226 may be configured to determine the on times T_{ON1}-T_{ON5} to of the respective drive signal V_{DR1}-V_{DR5} based on the duty cycles d₁-d₅ (e.g., and the operating period T_{OP}). Since the control circuit 226 may be configured to adjust each of the on times T_{ON1}-T_{ON5} by multiples of the adjustment amount Δ_{T-ON}, the control circuit 226 may be configured to round the duty cycles d₁-d₅ (e.g., the desired duty cycles) to the closest multiple of the adjustment amount Δ_{T-ON}.

When the target intensity level L_{TRGT} of the cumulative light emitted by the light source 210 is at the high-end intensity level L_{HE} (e.g., approximately 100%), the control circuit 226 may set the duty cycles d₁-d₅ such that the sum of the duty cycles d₁-d₅ may be approximately 100% (e.g., the sum of the on times T_{ON1}-T_{ON5} may be approximately equal to the operating period T_{OP}). The control circuit 226 may be configured to generate the drive signals V_{DR1}-V_{DR5} such that the on times T_{ON1}-T_{ON5} do not overlap in time within each cycle of operation of the driver module 220 (e.g., each instance of the operating period T_{OP}). Since the on times T_{ON1}-T_{ON5} of the drive signals V_{DR1}-V_{DR5} do not overlap in time, the LED drive circuits 221-225 may each conduct the respective LED current I_{LED1}-I_{LED5} having a peak magnitude up to the current limit I_{LIMIT} of the power converter circuit 232 (e.g., without the power converter circuit 232 limiting the magnitude of the LED currents I_{LED1}-I_{LED5}). In some examples, the control circuit 226 may be configured to generate the drive signals V_{DR1}-V_{DR5} such that the on times T_{ON1}-T_{ON5} have no more than a maximum overlap time T_{OL-MAX} (e.g., as will be described in greater detail below).

When the target intensity level L_{TRGT} of the cumulative light emitted by the light source 210 is less than the high-end intensity level L_{HE}, the control circuit 226 may be configured to scale the duty cycles (e.g., the duty cycles d₁-d₅ when the target intensity level L_{TRGT} is at the high-end intensity level L_{HE}) by the target intensity level L_{TRGT}, such that the ratios between the individual intensity levels L_{IND1}-L_{IND5} of the respective emitter circuits 211-215 are maintained constant. When the target intensity level L_{TRGT} is less than the high-end intensity level L_{HE}, the sum of the duty cycles d₁-d₅ may be less than 100% (e.g., the sum of the on time T_{ON1}-T_{ON5} may be less than the operating period T_{OP}), such that a dead time T_{DT} exists during the operating period T_{OP}. For example, the dead time T_{DT} may be equal to the difference between the operating period T_{OP} and the sum of the on times T_{ON1}-T_{ON5}, e.g.,

$${T}_{DT} = {T}_{OP} - ( {T}_{ON 1} + {T}_{ON 2} + {T}_{ON 3} + {T}_{ON 4} + {T}_{ON 5} ) .$$

During the dead time T_{DT}, the control circuit may be configured to drive the magnitudes of the drive signals V_{DR1}-V_{DR5} (e.g., all of the drive signals) low (e.g., towards circuit common).

The control circuit 226 may use the timer peripheral 229a to generate the drive signals V_{DR1}-V_{DR5} for controlling the LED drive circuits 221-225. For example, the control circuit 226 may use five channels of the timer peripheral to generate (e.g., independently generate) the respective drive signals V_{DR1}-V_{DR5} (e.g., one channel for each of the drive signals V_{DR1}-V_{DR5}). The control circuit 226 may configure the timer peripheral to generate the drive signals V_{DR1}-V_{DR5} as pulse-width modulated (PWM) signals. The control circuit 226 may be configured to set a timer period T_{TIM} of the periodic operation of the timer peripheral for generating the pulse-width modulated signals (e.g., the drive signals V_{DR1}-V_{DR5}), such that the pulse-width modulated signals may define one or more time slots (e.g., periodic time slots). As described in more detail herein, the control circuit 226 may configure a capture/compare register of each of the channels of the timer peripheral to set the on times T_{ON1}-T_{ON5} (e.g., and thus the duty cycles d₁-d₅) of the drive signals V_{DR1}-V_{DR5}. In addition, the control circuit 226 may configure each of the channels of the timer peripheral to be driven high (e.g., towards the supply voltage V_{CC}) at the beginning of each timer period T_{TIM} and then low (e.g., towards circuit common) at the end of each timer period T_{TIM}, or driven low (e.g., towards circuit common) at the beginning of each timer period T_{TIM} and then high (e.g., towards the supply voltage V_{CC}) at the end of each timer period T_{TIM}.

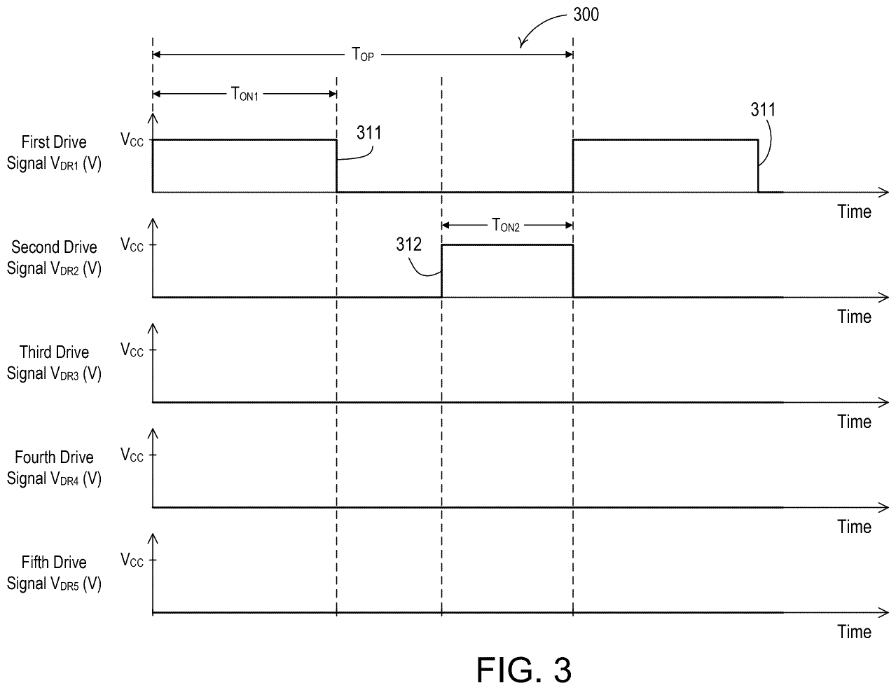

FIG. 3 is a diagram illustrating examples of the drive signals V_{DR1}-V_{DR5} generated by the control circuit 226 during a cycle 300 of operation of the driver module 220, for example, when the light source 210 comprises two emitter circuits (e.g., the emitter circuits 211-212). For example, the first emitter circuit 211 may represent a string of broad-spectrum LEDs at a first color temperature T₁ (e.g., a cool-while color temperature, such as approximately 3000 K) and the second emitter circuit 212 may represent a string of broad-spectrum LEDs at a second color temperature T₂ (e.g., a warm-white color temperature, such as approximately 1800 K). The control circuit 226 may be configured to generate the first and second drive signals V_{DR1}-V_{DR2} for controlling the first and second LED drive circuits 221-222, respectively, to adjust the present color temperature T_{PRES} of the cumulative light emitted by the light source 210 to the target color temperature T_{TRGT} (e.g., when in the color-temperature-control mode) and/or to adjust the present intensity level L_{PRES} of the cumulative light emitted by the light source 210. The control circuit 226 may be configured to control the LED drive circuits 211-222 to generate pulses 311-312 having respective on times T_{ON1}-T_{ON5}. The control circuit 226 may be configured to control the third, fourth, and fifth drive signals V_{DR3}-V_{DR5} to be driven low (e.g., towards approximately circuit common) throughout each cycle 300. For example, the control circuit may be configured to control the generation of the drive signals V_{DR1}-V_{DR2} at the operating frequency for, such that the drive signals V_{DR1}-V_{DR2} repeat during each cycle 300 of the operation of the driver module 220.

The control circuit 226 may configure the timer peripheral to generate the drive signals V_{DR1}-V_{DR2} as pulse-width modulated signals using two of the channels (e.g., first and second channels) of the timer peripheral. The control circuit 226 may be configured to set the timer period T_{TIM} to be the same for both of the channels (e.g., such that the first and second drive signals V_{DR1}-V_{DR2} are generated in the same time slot of the timer peripheral operation). For example, the timer period T_{TIM} may be equal to the operating period T_{OP} of the drive signals V_{DR1}-V_{DR2}. The control circuit 226 may configure the first channel (e.g., for generating the first drive signal V_{DR1}) to be driven high (e.g., towards the supply voltage V_{CC}) at the beginning of each timer period T_{TIM} and then low (e.g., towards circuit common) at the end of each timer period T_{TIM}, and configure the second channel (e.g., for generating the second drive signal V_{DR2}) to be driven low (e.g., towards circuit common) at the beginning of each timer period T_{TIM} and then high (e.g., towards the supply voltage V_{CC}) at the end of each timer period T_{TIM}.

The control circuit 226 may be configured to determine the duty cycles d₁-d₂ for the respective drive signals V_{DR1}-V_{DR2} based on the target color temperature T_{TRGT} and/or the target intensity level L_{TRGT} for the light source 210. For example, as shown in FIG. 3, the target intensity level L_{TRGT} may be less than the high-end intensity level L_{HE}. To determine the duty cycles d₁-d₂ for the respective drive signals V_{DR1}-V_{DR2} when the target intensity level L_{TRGT} is less than the high-end intensity level L_{HE}, the control circuit 226 may determine the duty cycles d₁-d₂ of the respective drive signals V_{DR1}-V_{DR2} when the target intensity level L_{TRGT} is at the high-end intensity level L_{HE}, and scale the duty cycles d₁-d₂ by the target intensity level L_{TRGT} (e.g., d₁=L_{TRGT}·d₁, and d₂=L_{TRGT}·d₂), such that the ratios between the individual intensity level L_{IND1}-L_{IND2} of the respective emitter circuits 211-212 are maintained constant. The control circuit 226 may configure the capture/compare registers of the first and second channels of the timer peripheral to generate the drive signals V_{DR1}-V_{DR2} with the determined duty cycles d₁-d₂ (e.g., as shown in FIG. 3). When the target intensity level L_{TRGT} is less than the high-end intensity level L_{HE}, the sum of the duty cycles d₁-d₂ may be less than 100% (e.g., the sum of the on times T_{ON1}-T_{ON2} may be less than the operating period T_{OP}). The dead time T_{DT} may extend between the on times T_{ON1}-T_{ON2} of the drive signals V_{DR1}-V_{DR2}, such that the sum of the on times T_{ON1}-T_{ON2} is equal to the operating period T_{OP}. During the dead time T_{DT}, the control circuit 226 may be configured to drive the magnitudes of the drive signals V_{DR1}-V_{DR2} low (e.g., towards circuit common). When the target intensity level L_{TRGT} changes, the control circuit 226 may reconfigure the capture/compare registers of the first and second channels of the timer peripheral, such that the control circuit 226 may generate the drive signals V_{DR1}-V_{DR2} with different duty cycles d₁-d₂ during a subsequent cycle of operation of the driver module 220. As shown in FIG. 3, the on times T_{ON1}-T_{ON2} of the drive signals V_{DR1}-V_{DR2} may be non-overlapping.

When the light source 210 comprises more than two emitter circuits, the control circuit 226 may generate the drive signals V_{DR1}-V_{DR5}, such the drive signals V_{DR1}-V_{DR5} include more than two on times during each cycle of the operation of the driver module 220. For example, each cycle of an operating period T_{OP} may include more than two on times, where each on time may correspond to a drive signal V_{DR1}-V_{DR5}. For example, when the light source 210 comprises three emitter circuits (e.g., the emitter circuits 211, 212, 213), the control circuit 226 may be configured to generate the first, second, and third drive signals V_{DR1}-V_{DR3} for controlling the first, second, and third LED drive circuits 221-223, respectively, such that the drive signals V_{DR1}-V_{DR3} include the three on times T_{ON1}-T_{ON3} during each of the cycles of operation of the driver module 220. In addition, when the light source 210 comprises the five emitter circuits 211-215 (e.g., as shown in FIG. 2), the control circuit 226 may be configured to generate the drive signals V_{DR1}-V_{DR5} for controlling the LED drive circuits 221-225, respectively, such that the drive signals V_{DR1}-V_{DR5} include the five on times T_{ON1}-T_{ON5} within each of the cycles of operation of the driver module 220.

To generate the drive signals V_{DR1}-V_{DR5} with more than two on times during each cycle of operation of the driver module 220 (e.g., one instance of the operating period T_{OP}), the control circuit 226 may reconfigure the timer peripheral during each cycle. Each time that the control circuit 226 reconfigures the timer peripheral (e.g., during a single cycle of operation), the control circuit 226 may set the timer period T_{TIM} to be shorter than the operating period T_{OP}. The control circuit 226 may be configured to use the peripheral DMA controller to reconfigure the timer peripheral during a single cycle of operation. When the timer count for a particular timer channel reaches the timer period T_{TIM}, the timer channel may overflow (e.g., a timer overflow event may occur for that particular channel). Whenever a timer overflow event occurs, the peripheral DMA controller may be configured to reconfigure the timer peripheral.

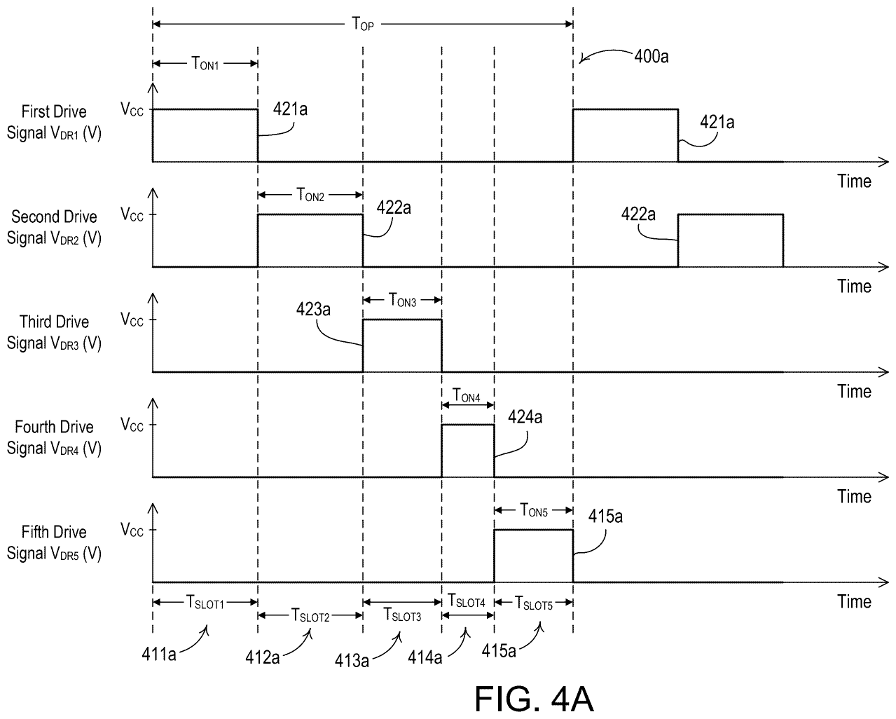

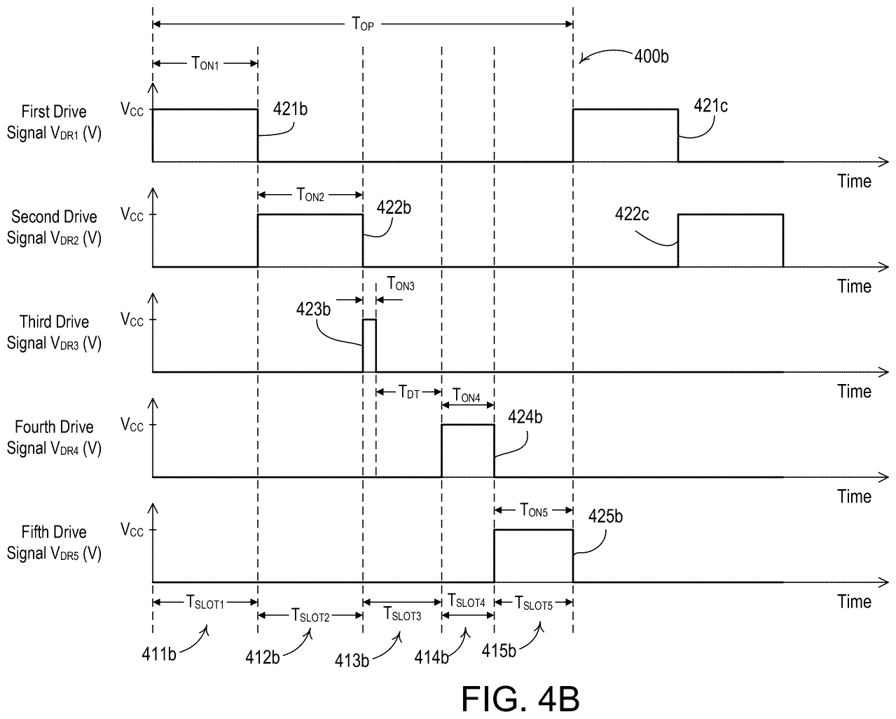

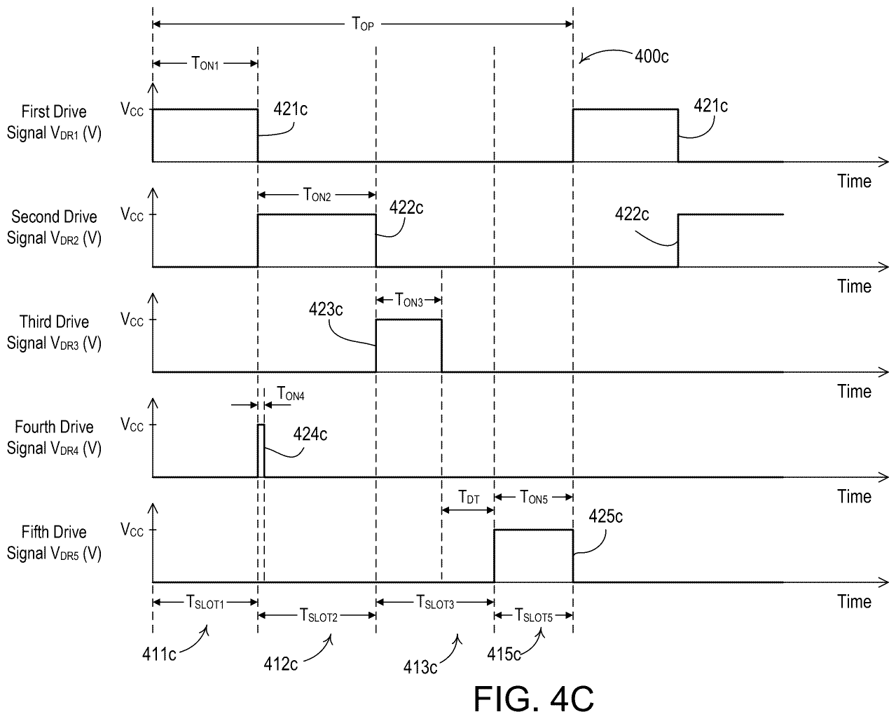

FIG. 4A is a diagram illustrating examples of the drive signals V_{DR1}-V_{DR5} generated by the control circuit 226 during a cycle 400a of operation of the driver module 220, for example, when the control circuit 226 is controlling all of the five LED drive circuit 221-225 to control the light source 210. For example, the light source 210 may comprise five emitter circuits (e.g., the emitter circuits 211-215 as shown in FIG. 2). The control circuit 226 may be configured to control the LED drive circuits 221-225 to generate pulses 421a-425a having respective on times T_{ON1}-T_{ON5} during respective time slots 411a-415a of the cycle 400a. When the target intensity level L_{TRGT} of the cumulative light emitted by the light source 210 is at the high-end intensity level L_{HE} (e.g., approximately 100%), the duty cycles d₁-d₅ may be sized such that the duty cycles d₁-d₅ add up to approximately 100% (e.g., the sum of the on times T_{ON1}-T_{ON5} may be approximately equal to the operating period T_{OP}). As shown in FIG. 4A, the control circuit 226 may be configured to control the drive signals V_{DR1}-V_{DR5} such that the pulses 421a-425a are non-overlapping (e.g., substantially non-overlapping). Each of the time slots 411a-415a may be characterized by a respective slot time T_{SLOT1}, T_{SLOT2}, T_{SLOT3}, T_{SLOT4}, T_{SLOT5}. The time slots 411a-415a may extend across the cycle 400a (e.g., such that the sum of the slot times T_{SLOT1}-T_{SLOT5} may be equal to the operating period T_{OP}). When the target intensity level L_{TRGT} of the cumulative light emitted by the light source 210 is at the high-end intensity level L_{HE}, the on times T_{ON1}-T_{ON5} of the respective drive signals V_{DR1}-V_{DR5} may each be approximately equal to the slot times T_{SLOT1}-T_{SLOT5} of the respective time slots 411a-415a.

The control circuit 226 may be configured to use the peripheral DMA controller to reconfigure the timer peripheral during each of the time slots 411a-415a to allow the timer peripheral to generate the drive signals V_{DR1}-V_{DR5} using five channels (e.g., first, second, third, fourth, and fifth channels) of the timer peripheral. During each of the time slots 411a-415a (e.g., in response to the timer overflow event for the previous time slot), the peripheral DMA controller may be configured to reconfigure the timer peripheral for operation during a subsequent one of the time slots 411a-415a (e.g., the next one of the time slots 411a-415a).

The control circuit 226 may maintain two blocks in the memory 227b for use when generating the drive signals V_{DR1}-V_{DR5}. The control circuit 226 may be configured to store data for generating the drive signals V_{DR1}-V_{DR5} in a first block (e.g., an edit block) in the memory 227b, and the peripheral DMA controller may be configured to retrieve data for configuring the timer peripheral to generate the drive signals V_{DR1}-V_{DR5} from a second block (e.g., an execute block) in the memory 227b. The data stored in the first and second blocks in the memory 227b may enable the timer peripheral to properly generate the drive signals V_{DR1}-V_{DR5}. For example, the data stored in the first and second blocks in the memory 227b may represent the on times T_{ON1}-T_{ON5} and the slot times T_{SLOT1}-T_{SLOT5} for generating the drive signals V_{DR1}-V_{DR5}. In addition, the data stored in the first and second blocks in the memory 227b may represent instructions for configuring and/or storing data in the registers of the timer peripheral. At each timer overflow event generated by the timer peripheral, the peripheral DMA controller may be configured to reconfigure the timer peripheral with data from the second block depending upon which of the channels of the timer peripheral generated the timer overflow event. For example, at the timer overflow event for the first channel of the timer peripheral (e.g., at the end of the first time slot 411a and during the second time slot 402a), the peripheral DMA controller may be configured to retrieve data representing the on time T_{ON3} and the slot time T_{SLOT3} for the third time slot 413a, and store the data representing the on time T_{ON3} and the slot time T_{SLOT3} for the third time slot 413a in the registers of the timer peripheral. Each of the time slots 411a-415a may be characterized by a minimum slot time T_{SLOT-MIN} (e.g., approximately 4 microseconds), which may be a time period that is long enough to allow the peripheral DMA controller to properly reconfigure the timer peripheral for the next time slot.

When the target color temperature T_{TRGT} and/or the target intensity level L_{TRGT} for the light source 210 changes (e.g., in response to control data received in a message via the communication circuit 227a), the control circuit 226 may be configured to adjust (e.g., edit) data in the first block (e.g., the edit block) in the memory 227b. The control circuit 226 may be configured to determine updated duty cycles d₁-d₂ for the respective drive signals V_{DR1}-V_{DR2} based on the target color temperature T_{TRGT} and/or the target intensity level L_{TRGT} for the light source 210, and to calculate updated on times T_{ON1}-T_{ON5} and the slot times T_{SLOT1}-T_{SLOT5} based on the updated duty cycles d₁-d₂. When the control circuit 226 is finished editing the first block in the memory 227b based on the updated target color temperature T_{TRGT} and/or the updated target intensity level L_{TRGT}, the control circuit 226 may be configured to cause the peripheral DMA controller to retrieve the data for re-configuring the timer peripheral from the first block to generate the drive signals V_{DR1}-V_{DR5} during the next cycle of operation of the driver module 220 (e.g., the first block may now be the execute block and the second block may be the edit block). The control circuit 226 may subsequently edit the second block in the memory 227b in response to changes in the target color temperature T_{TRGT} and/or the target intensity level L_{TRGT} for the light source 210.

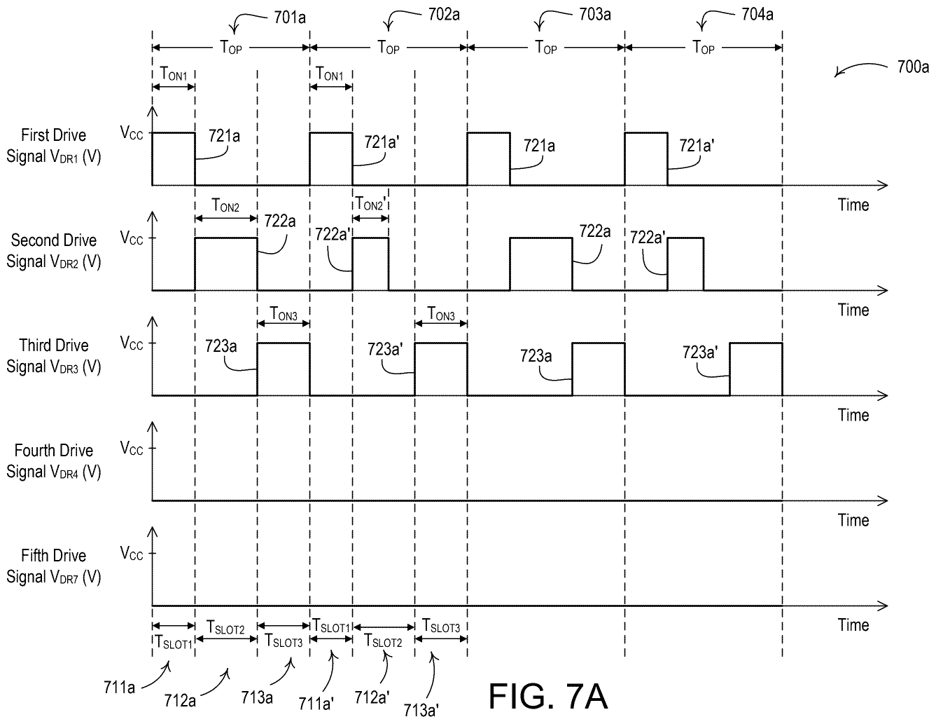

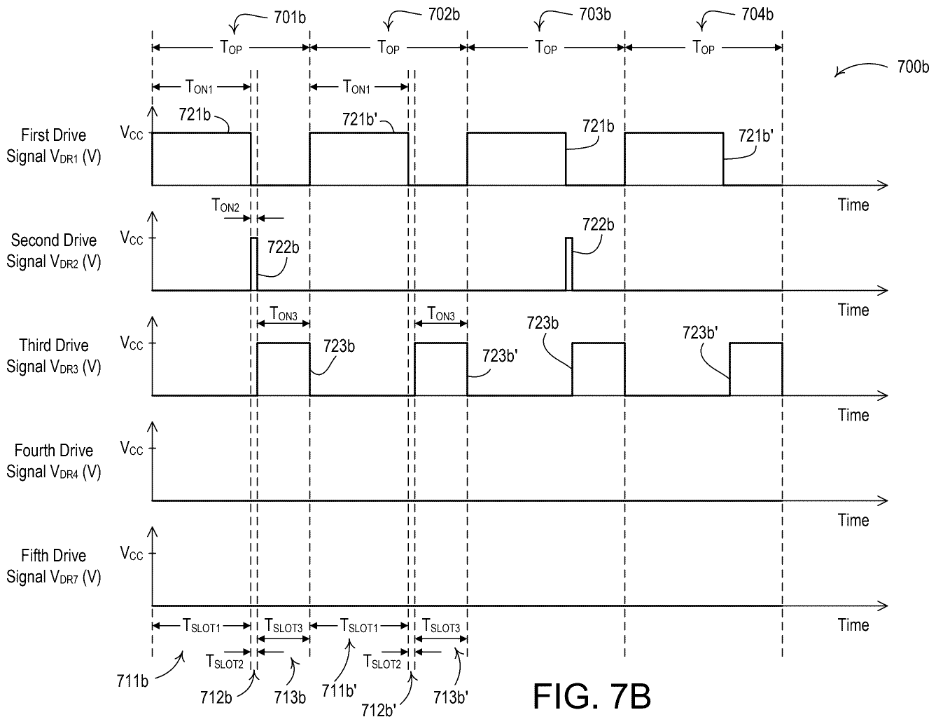

While only one full cycle 400a of operation of the driver module 220 is shown in FIG. 4A, the control circuit 226 may be configured to generate the drive signals V_{DR1}-V_{DR5} in the same way during subsequent cycles as shown during the operating period T_{OP} in FIG. 4A when the target color temperature T_{TRGT} and/or the target intensity level L_{TRGT} are in steady-state conditions. When the target color temperature T_{TRGT} and/or the target intensity level L_{TRGT} for the light source 210 change, the control circuit 226 may be configured to adjust the generation of the drive signals V_{DR1}-V_{DR5} from one cycle of operation of the driver module 220 to the next after which the generation the drive signals V_{DR1}-V_{DR5} may repeat on a periodic basis (e.g., from one cycle 400a to the next) while the target color temperature T_{TRGT} and/or the target intensity level L_{TRGT} are in steady-state conditions. In some examples, the control circuit may be configured to control the generation of the drive signals V_{DR1}-V_{DR2}, such that the drive signals V_{DR1}-V_{DR2} do not repeat, but may vary slightly, during each cycle 400a of operation of the driver module 220 (e.g., as will be described in greater detail below with respect to FIGS. 7A and 7B).

FIG. 4B is a diagram illustrating examples of the drive signals V_{DR1}-V_{DR5} generated by the control circuit 226 during a cycle 400b of operation of the driver module 220, for example, when the target intensity level L_{TRGT} is less than the high-end intensity level L_{HE}. The control circuit 226 may be configured to control the LED drive circuits 221-225 to generate pulses 421b-425b having respective on times T_{ON1}-T_{ON5} during respective time slots 411b-415b of the cycle 400b. When the target intensity level L_{TRGT} of the cumulative light emitted by the light source 210 is less than the high-end intensity level L_{HE}, the control circuit 226 may be configured to generate the drive signals V_{DR1}-V_{DR5} such that at least one of the on times T_{ON1}-T_{ON5} is less than the slot time T_{SLOT1}-T_{SLOT5} of the respective time slot 411b-415b. As shown in FIG. 4B, the on times T_{ON1}-T_{ON5} may be non-overlapping (e.g., substantially non-overlapping) and the sum of the slot times T_{SLOT1}-T_{SLOT5} may be equal to the operating period T_{OP}.

To determine the duty cycles d₁-d₅ for the respective drive signals V_{DR1}-V_{DR5} when the target intensity level L_{TRGT} is less than the high-end intensity level L_{HE}, the control circuit 226 may be configured to scale the duty cycles by the target intensity level L_{TRGT} (e.g., d₁=L_{TRGT}·d₁; d₂=L_{TRGT}·d₂; d₃=L_{TRGT}·d₃; d₄=L_{TRGT}·d₄; and d₅=L_{TRGT}·d₅), such that the ratios between the individual intensity levels L_{IND1}-L_{IND5} of the respective emitter circuits 211-215 are maintained constant. As a result, at least one of the time slots 411b-415b may comprise a dead time T_{DT} during which the control circuit does not drive any of the drive signals V_{DR1}-V_{DR5} high towards the supply voltage V_{CC}. For example, the control circuit 226 may be configured to add the dead time T_{DT} to the one of the time slots 411b-415b that has the shortest respective one of the on times T_{ON1}-T_{ON5}. As shown in FIG. 4B, the dead time T_{DT} may occur, for example, during the third time slot 413b, such that the sum of the on time T_{ON3} of the third drive signal V_{DR3} and the dead time T_{DT} is approximately equal to the slot time T_{SLOT3} of the third time slot 413b. While the dead time T_{DT} is shown in the third time slot 413b in FIG. 4B, the dead time T_{DT} may also be located in any of the time slots 411b-415b. In addition, multiple time slots may include periods of dead time.

In some examples, the control circuit 226 may be configured to allow for some overlap between the on times in two adjacent time slots. For example, the length of the overlap may be limited to a maximum overlap time T_{OL-MAX} (e.g., approximately 20 microseconds) which may be less than the amount of time required to trip the overcurrent protection circuit in the power converter circuit 232. The maximum overlap time T_{OL-MAX} may be, for example, greater than the minimum slot time T_{SLOT-MIN}.

FIG. 4C is a diagram illustrating examples of the drive signals V_{DR1}-V_{DR5} generated by the control circuit 226 during a cycle 400c of operation of the driver module 220, for example, when one of the on times (e.g., the on time T_{ON4} of the fourth drive signal V_{DR4}) is less than a minimum slot time T_{SLOT-MIN}. The control circuit 226 may be configured to control the LED drive circuits 221-225 to generate pulses 421c-425c having respective on times T_{ON1}-T_{ON5} during respective time slots 411c-415c of the cycle 400c. When one or more of the on times T_{ON1}-T_{ON5} is less than the minimum slot time T_{SLOT-MIN}, the control circuit 226 may be configured to generate the drive signals V_{DR1}-V_{DR5} such that two or more of the pulses 421c-425c occur during the same one of the slot times T_{SLOT1}-T_{SLOT5}. Since the minimum slot time T_{SLOT-MIN} is less than the maximum overlap time T_{OL-MAX}, the control circuit 226 may be configured to generate the one of the pulses 421c-425c that has the on time that is less than the minimum slot time T_{SLOT-MIN} at the same time as the pulse of one of the other drive signals. For example, the control circuit 226 may be configured to generate the pulse 424c having the on time that is less than the minimum slot time T_{SLOT-MIN} during the one of the time slots 411c-415c that has the longest one of the on times T_{ON1}-T_{ON5}. As shown in FIG. 4C, the pulse 424c of the fourth drive signal V_{DR4} may occur, for example, in the second time slot 412c at the same time as the pulse 422c of the second drive signal V_{DR2}. As a result, there may be less time slots during each cycle 400c of the operation of the driver module 220, e.g., four time slots 411c, 412c, 413c, 415c as shown in FIG. 4C. For example, the control circuit 226 may be configured to set the slot time T_{SLOT4} of the fourth time slot 414c equal to zero seconds.

In some examples, the control circuit 226 may control less than all of the five LED drive circuits 221-225 to control the light source 210. For example, the control circuit 226 may determine to control less than the five LED drive circuits 221-225 based on the number of the number of emitter circuits in the light source 210 (e.g., when the light source 210 includes less than the five emitter circuits 211-215). In addition, the control circuit 226 may determine to control less than the five LED drive circuits 221-225 based on the color-control mode in which the control circuit is presently operating and/or the emitter color of the emitters in each of the emitter circuits of the light source 210.

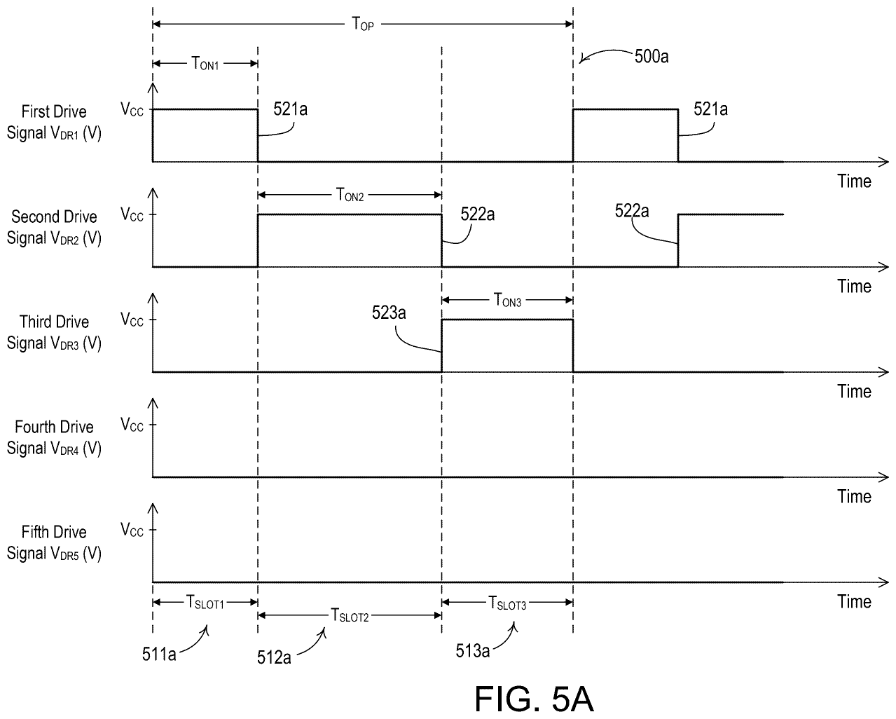

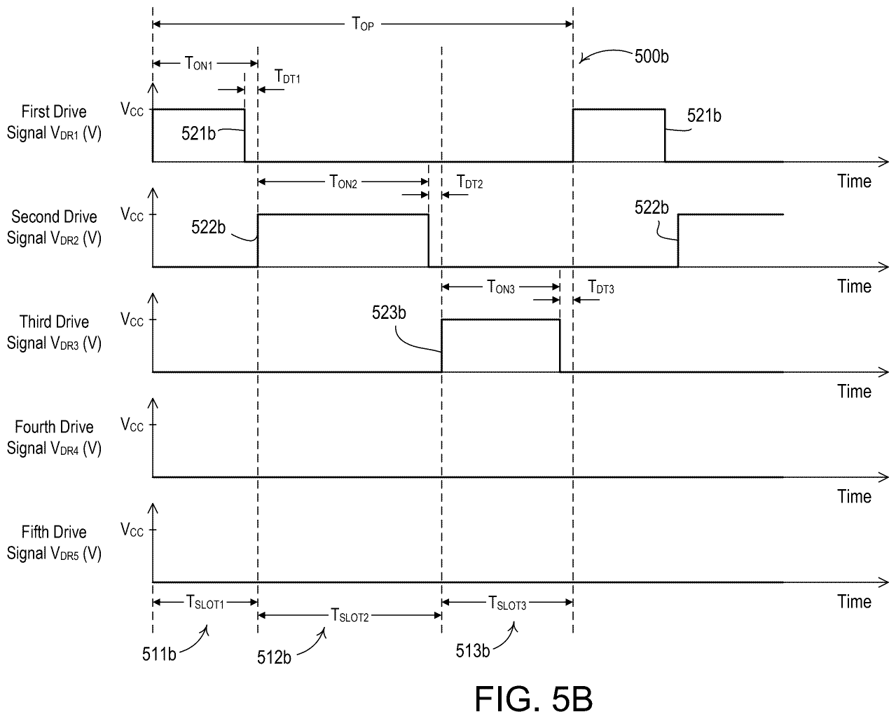

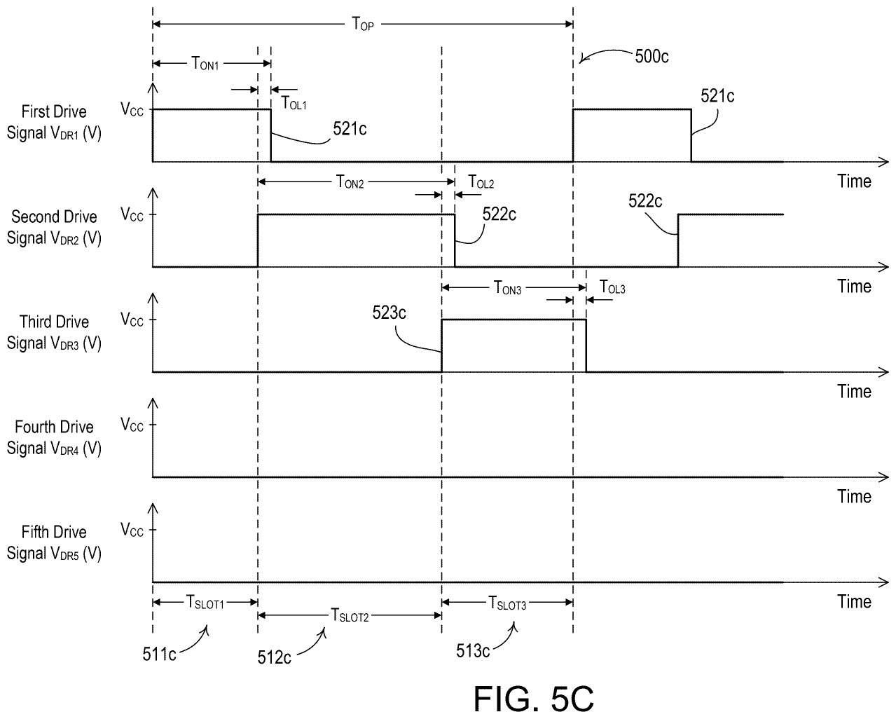

FIG. 5A is a diagram illustrating examples of the drive signals V_{DR1}-V_{DR3} generated by the control circuit 226 during a cycle 500a of the operation of the driver module 220, for example, when the control circuit 226 is controlling three of the LED drive circuits 221-225 to control the light source 210. For example, the light source 210 may comprise three emitter circuits (e.g., the emitter circuits 211-213) and/or the control circuit 226 may determine to control three of the LED drive circuits (e.g., the LED drive circuits 221-223) based on the color-control mode in which the control circuit is presently operating and/or the emitter color of the emitters in each of the emitter circuits of the light source 210. The control circuit 226 may be configured to control the LED drive circuits 221-223 to generate pulses 521a-523a having respective on times T_{ON1}-T_{ON3} during respective time slots 511a-513a of the cycle 500a. The control circuit 226 may be configured to control the fourth and fifth drive signals V_{DR4}-V_{DR5} to be driven low (e.g., towards approximately circuit common). Each of the time slots 511a-513a may be characterized by a respective slot time T_{SLOT1}, T_{SLOT2}, T_{SLOT3}. The time slots 511a-513a may extend across the length of the operating period T_{OP}, (e.g., such that the sum of the slot times T_{SLOT1}-T_{SLOT3} may be equal to the operating period T_{OP}).

As shown in FIG. 5A, the control circuit 226 may be configured to generate the drive signals V_{DR1}-V_{DR3} such that the pulses 521a-523a are non-overlapping (e.g., substantially non-overlapping). When the target intensity level L_{TRGT} of the cumulative light emitted by the light source 210 is at the high-end intensity level L_{HE}, the duty cycles d₁-d₃ of the drive signals V_{DR1}-V_{DR3} may be sized such that the duty cycles d₁-d₃ add up to approximately 100% (e.g., the sum of the on time T_{ON1}-T_{ON3} may be approximately equal to the operating period T_{OP}). When the target intensity level L_{TRGT} of the cumulative light emitted by the light source 210 is at the high-end intensity level L_{HE}, the on times T_{ON1}-T_{ON3} of the respective drive signals V_{DR1}-V_{DR5} may each be approximately equal to the slot times T_{SLOT1}-T_{SLOT3} of the respective time slots 511a-513a. While FIG. 5A is shown with the control circuit 226 generating the drive signals V_{DR1}-V_{DR3} to control the first, second, and third LED drive circuits 221-223, the control circuit 226 could generate the appropriate drive signals to control any three of the LED drive circuits 221-225 (e.g., depending upon which of the emitter circuits 211-215 of the light source 210 the driver module 220 needs to control).

The control circuit 226 may be configured to use the peripheral DMA controller to reconfigure the timer peripheral during each of the time slots 511a-513a to allow the timer peripheral to generate the drive signals V_{DR1}-V_{DR3} using three channels of the timer peripheral. During each of the time slots 511a-513a (e.g., at each timer overflow event for the previous time slot), the peripheral DMA controller may be configured to reconfigure the timer peripheral for operation during a subsequent one of the time slots 511a-513a (e.g., the next one of the time slots 511a-513a). At each of the timer overflow events generated by the timer peripheral, the peripheral DMA controller may be configured to reconfigure the timer peripheral with data from memory (e.g., depending upon the channel of the timer peripheral that generated the timer overflow event). For example, at the timer overflow event for the first channel of the timer peripheral (e.g., at the end of the first time slot 511a and during the second time slot 512a), the peripheral DMA controller may be configured to retrieve data representing the on time T_{ON3} and the slot time T_{SLOT3} for the third time slot 513a, and store the data representing the on time T_{ON3} and the slot time T_{SLOT3} for the third time slot 513a in the registers of the timer peripheral.

When the target intensity level L_{TRGT} of the cumulative light emitted by the light source 210 is less than the high-end intensity level L_{HE}, the control circuit 226 may be configured to generate the drive signals V_{DR1}-V_{DR3} such that at least one of the on times T_{ON1}-T_{ON3} is less than the slot time T_{SLOT1}-T_{SLOT3} of the respective time slot 511a-513a. While not shown in FIG. 5A, the control circuit 226 may also be configured to generate the drive signals V_{DR1}-V_{DR3} such that at least one of the time slots 511a-513a may comprise a dead time T_{DT} during which the control circuit does not drive any of the drive signals V_{DR1}-V_{DR3} high towards the supply voltage V_{CC}. For example, the control circuit 226 may be configured to add the dead time T_{DT} to the one of the time slots 501a-503a that has the shortest respective one of the on times T_{ON1}-T_{ON3} (e.g., in a similar manner as shown in FIG. 4B and described above).

FIG. 5B is a diagram illustrating examples of the drive signals V_{DR1}-V_{DR3} generated by the control circuit 226 during a cycle 500b of the operation of the driver module 220, for example, when the control circuit 226 is controlling three of the LED drive circuits 221-225 to control the light source 210. For example, the light source 210 may comprise three emitter circuits (e.g., the emitter circuits 211-213) and/or the control circuit 226 may determine to control three of the LED drive circuits (e.g., the LED drive circuits 221-223) based on the color-control mode in which the control circuit is presently operating and/or the emitter color of the emitters in each of the emitter circuits of the light source 210. The control circuit 226 may be configured to control the LED drive circuits 221-223 to generate pulses 521b-523b having respective on times T_{ON1}-T_{ON3} during respective time slots 511b-513b of the cycle 500b. When the target intensity level L_{TRGT} of the cumulative light emitted by the light source 210 is less than the high-end intensity level L_{HE}, the control circuit 226 may be configured to generate the drive signals V_{DR1}-V_{DR3} such that at least one of the on times T_{ON1}-T_{ON3} is less than the slot time T_{SLOT1}-T_{SLOT3} of the respective time slot 511b-513b. The control circuit 226 may also be configured to generate the drive signals V_{DR1}-V_{DR3} such that at least one of the time slots 511b-513b may comprise at least a portion of dead time during which the control circuit does not drive any of the drive signals V_{DR1}-V_{DR3} high towards the supply voltage V_{CC}. As shown in FIG. 5B, the control circuit 226 may be configured to add a respective dead time T_{DT1}-T_{DT3} to each of the time slots 511b-513b. Further, when configured to drive more than three emitter circuits, the control circuit 226 may be configured to add a respective dead time to each of the time slots associated with each of the emitter circuits.

FIG. 5C is a diagram illustrating examples of the drive signals V_{DR1}-V_{DR3} generated by the control circuit 226 during a cycle 500c of the operation of the driver module 220, for example, when the control circuit 226 is controlling three of the LED drive circuits 221-225 to control the light source 210. For example, the light source 210 may comprise three emitter circuits (e.g., the emitter circuits 211-213) and/or the control circuit 226 may determine to control three of the LED drive circuits (e.g., the LED drive circuits 221-223) based on the color-control mode in which the control circuit is presently operating and/or the emitter color of the emitters in each of the emitter circuits of the light source 210. The control circuit 226 may be configured to control the LED drive circuits 221-223 to generate with pulses 521c-523c having respective on times T_{ON1}-T_{ON3} during respective time slots 511c-513c of the cycle 500c. The control circuit 226 may be configured to generate the drive signals V_{DR1}-V_{DR3} such that the pulses 521c-523c overlap with each other slightly. For example, the first and second pulses 521c, 522c may overlap for an overlap time T_{OL1}, the second and third pulses 522c, 523c may overlap for an overlap time T_{OL2}, and the first and third pulses 521c, 523c may overlap for an overlap time T_{OL3} or some combination thereof. Each of the overlap times T_{OL1}, T_{OL2}, T_{OL3} may be shorter than, for example, maximum overlap time T_{OL-MAX} and may be of different durations.

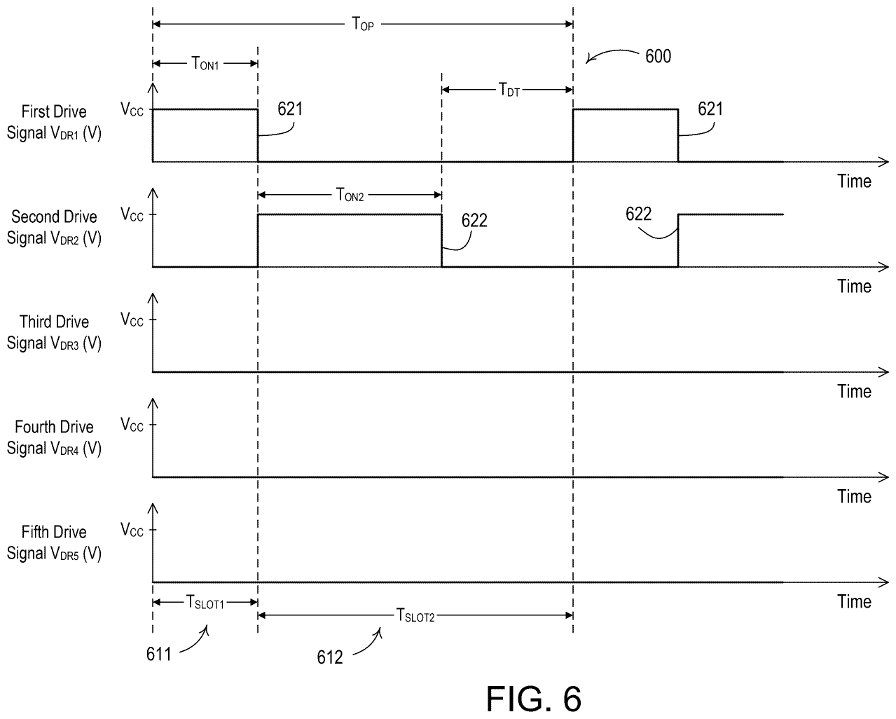

FIG. 6 is a diagram illustrating examples of the drive signals V_{DR1}-V_{DR2} generated by the control circuit 226 during a cycle 600 of the operation of the driver module 220, for example, when the control circuit 226 is controlling two of the LED drive circuits 221-225 to control the light source 210. For example, the light source 210 may comprise two emitter circuits (e.g., the emitter circuits 211-212) and/or the control circuit 226 may determine to control two of the LED drive circuits (e.g., the LED drive circuits 221-222) based on the color-control mode in which the control circuit is presently operating and/or the emitter color of the emitters in each of the emitter circuits of the light source 210. The control circuit 226 may be configured to control the LED drive circuits 221-222 to generate with pulses 621-622 having respective on times T_{ON1}-T_{ON2} during respective time slots 611-612 of the cycle 600. The control circuit 226 may be configured to control the third, fourth, and fifth drive signals V_{DR3}-V_{DR5} to be driven low (e.g., towards approximately circuit common). Each of the time slots 611-612 may be characterized by a respective slot time T_{SLOT1}, T_{SLOT2}. The time slots 611-612 may extend across the length of the operating period T_{OP}, (e.g., such that the sum of the slot times T_{SLOT1}-T_{SLOT2} may be equal to the operating period T_{OP}).

As shown in FIG. 6, the control circuit 226 may be configured to generate the drive signals V_{DR1}-V_{DR2} such that the pulses 621-622 are non-overlapping (e.g., substantially non-overlapping). When the target intensity level L_{TRGT} of the cumulative light emitted by the light source 210 is at the high-end intensity level L_{HE}, the duty cycles d₁-d₂ of the drive signals V_{DR1}-V_{DR2} may be sized such that the duty cycles d₁-d₂ add up to approximately 100% (e.g., the sum of the on time T_{ON1}-T_{ON2} may be approximately equal to the operating period T_{OP}). When the target intensity level L_{TRGT} of the cumulative light emitted by the light source 210 is at the high-end intensity level L_{HE}, the on times T_{ON1}-T_{ON2} of the respective drive signals V_{DR1}-V_{DR2} may each be approximately equal to the slot times T_{SLOT1}-T_{SLOT2} of the respective time slots 611-612. While FIG. 6 is shown with the control circuit 226 generating the drive signals V_{DR1}-V_{DR2} to control the first and second LED drive circuits 221-222, the control circuit 226 could generate the appropriate drive signals to control any two of the LED drive circuits 221-225 (e.g., depending upon which of the emitter circuits 211-215 of the light source 210 the driver module 220 needs to control).

The control circuit 226 may be configured to use the peripheral DMA controller to reconfigure the timer peripheral during each of the time slots 611-612 to allow the timer peripheral to generate the drive signals V_{DR1}-V_{DR2} using two channels of the timer peripheral. During each of the time slots 611-612 (e.g., at each timer overflow event for the previous time slot), the peripheral DMA controller may be configured to reconfigure the timer peripheral for operation during a subsequent one of the time slots 611-612 (e.g., the next one of the time slots 611-612). At each of the timer overflow events generated by the timer peripheral, the peripheral DMA controller may be configured to reconfigure the timer peripheral with data from memory (e.g., depending upon the channel of the timer peripheral that generated the timer overflow event). For example, at the timer overflow event for the first channel of the timer peripheral (e.g., at the end of the first time slot 611 and during the second time slot 612), the peripheral DMA controller may be configured to retrieve data representing the on time T_{ON1} and the slot time T_{SLOT1} for the first time slot 611, and store the data representing the on time T_{ON1} and the slot time T_{SLOT1} for the first time slot 611 in the registers of the timer peripheral.

When the target intensity level L_{TRGT} of the cumulative light emitted by the light source 210 is less than the high-end intensity level L_{HE}, the control circuit 226 may be configured to generate the drive signals V_{DR1}-V_{DR2} such that at least one of the on times T_{ON1}-T_{ON2} is less than the slot time T_{SLOT1}-T_{SLOT2} of the respective time slot 611-612. The control circuit 226 may be configured to generate the drive signals V_{DR1}-V_{DR2} such that at least one of the time slots 611-612 may comprise a dead time T_{DT} during which the control circuit does not drive any of the drive signals V_{DR1}-V_{DR2} high towards the supply voltage V_{CC}. For example, the control circuit 226 may be configured to add the dead time T_{DT} to the one of the time slots 611-612 that has the shortest respective one of the on times T_{ON1}-T_{ON2} (e.g., in a similar manner as shown in FIG. 4B and described above).

The resolution to which the control circuit 226 may adjust the duty cycles d₁-d₅ of the drive signals V_{DR1}-V_{DR5}, and thus the respective intensity levels of the emitter circuits 211-215 of the light source 210 controlled by the LED drive circuits 221-225, may be limited by the adjustment amount Δ_{T-ON} (e.g., a minimum step size). As previously mentioned, the control circuit 226 may be configured to adjust (e.g., only adjust) the on times T_{ON1}-T_{ON5} to discrete values (e.g., achievable on times) that are spaced apart by the adjustment amount Δ_{T-ON}. To control the respective intensity levels of the emitter circuits 211-215 of the light source 210 to levels between levels that are achieved when any of the on times T_{ON1}-T_{ON5} are at two adjacent achievable on times (e.g., that are not multiples of the adjustment amount Δ_{T-ON}), the control circuit 226 may be configured to “dither” (e.g., adjust) the respective on time T_{ON1}-T_{ON5} of one or more of the drive signals V_{DR1}-V_{DR5} between two of the adjacent achievable on times from one cycle of operation of the driver module 220 to the next. As a result, the drive signals V_{DR1}-V_{DR5} may not repeat during each cycle of operation of the driver module 220 (e.g., as the drive signals V_{DR1}-V_{DR5} as shown in FIGS. 4A-6).

FIG. 7A is a diagram illustrating examples of the drive signals V_{DR1}-V_{DR5} generated by the control circuit 226 during multiple cycles 701a, 702a, 703a, 704a of operation of the driver module 220, for example, when the drive signals V_{DR1}-V_{DR5} do not repeat during each of the cycles 701a-704a of operation of the driver module 220. In the example of FIG. 7A, the control circuit 226 may be controlling three of the LED drive circuits 221-225 to control the light source 210. For example, the light source 210 may comprise three emitter circuits (e.g., the emitter circuits 211-213) and/or the control circuit 226 may determine to control three of the LED drive circuits (e.g., the LED drive circuits 221-223) based on the color-control mode (e.g., and/or intensity level) in which the control circuit is presently operating and/or the emitter color of the emitters in each of the emitter circuits of the light source 210. During the first cycle 701a, the control circuit 226 may be configured to control the LED drive circuits 221-223 to generate pulses 721a-723a having respective on times T_{ON1}-T_{ON3} in respective time slots 711a-713a. The control circuit 226 may be configured to control the fourth and fifth drive signals V_{DR4}-V_{DR5} to be driven low (e.g., towards approximately circuit common). Each of the time slots 711a-713a may be characterized by a respective slot time T_{SLOT1}, T_{SLOT2}, T_{SLOT3}. The time slots 711a-713a may extend across the length of the first cycle 701a, (e.g., such that the sum of the slot times T_{SLOT1}-T_{SLOT3} may be equal to the operating period T_{OP}).

The control circuit 226 may be configured to adjust the on times T_{ON1}-T_{ON3} of the drive signals V_{DR1}-V_{DR3} during one or more of the subsequent cycles that occur after the first cycle 701a. The control circuit 226 may be configured to adjust (e.g., dither) the respective on times T_{ON1}-T_{ON3} of one or more of the drive signals V_{DR1}-V_{DR3} between two of the achievable on times from one cycle to the next (e.g., from the first cycle 701a to the second cycle 702a). As noted above, the achievable on times may be multiples of the adjustment amount Δ_{T-ON}. During the second cycle 702a, the control circuit 226 may be configured to control the LED drive circuits 221-223 to generate pulses 721a′-723a′ in respective time slots 711a′-713a′. The time slots 711a′-711a′ of the second cycle 702a may have the same lengths as the time slots 711a-713a of the first cycle 701a, respectively. The control circuit 226 may generate the respective pulses 721a′, 723a′ in the first and third time slots 711a′, 713a′ of the second cycle 702a to have the same lengths as the respective pulses 721a, 723a in the first and third time slots 711a, 713a of the first cycle 701a. However, the control circuit 226 may may adjust an on time T_{ON2}′ of the second drive signal V_{DR2} during the second time slot 712a′ of the second cycle 702a as compared to the on time T_{ON2} of the second drive signal V_{DR2} during the second time slot 712a of the first cycle 701a. The on time T_{ON2}′ of the second drive signal V_{DR2} during the second time slot 712a′ of the second cycle 702a may be, for example, shorter than the on time T_{ON2} of the second drive signal V_{DR2} during the second time slot 712a of the first cycle 701a (e.g., as shown in FIG. 7A). The on time T_{ON2}′ of the second drive signal V_{DR2} during the second time slot 712a′ of the second cycle 702a may be visibly shorter than the on time T_{ON2} of the second drive signal V_{DR2} during the second time slot 712a of the first cycle 701a to illustrate the dithering of the on time T_{ON2} of the second drive signal V_{DR2} in FIG. 7A. In some examples, the control circuit 226 may adjust the on time T_{ON2} of the second drive signal V_{DR2} between two of the adjacent achievable on times, which may be separated (e.g., only separated) by the adjustment amount Δ_{T-ON} (e.g., and thus the change in the on time T_{ON2} of the second drive signal V_{DR2} would not be perceptible at the scale of FIG. 7A).

The control circuit 226 may be configured to repeat the operation of the driver module 220 from the first and second cycles 701a, 702a in subsequent cycles. The control circuit 226 may be configured to repeat the pulses 721a-723a of the drive signals V_{DR1}-V_{DR3} of the first cycle 701a in the third cycle 703a (e.g., such that the drive signals V_{DR1}-V_{DR3} have the same on times as the first cycle 701a). The control circuit 226 may be configured to repeat the pulses 721a′-723a′ of the drive signals V_{DR1}-V_{DR3} of the second cycle 702a in the fourth cycle 704a (e.g., such that the drive signals V_{DR1}-V_{DR3} have the same on times as the second cycle 702a). In this manner, the control circuit 226 may continue to adjust (e.g., dither) the on time T_{ON2} of the second drive signal V_{DR2} between two of the achievable on times from one cycle of operation of the driver module 220 to the next. For example, the control circuit 226 may repeat the pulses 721a-723a of the drive signals V_{DR1}-V_{DR3} of the first cycle 701a in the odd numbered cycles, and repeat the pulses 721a′-723a′ of the drive signals V_{DR1}-V_{DR3} of the second cycle 702a in even numbered cycles, such that the control circuit may adjust (e.g., dither) the on time T_{ON2} of the second drive signal V_{DR2} between two of the achievable on times from one cycle of operation of the driver module 220 to the next. As a result, the second emitter circuit 212 of the light source 210 may emit light having an intensity level that is approximately half-way (e.g., 50%) between a first intensity level that may be produced when the second drive signal V_{DR2} has the pulses 722a with the on time T_{ON2} in the second time slot 712a and a second intensity level that may be produced when the second drive signal V_{DR2} has the pulses 722a′ with the on time T_{ON2}′ in the second time slot 712a′. Finally, although described above as switching back and forth between two achievable on times from one cycle of operation of the driver module 220 to the next, in some examples, the control circuit 226 may be configured to switch between achievable on times using a pattern, where each of the achievable on times are not equally represented in the pattern (e.g., to provide greater degree of control of the drive signal generated by the control circuit). For example, the control circuit may control the respective on time of one of the drive signals V_{DR1}-V_{DR3} to a first value for two cycles in a row before controlling the respective on time of that one of the drive signals V_{DR1}-V_{DR3} a second value for a single cycle, and then repeating this pattern (e.g., to provide greater degree of control of the intensity level of the emitter circuit). Further, other patterns are also possible, such as repeating one on time multiple times in a row and then switching to the other on time for multiple instances.

The control circuit 226 may be configured to use the peripheral DMA controller to reconfigure the timer peripheral during each of the time slots 711a-713a′ (e.g., of the first and second cycles 701a, 702a) to allow the timer peripheral to generate the drive signals V_{DR1}-V_{DR3} using three channels of the timer peripheral. During each of the time slots 711a-713a′ (e.g., at each timer overflow event for the previous time slot), the peripheral DMA controller may be configured to reconfigure the timer peripheral for operation during a subsequent one of the time slots 711a-713a′ (e.g., the next one of the time slots 711a-713a′). While the discussion herein references the first and second cycles 701a, 702a, the control circuit 226 may be configured to use the peripheral DMA controller in a similar manner in the third and fourth cycles 703a, 704a, and subsequent cycles.

When dithering the on times T_{ON1}-T_{ON5} of one or more of drive signals V_{DR1}-V_{DR5} between two values (e.g., as shown in FIG. 7A), the control circuit 226 may continue to use the first block (e.g., the edit block) and second block (e.g., the execute block) in the memory 227b for configuring and controlling the timer peripheral to generate the drive signals V_{DR1}-V_{DR5}. However, the first and second blocks in the memory 227b may each be larger to enable dithering the on times T_{ON1}-T_{ON5} of one or more of the drive signals V_{DR1}-V_{DR5} (e.g., as compared to when the control circuit 226 is not dithering the on times T_{ON1}-T_{ON5} of the drive signals V_{DR1}-V_{DR5}). The data stored in the first and second blocks in the memory 227b may represent a pattern, which may include a number of sections. Each section of the pattern may define the operation of the driver module 220 during one cycle of operation. For example, the data stored in each section of the pattern in the memory 227b may represent the on times T_{ON1}-T_{ON5} and the slot times T_{SLOT1}-T_{SLOT5} for generating the drive signals V_{DR1}-V_{DR5} for one cycle of operation of the driver module 220. At each of the timer overflow events generated by the timer peripheral, the peripheral DMA controller may be configured to reconfigure the timer peripheral with data from memory (e.g., depending upon the channel of the timer peripheral that generated the timer overflow event). For example, at the timer overflow event for the first channel of the timer peripheral (e.g., at the end of the first time slot 711a and during the second time slot 712a), the peripheral DMA controller may be configured to retrieve data representing the on time T_{ON3} and the slot time T_{SLOT3} for the third time slot 713a, and store the data representing the on time T_{ON3} and the slot time T_{SLOT3} for the third time slot 713a in the registers of the timer peripheral.

The ability to control the respective intensity levels of the emitter circuits 211-215 of the light source 210 to very small magnitudes may be partially restricted by the minimum on time T_{ON-MIN}. For example, the control circuit 226 may not be configured to adjust the on time T_{ON1}-T_{ON5} of each of the drive signals V_{DR1}-V_{DR5} below the minimum on time T_{ON-MIN}. To control the respective intensity levels of each of the emitter circuits 211-215 of the light source 210 below a level that is achieved when the respective on time T_{ON1}-T_{ON5} is at the minimum on time T_{ON-MIN}, the control circuit 226 may be configured to “dither” (e.g., adjust) the respective on time T_{ON1}-T_{ON5} of one or more of the drive signals V_{DR1}-V_{DR5} between the minimum on time T_{ON-MIN} and an on time of zero microseconds from one cycle of operation of the driver module 220 to the next. As a result, the drive signals V_{DR1}-V_{DR5} may not repeat during each cycle of operation of the driver module 220 (e.g., as the drive signals V_{DR1}-V_{DR5} as shown in FIGS. 4A-6).

FIG. 7B is a diagram illustrating examples of the drive signals V_{DR1}-V_{DR5} generated by the control circuit 226 during multiple cycles 701b, 702b, 703b, 704b of operation of the driver module 220, for example, when the drive signals V_{DR1}-V_{DR5} do not repeat during each of the cycles 701b-704b of operation of the driver module 220. In the example of FIG. 7B, the control circuit 226 may be controlling three of the LED drive circuit 221-225 to control the light source 210. For example, the light source 210 may comprise three emitter circuits (e.g., the emitter circuits 211-213) and/or the control circuit 226 may determine to control three of the LED drive circuits (e.g., the LED drive circuits 221-2231232) based on the color-control mode in which the control circuit is presently operating and/or the emitter color of the emitters in each of the emitter circuits of the light source 210. During the first cycle 701b, the control circuit 226 may be configured to control the LED drive circuits 221-223 to generate pulses 721b-723b having respective on times T_{ON1}-T_{ON3} in respective time slots 711b-713b. The control circuit 226 may be configured to control the fourth and fifth drive signals V_{DR4}-V_{DR5} to be driven low (e.g., towards approximately circuit common). Each of the time slots 711b-713b may be characterized by a respective slot time T_{SLOT1}, T_{SLOT2}, T_{SLOT3}. The time slots 711b-713b may extend across the length of the first cycle 701b, (e.g., such that the sum of the slot times T_{SLOT1}-T_{SLOT3} may be equal to the operating period T_{OP}).

The control circuit 226 may be configured to adjust the on times T_{ON1}-T_{ON3} of the drive signals V_{DR1}-V_{DR3} during one or more of the subsequent cycles that occur after the first cycle 701a. The control circuit 226 may be configured to adjust (e.g., dither) the respective on time T_{ON1}-T_{ON3} of one or more of the drive signals V_{DR1}-V_{DR3} between the minimum on time T_{ON-MIN} and an on time of zero microseconds from one cycle to the next (e.g., from the first cycle 701b to the second cycle 702b). The second cycle 702b may include time slots 771b′-713b′, which may have the same lengths as the time slots 711b-713b of the first cycle 701b, respectively. During the second cycle 702b, the control circuit 226 may generate the respective pulses 721b′, 723b′ in the first and third time slots 711b′, 713b′ of the second cycle 702b to have the same lengths as the respective pulses 721b, 723b in the first and third time slots 711b, 713b of the first cycle 701b. However, the control circuit 226 may may adjust the on time T_{ON2} of the second drive signal V_{DR2} to zero microseconds during the second time slot 712b′ of the second cycle 702b, such that the second drive signal V_{DR2} does not have a pulse during the second time slot 712b′ of the second cycle 702b.

The control circuit 226 may be configured to repeat the operation of the driver module 220 from the first and second cycles 701b, 702b in subsequent cycles. The control circuit 226 may be configured to repeat the pulses 721b-723b of the drive signals V_{DR1}-V_{DR3} of the first cycle 701b in the third cycle 703b (e.g., such that the drive signals V_{DR1}-V_{DR3} have the same on times). The control circuit 226 may be configured to repeat the pulses 721b′-723b′ of the drive signals V_{DR1}-V_{DR3} of the second cycle 702b in the fourth cycle 704b (e.g., such that the drive signals V_{DR1}-V_{DR3} have the same on times). In this manner, the control circuit 226 may continue to adjust (e.g., dither) the on time T_{ON2} of the second drive signal V_{DR2} between the minimum on time T_{ON-MIN} and the on time of zero microseconds from one cycle of operation of the driver module 220 to the next. As a result, the second emitter circuit 212 of the light source 210 may emit light having an intensity level that is approximately half (e.g., 50%) of an intensity level that may be produced when the second drive signal V_{DR2} has the pulses 722a with the on time T_{ON2} in the second time slot 712a equal to the minimum on time T_{ON-MIN}. As such, by adjusting (e.g., dithering) the on time T_{ON2} of the second drive signal V_{DR2} between the minimum on time T_{ON-MIN} and an on time of zero microseconds from one cycle of operation of the driver module 220 to the next, the control circuit may be configured to control the intensity levels of the emitter circuits 212 of the light source 210 to a magnitude that is smaller than an intensity level that is achievable when the second drive signal V_{DR2} is controlled to the minimum on time T_{ON-MIN} during every cycle of operation of the driver module 220.

The control circuit 226 may be configured to use the peripheral DMA controller to reconfigure the timer peripheral during each of the time slots 711b-713b′ (e.g., of the first and second cycles 701b, 702b) to allow the timer peripheral to generate the drive signals V_{DR1}-V_{DR3} using three channels of the timer peripheral. During each of the time slots 711b-713b′ (e.g., at each timer overflow event for the previous time slot), the peripheral DMA controller may be configured to reconfigure the timer peripheral for operation during a subsequent one of the time slots 711b-713b′ (e.g., the next one of the time slots 711b-713b′). While the discussion herein references the first and second cycles 701b, 702b, the control circuit 226 may be configured to use the peripheral DMA controller in a similar manner in the third and fourth cycles 703b, 704b, and subsequent cycles.

When dithering the on times T_{ON1}-T_{ON5} of one or more of drive signals V_{DR1}-V_{DR5} between the minimum on time and the on time of zero microseconds (e.g., as shown in FIG. 7B), the control circuit 226 may continue to use the first block (e.g., the edit block) and second block (e.g., the execute block) in the memory 227b for configuring and controlling the timer peripheral to generate the drive signals V_{DR1}-V_{DR5}. However, the first and second blocks in the memory 227b may each be larger to enable dithering the on times T_{ON1}-T_{ON5} of one or more of drive signals V_{DR1}-V_{DR5} (e.g., as compared to when the control circuit 226 is not dithering the on times T_{ON1}-T_{ON5} of the drive signals V_{DR1}-V_{DR5}). The data stored in the first and second blocks in the memory 227b may represent a pattern, which may include a number of sections. Each section of the pattern may define the operation of the driver module 220 during one cycle of operation. For example, the data stored in each section of the pattern in the memory 227b may represent the on times T_{ON1}-T_{ON5} and the slot times T_{SLOT1}-T_{SLOT5} for generating the drive signals V_{DR1}-V_{DR5} for one cycle of operation of the driver module 220. At each of the timer overflow events generated by the timer peripheral, the peripheral DMA controller may be configured to reconfigure the timer peripheral with data from memory (e.g., depending upon the channel of the timer peripheral that generated the timer overflow event). For example, at the timer overflow event for the first channel of the timer peripheral (e.g., at the end of the first time slot 711b′ and during the second time slot 712b′), the peripheral DMA controller may be configured to retrieve data representing the on time T_{ON3} and the slot time T_{SLOT3} for the third time slot 713b, and store the data representing the on time T_{ON3} and the slot time T_{SLOT3} for the third time slot 713b in the registers of the timer peripheral.

In some examples, when the light source 210 is a linear light source and a length of the linear light source is at or near the maximum length L_{STRIP-MAX}, the driver module 220 (e.g., the LED drive circuits 221-225) may not be able to accurately control the emitters of the emitters circuits 211-215 near the end of the linear light source due to electrical characteristics of electrical wiring and/or conductors of the linear light source (e.g., parasitic impedances, such as parasitic resistances, inductances, and/or capacitances). For example, when one of the LED drive circuits 221-225 is controlling the on time T_{ON1}-T_{ON5} of the respective drive signal V_{DR1}-V_{DR5} to a small on time (e.g., such as the minimum on time T_{ON-MIN}), the electrical characteristics of the linear light source may distort and/or attenuate the respective drive signal V_{DR1}-V_{DR5} such that the voltage generated by the respective pulse is not received by the emitters of the emitters circuits 211-215 near the end of the linear light source causing the those emitters to not emit light. This may affect the intensity level and/or the color of the light emitted by the emitters of the emitter circuits 211-215 near the end of the linear light source and cause the light emitted by the emitters of the emitter circuits 211-215 near the end of the linear light source to differ from the intensity level and/or the color of the light emitted by the emitters of the emitter circuits 211-215 that are located closer to the driver module 220.

In some examples, the driver module 220 (e.g., the LED drive circuits 221-225) may be characterized by a limited minimum on time T_{ON-MIN-L} (e.g., a linear-light-source minimum on time) to which the control circuit 226 may adjust the on times T_{ON1}-T_{ON5} of the respective drive signal V_{DR1}-V_{DR5}, where the limited minimum on time T_{ON-MIN} is sized to ensure that the emitters of the emitters circuits 211-215 near the end of the linear light source receive voltage generated by all pulses of the respective drive signal V_{DR1}-V_{DR5}. The limited minimum on time T_{ON-MIN} may be sized to ensure that the emitters of emitters circuits near an end of the linear light source receive all pulses of the respective drive signal V_{DR1}-V_{DR5}. The limited minimum on time T_{ON-MIN} may be, for example, greater than the minimum on time T_{ON-MIN} (e.g., the limited minimum on time T_{ON-MIN} may be approximately 2.6 microseconds). In some examples, the limited minimum on time T_{ON-MIN-L} may be referred to as a restricted minimum on time T_{ON-MIN-R} since, for example, the control circuit may restrict the on time T_{ON1}-T_{ON5} of the respective drive signal V_{DR1}-V_{DR5} that are allocated to the sections in the pattern to be no less than the limited minimum on time T_{ON-MIN-L}. When the on time T_{ON1}-T_{ON5} of the one of the drive signals V_{DR1}-V_{DR5} is not at least as long as the limited minimum on time T_{ON-MIN-L} for sections of a pattern (e.g., all sections of the pattern), the control circuit 226 may be configured to redistribute the on time T_{ON1}-T_{ON5} of the respective drive signal V_{DR1}-V_{DR5} across the sections of the pattern, such that the on time T_{ON1}-T_{ON5} of the respective drive signal V_{DR1}-V_{DR5} is equal to the limited minimum on time T_{ON-MIN-L} or zero seconds in the different sections of the pattern. For example, the control circuit 226 may be configured to redistribute the on time T_{ON1}-T_{ON5} of the respective drive signal V_{DR1}-V_{DR5} across the sections of the pattern, such that the on time T_{ON1}-T_{ON5} of the respective drive signal V_{DR1}-V_{DR5} is not below the limited minimum on time T_{ON-MIN-L} (e.g., unless the on time is zero seconds) so that the emitters of the emitters circuits 211-215 near the end of the linear light source receive voltage generated by all of the pulses of the respective drive signal V_{DR1}-V_{DR5} that are being generated. Further, in some examples, such as when the redistribution of the on time results in a remainder, the control circuit may may be configured to minimize a number of sections of the pattern where the on times T_{ON1}-T_{ON5} of the respective drive signals V_{DR1}-V_{DR5} is less than the limited minimum on time T_{ON-MIN-L} (e.g., to one section of the pattern).

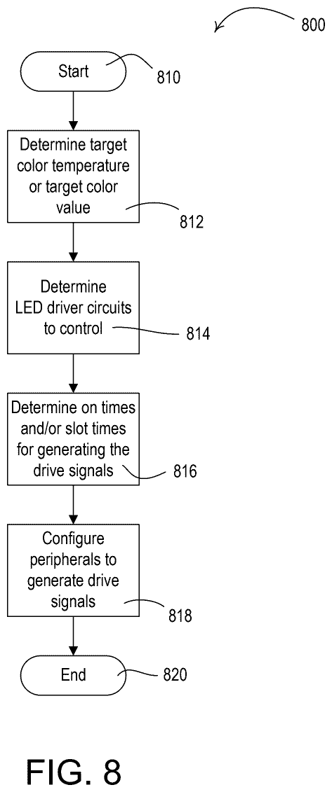

FIG. 8 is a flowchart of an example procedure 800 for controlling a light source at a load control device (e.g., one of the load control devices of FIG. 1, such as the dimmer switch 110, the LED driver 120, and/or the controllable light source 130, and/or the driver module 220 of FIG. 2). The control procedure 800 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to generate drive signals V_{DR1}-V_{DR5} for controlling the respective LED drive circuits. For example, the control circuit may execute the control procedure 800 at 810 periodically and/or in response to receiving the message comprising a color-temperature-adjustment command a full-color-adjustment command, or an intensity adjustment command.

At 812, the control circuit may determine a target color temperature T_{TRGT}(e.g., when operating in a color-temperature-control mode) or a target color value (e.g., when operating in a full-color-control mode). For example, the target color value may be defined by a target x-chromaticity coordinate X_{TRGT} and a target y-chromaticity coordinate Y_{TRGT}. The control circuit may determine the target color temperature T_{TRGT} in response to receiving a color-temperature-adjustment command or the target color value in response to receiving a full-color-adjustment command.

At 814, the control circuit may determine which of the LED drive circuits to control based on the color-control mode in which the control circuit is presently operating and/or a light source type for the light source, which may be stored in memory. The control circuit may be configured to determine which of the LED drive circuits to control based on the number of the number of emitter circuits in the light source. For example, the control circuit may be configured to determine the number of emitter circuits in the light source based on the light source type for the light source. In addition, the control circuit may be configured to determine which of the LED drive circuits to control based on the color-control mode in which the control circuit is presently operating and/or the emitter color of the emitters in each of the emitter circuits of the light source. For example, the control circuit may be configured to determine the emitter color of each of the emitter circuits of the light source based on a light source type for the light source.

At 816, the control circuit may determine respective on times T_{ON1}-T_{ON5} and/or respective slot times T_{SLOT1}-T_{SLOT5} for generating the drive signals V_{DR1}-V_{DR5}. The control circuit may be configured to determine duty cycles d₁-d₅ that may be used to calculate the respective on times T_{ON1}-T_{ON5} and/or respective slot times T_{SLOT1}-T_{SLOT5} used for generating the drive signals V_{DR1}-V_{DR5}. For example, the control circuit may be configured to determine the duty cycles d₁-d₅ for the respective drive signals V_{DR1}-V_{DR5} based on which of the five LED drive circuits that the control circuit has determined to control (e.g., based on the color-control mode in which the control circuit is presently operating and/or the light source type as described above). In addition, the control circuit may be configured to determine the duty cycles d₁-d₅ for the respective drive signals V_{DR1}-V_{DR5} based on the target color temperature T_{TRGT} (e.g., when operating in the color-temperature-control mode) or the target x-chromaticity coordinate X_{TRGT} and the target y-chromaticity coordinate Y_{TRGT} (e.g., when operating in the full-color-control mode), and for example, the target intensity level.

At 818, the control circuit may configure one or more peripherals of the control circuit to generate the drive signals based on the duty cycles d₁-d₅ (e.g., as determined at 816), before the procedure 800 ends at 820. For example, the control circuit may configure a timer peripheral for allowing the timer peripheral to generate the drive signals V_{DR1}-V_{DR5} (e.g., when the light source comprises two emitter circuits as shown in FIG. 3). In some examples, the control circuit may configure a peripheral DMA controller for configuring the timer peripheral to generate the drive signals V_{DR1}-V_{DR5} (e.g., as shown in FIG. 4A-5 and 7B). For example, the control circuit may be configured to store data in a block (e.g., an edit block) in memory (e.g., the memory 227b) to enable the peripheral DMA controller to configure the timer peripheral to generate the drive signals V_{DR1}-V_{DR5}. The control circuit may be configured to store the respective on times T_{ON1}-T_{ON5} and/or the respective slot times T_{SLOT1}-T_{SLOT5} for generating the drive signals V_{DR1}-V_{DR5} in the edit block in memory. When the control circuit is finished storing the on times T_{ON1}-T_{ON5} and/or the slot times T_{SLOT1}-T_{SLOT5} in the first block in memory, the control circuit may be configured to point the peripheral DMA controller to the block in memory, such that the peripheral DMA controller may retrieve the on times T_{ON1}-T_{ON5} and/or the slot times T_{SLOT1}-T_{SLOT5} from the block (e.g., the block may now be an execute block) and configure the timer peripheral to generate the drive signals V_{DR1}-V_{DR5}.

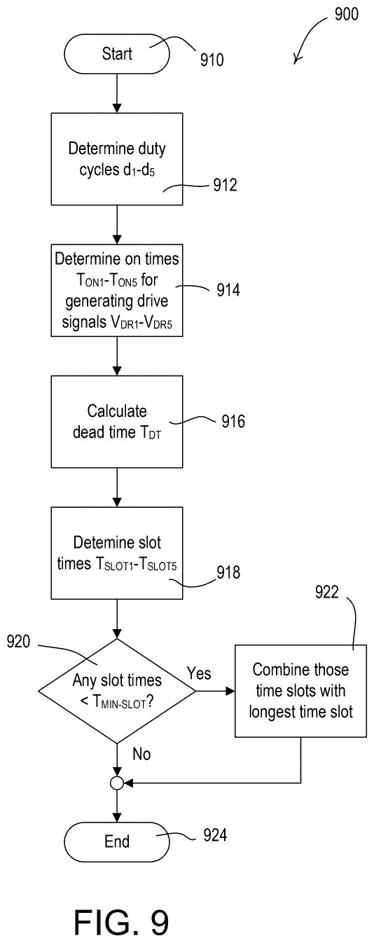

FIG. 9 is a flowchart of an example procedure 900 for controlling a light source at a load control device (e.g., one of the load control devices of FIG. 1, such as the dimmer switch 110, the LED driver 120, and/or the controllable light source 130, and/or the driver module 220 of FIG. 2). The control procedure 900 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to generate drive signals V_{DR1}-V_{DR5} for controlling the respective LED drive circuits. The control circuit may be configured to generate the drive signals V_{DR1}-V_{DR5} to control a color of the cumulative light emitted by the light source towards a target color temperature T_{TRGT} (e.g., when operating in a color-temperature-control mode) or a target color value (e.g., when operating in a full-color-control mode). The control circuit may be configured to execute the procedure 900 to determine respective on times T_{ON1}-T_{ON5} and/or respective slot times T_{SLOT1}-T_{SLOT5} for generating the drive signals V_{DR1}-V_{DR5}. For example, the control circuit may execute the procedure 900 at 910 periodically and/or in response to receiving the message or user command comprising a color-temperature-adjustment command, a full-color-adjustment command, or an intensity adjustment command. The control circuit may be configured to execute the procedure 900, for example, at 816 of the procedure 800 shown in FIG. 8.

At 912, the control circuit may determine duty cycles d₁-d₅ for generating the respective drive signals V_{DR1}-V_{DR5}. The control circuit the control circuit may determine duty cycles d₁-d₅ at 912 based on which of the five LED drive circuits, for example, that the control circuit has determined to control (e.g., at 814 of the procedure 800 shown in FIG. 8). In addition, the control circuit may be configured to determine the duty cycles d₁-d₅ at 912 based on either a target color temperature T_{TRGT} (e.g., when operating in the color-temperature-control mode) or a target x-chromaticity coordinate X_{TRGT} and the target y-chromaticity coordinate Y_{TRGT} (e.g., when operating in the full-color-control mode). The determined duty cycles d₁-d₅ for the respective drive signals V_{DR1}-V_{DR5} may define ratios between individual intensity level L_{IND1}-L_{IND5} of the respective emitter circuits to cause the cumulative light to be controlled towards the target color temperature T_{TRGT} (e.g., when operating in the color-temperature-control mode) or the target color value as defined by the target x-chromaticity coordinate X_{TRGT} and the target y-chromaticity coordinate Y_{TRGT} (e.g., when operating in the full-color-control mode). When the control circuit has determined to control less than the five LED drive circuits, the control circuit may be configured to set the duty cycles d₁-d₅ for the respective drive signals V_{DR1}-V_{DR5} for those of the LED drive circuits that are not being controlled to 0%. When the target intensity level L_{TRGT} of the cumulative light emitted by the light source is at the high-end intensity level L_{HE} (e.g., approximately 100%), the control circuit may set the duty cycles d₁-d₅ such that the sum of the duty cycles d₁-d₅ may be approximately 100%. When the target intensity level L_{TRGT} of the cumulative light emitted by the light source is less than the high-end intensity level L_{HE}, the control circuit may be configured to scale the duty cycles (e.g., the duty cycles d₁-d₅ when the target intensity level L_{TRGT} is at the high-end intensity level L_{HE}) by the target intensity level L_{TRGT}, such that the ratios between the individual intensity level L_{IND1}-L_{IND5} of the respective emitter circuits of the light source are maintained constant.

At 914, the control circuit may determine on times T_{ON1}-T_{ON5} for generating the respective drive signals V_{DR1}-V_{DR5}. For example, the control circuit may determine the on times T_{ON1}-T_{ON5} by multiplying the operating period TOP by the respective duty cycles d₁-d₅, e.g.,

$${T}_{ON 1} = {d}_{1} \cdot {T}_{OP} ;$$

$${T}_{ON 2} = {d}_{2} \cdot {T}_{OP} ;$$

$${T}_{ON 3} = {d}_{3} \cdot {T}_{OP} ;$$

$${T}_{ON 4} = {d}_{4} \cdot {T}_{OP} ; and$$

$${T}_{ON 5} = {d}_{5} \cdot {T}_{OP} .$$

At 916, the control circuit may determine the dead time T_{DT} (e.g., when the target intensity level L_{TRGT} of the cumulative light emitted by the light source is less than the high-end intensity level L_{HE}). For example, the control circuit may be configured to calculate the dead time TDT by subtracting the sum of the on times T_{ON1}-T_{ON5} from the operating period T_{OP}, e.g.,

$${T}_{DT} = {T}_{OP} - ( {T}_{ON 1} + {T}_{ON 2} + {T}_{ON 3} + {T}_{ON 4} + {T}_{ON 5} ) .$$

When the target intensity level L_{TRGT} of the cumulative light emitted by the light source is at the high-end intensity level L_{HE}, the control circuit may be configured to set the dead time T_{DT} to zero microseconds at 916.

At 918, the control circuit may be configured to determine slot times T_{SLOT1}-T_{SLOT5} for defining time slots in which to generate pulses at the respective on times T_{ON1}-T_{ON5} of the drive signals V_{DR1}-V_{DR5}. When the target intensity level L_{TRGT} of the cumulative light emitted by the light source is at the high-end intensity level L_{HE}, the control circuit may be configured to set the slot times T_{SLOT1}-T_{SLOT5} equal to the respective on times T_{ON1}-T_{ON5} of the drive signals V_{DR1}-V_{DR5}. When the target intensity level L_{TRGT} of the cumulative light emitted by the light source is less than the high-end intensity level L_{HE}, the control circuit may be configured to add at least a portion of the dead time T_{DT} to one or more of the time slots. For the time slots with those of the on times T_{ON1}-T_{ON5} that are less than a minimum slot time T_{SLOT-MIN} (e.g., approximately 4 microseconds), the control circuit may be configured to add a portion of the dead time T_{DT} to the slot times T_{SLOT1}-T_{SLOT5} of those time slots. For example, if the third on time T_{ON3} of the third time slot is the only on time that is less than the minimum slot time T_{SLOT-MIN}, the control circuit may be configured to add the dead time T_{DT} (e.g., all of the dead time) to the third slot time T_{SLOT3} of the third time slot, e.g.,

$${T}_{SLOT 3} = {T}_{SLOT 3} + {T}_{DT} ,$$

(e.g., as shown by the example of FIG. 4B). In addition, if the third and fourth on times T_{ON3}, T_{ON4} are both less than the minimum slot time T_{SLOT-MIN} (e.g., both equal to 2 microseconds) and the dead time T_{DT} is 5 microseconds, the control circuit may be configured to add 2.5 microseconds (e.g., or in other words sufficient of the dead time) to each of the third and fourth slot time T_{SLOT3}, T_{SLOT4} such that the third and fourth slot time T_{SLOT3}, T_{SLOT4} are then each equal to or greater than the minimum slot time T_{SLOT-MIN}. If there is still a remaining portion of the dead time T_{DT}, the control circuit may be configured to add the remaining portion of the dead time T_{DT} to one or more of the slot times T_{SLOT1}-T_{SLOT5} (e.g., to the smallest one of the slot times T_{SLOT1}-T_{SLOT5} and/or divided between the smallest ones of the slot times T_{SLOT1}-T_{SLOT5}). In some examples, if there is still a remaining portion of the dead time T_{DT}, the control circuit may be configured to add the remaining portion of the dead time T_{DT} to the smallest one of the slot times T_{SLOT1}-T_{SLOT5} first.

At 920, the control circuit may determine if any of the slot times T_{SLOT1}-T_{SLOT5} are still less than the minimum slot time T_{SLOT-MIN} (e.g., after the dead time T_{DT} was added to one or more of the slot times T_{SLOT1}-T_{SLOT5} at 918). For example, if the third and fourth on times T_{ON3}, T_{ON4} are both less than the minimum slot time T_{SLOT-MIN} (e.g., both equal to 2 microseconds) and the dead time T_{DT} is 3 microseconds, the control circuit may be configured to add 2 microseconds to each of the third slot time T_{SLOT3} and 1 microsecond to the fourth time slot T_{SLOT4} at 918, such that the third slot time T_{SLOT3} is equal to the minimum slot time T_{SLOT-MIN}, and with the fourth slot time T_{SLOT4} still less than the minimum slot time T_{SLOT-MIN} (e.g., equal to 3 microseconds). If the control circuit determines that none of the slot times T_{SLOT1}-T_{SLOT5} are less than the minimum slot time T_{SLOT-MIN} at 920, the procedure 900 may end at 924 with the slot times T_{SLOT1}-T_{SLOT5} as set at 918.

However, when the control circuit determines that any of the slot times T_{SLOT1}-T_{SLOT5} are less than the minimum slot time T_{SLOT-MIN} at 920, the control circuit may combine those time slots with the time slot having the longest one of the slot times T_{SLOT1}-T_{SLOT5} at 922, before the procedure 900 exits at 946. For example, when the fourth slot time T_{SLOT4} is less than the minimum slot time T_{SLOT-MIN} and the second slot time T_{SLOT2} of the second time slot is the longest of the slot times T_{SLOT1}-T_{SLOT5}, the control circuit may be configured to cause the pulse with the on time T_{ON4} of the fourth drive signal V_{DR4} to be generated during the pulse with the on time T_{ON2} of the second drive signal V_{DR2} (e.g., as shown by the example of FIG. 4C). The control circuit may be configured to set the slot time T_{SLOT4} of the fourth time slot equal to 0 seconds. The control circuit may be configured to add any portion of the dead time T_{DT} that was previously added to the fourth time slot (e.g., at 918) to one of or more of the other slot times T_{SLOT1}, T_{SLOT2}, T_{SLOT3}, T_{SLOT5}. Other variations and examples are possible.

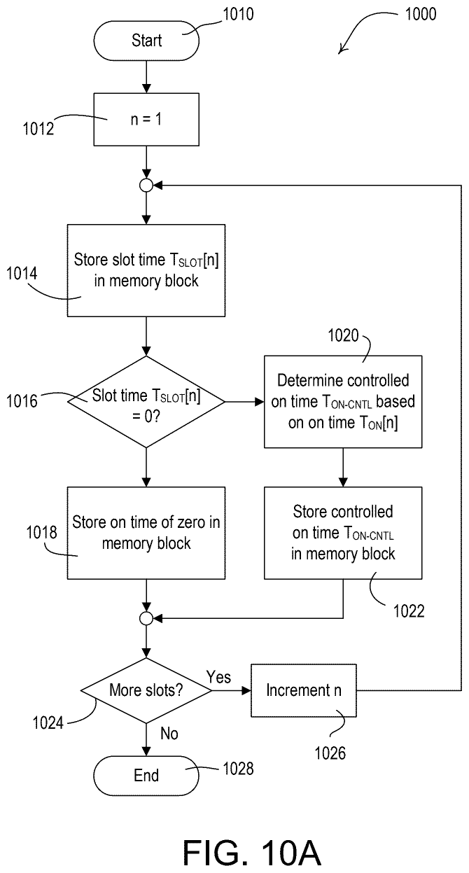

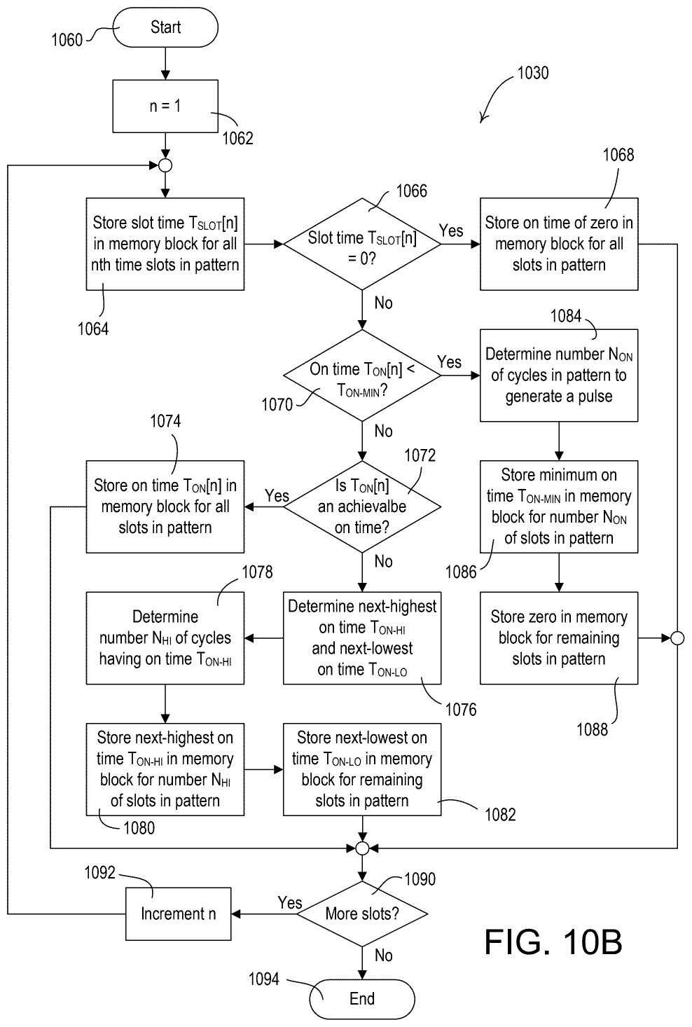

FIG. 10A is a flowchart of an example procedure 1000 for controlling a light source at a load control device (e.g., one of the load control devices of FIG. 1, such as the dimmer switch 110, the LED driver 120, and/or the controllable light source 130, and/or the driver module 220 of FIG. 2). The control procedure 1000 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to generate drive signals V_{DR1}-V_{DR5} for controlling the respective LED drive circuits. The control circuit may be configured to generate the drive signals V_{DR1}-V_{DR5} to control a color of the cumulative light emitted by the light source towards a target color temperature T_{TRGT} (e.g., when operating in a color-temperature-control mode) or a target color value (e.g., when operating in a full-color-control mode). For example, the control circuit may execute the procedure 1000 at 1010 periodically and/or in response to receiving the message comprising a color-temperature-adjustment command, a full-color-adjustment command, or an intensity adjustment command. The control circuit may be configured to execute the procedure 1000, for example, at 818 of the procedure 800 shown in FIG. 8.

The control circuit may be configured to execute the procedure 1000 to configure one or more peripherals of the control circuit to generate the drive signals V_{DR1}-V_{DR5} based on the duty cycles d₁-d₅. In addition, the control circuit may be configured to execute the procedure 1000 to store respective on times T_{ON1}-T_{ON5} and/or respective slot times T_{SLOT1}-T_{SLOT5} for generating the drive signals V_{DR1}-V_{DR5} (e.g., as determined at 816 of the procedure 800) in memory (e.g., the memory 277b).

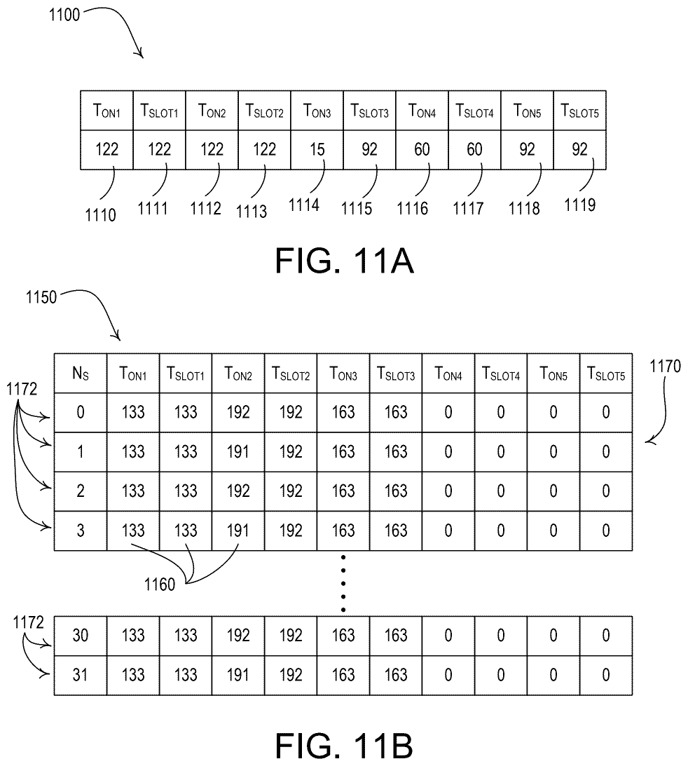

FIG. 11A is an example diagram illustrating a block 1100 in the memory in which the on times T_{ON1}-T_{ON5} and the slot times T_{SLOT1}-T_{SLOT5} may be stored. The block 1100 in the memory may be an example of an edit block (e.g., the first block in the memory 227b) in which the control circuit may store to the on times T_{ON1}-T_{ON5} and/or the slot times T_{SLOT1}-T_{SLOT5}. Alternatively or additionally, the block 1100 in the memory may be an example of an execute block (e.g., the second block in the memory 227b) from which the control circuit (e.g., the peripheral DMA controller) may retrieve the on times T_{ON1}-T_{ON5} and/or the slot times T_{SLOT1}-T_{SLOT5} and/or an execute block for generating the respective drive signals V_{DR1}-V_{DR5}. The block 1100 in the memory may comprise a plurality of memory locations 1110-1119. The control circuit may be configured to store the on times T_{ON1}-T_{ON5} in respective memory locations 1110, 1112, 1114, 1116, 1118 and the slot times T_{SLOT1}-T_{SLOT5} in respective memory locations 1111, 1113, 1115, 1117, 1119.

During the procedure 1000, the control circuit may use a variable n to keep track of the time slot that the control circuit is presently configuring. At 1012, the control circuit may initialize a variable n to one. At 1014, the control circuit may store a slot time T_{SLOT}[n] for the present time slot (e.g., as indicated by the variable n) in one of the memory locations of the block of memory (e.g., the edit block). For example, the first time that 1014 is executed during the procedure 1000, the control circuit may store the first slot time T_{SLOT1} in the memory location 1111 of the block 1100 of memory.

At 1016, the control circuit may determine whether the slot time T_{SLOT}[n] for the present time slot is equal to zero. If so, the control circuit may store an on time of zero seconds in one of the memory locations of the block of memory at 1018. For example, when the slot time T_{SLOT}[n] for the present time slot is equal to zero seconds during the first time that 1016 is executed during the procedure 1000, the control circuit may store the first on time T_{ON1} as an on time of zero seconds in the memory location 1111 of the block 1100 of memory at 1018.

When the slot time T_{SLOT}[n] for the present time slot is not equal to zero seconds at 1016, the control circuit may determine a controlled on time T_{ON-CNTL} for generating the respective drive signals V_{DR1}-V_{DR5} based on an on time T_{ON}[n] for the present time slot (e.g., as indicated by the variable n) at 1020. For example, the control circuit may determine the controlled on time T_{ON-CNTL} for the present time slot by rounding the on time T_{ON}[n] for the present time slot to the closest multiple of the adjustment amount Δ_{T-ON}, e.g.,

$${T}_{ON - CNTL} = ROUND ( {T}_{ON} [ n ] ) = α \cdot {Δ}_{T - ON} ,$$

where α is an integer value corresponding to the closest achievable on time. For example, when the slot time T_{SLOT}[n] for the present time slot is not equal to zero seconds during the first time that 1020 is executed during the procedure 1000, the control circuit may determine the controlled on time T_{ON-CNTL} by rounding the first on time T_{ON1} to the closest achievable on time. At 1022, the control circuit may load the controlled-on time T_{ON-CNTL} in one of the memory locations of the block of memory (e.g., the edit block).

At 1024, the control circuit may determine if there are more slots to configure. If there are more slots to configure, the control circuit may increment the variable n at 1026 and store the slot time T_{SLOT}[n] for the next time slot at 1014. The control circuit may continue to store slot times in the memory block (e.g., in the respective memory locations 1112, 1114, 1116, 1118) at 1014 and store on times in the memory block (e.g., in the respective memory locations 1113, 1115, 1117, 1119) until there are no more slots to configure. When there are no more slots to configure at 1024, the procedure 1000 may end at 1028.

In some examples, the control circuit may be configured to adjust the on times T_{ON1}-T_{ON5} of the respective drive signals V_{DR1}-V_{DR5} to values between the achievable on times (e.g., the multiples of the adjustment amount Δ_{T-ON}). FIG. 10B is a flowchart of another example procedure 1050 for controlling a light source at a load control device (e.g., one of the load control devices of FIG. 1, such as the dimmer switch 110, the LED driver 120, and/or the controllable light source 130, and/or the driver module 220 of FIG. 2), where at least one of the on times T_{ON1}-T_{ON5} of the respective drive signals V_{DR1}-V_{DR5} may be adjusted to a value between two of the achievable on times. The control procedure 1050 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to generate drive signals V_{DR1}-V_{DR5} for controlling the respective LED drive circuits. The control circuit may be configured to generate the drive signals V_{DR1}-V_{DR5} to control a color of the cumulative light emitted by the light source towards a target color temperature T_{TRGT} (e.g., when operating in a color-temperature-control mode) or a target color value (e.g., when operating in a full-color-control mode). For example, the control circuit may execute the procedure 1050 at 1060 periodically and/or in response to receiving the message comprising a color-temperature-adjustment command or a full-color-adjustment command. The control circuit may be configured to execute the procedure 1050, for example, at 818 of the procedure 800 shown in FIG. 8.

The control circuit may be configured to execute the procedure 1050 to configure one or more peripherals of the control circuit to generate the drive signals V_{DR1}-V_{DR5} based on the duty cycles d₁-d₅. In addition, the control circuit may be configured to execute the procedure 1050 to store a pattern defining respective on times T_{ON1}-T_{ON5} and respective slot times T_{SLOT1}-T_{SLOT5} for generating the drive signals V_{DR1}-V_{DR5} (e.g., as determined at 816 of the procedure 800) in memory (e.g., the memory 277b). For example, the pattern may comprise a plurality of sections (e.g., steps) that occur during a number of consecutive cycles of operation of the load control device. Each of the sections of the pattern may define respective on times T_{ON1}-T_{ON5} and/or respective slot times T_{SLOT1}-T_{SLOT5} for one of the cycles of operation of the load control device. For example, the sections of the pattern that are associated with a particular on time T_{ON1}-T_{ON5} and respective slot times T_{SLOT1}-T_{SLOT5} (e.g., and associated with a particular drive signal and emitter circuit) may define different, discrete values (e.g., two different achievable on times) for the on time across different sections of the pattern (e.g., or cycles of operation of the load control device). As such, the control circuit may be configured to adjust (e.g., dither) the on time between two discrete values (e.g., achievable on times) that are spaced apart by the adjustment amount AT-ox by storing a pattern that comprises a plurality of sections (e.g., steps) that occur during consecutive cycles of operation of the load control device.

FIG. 11B is an example diagram illustrating a block 1150 in the memory in which a pattern 1170 may be stored. The block 1150 in the memory may be an example of an edit block (e.g., the first block in the memory 227b) in which the control circuit may store to the on times T_{ON1}-T_{ON5} and/or the slot times T_{SLOT1}-T_{SLOT5}. Alternatively or additionally, the block 1150 may be an example of an execute block (e.g., the second block in the memory 227b) from which the control circuit (e.g., the peripheral DMA controller) may retrieve the on times T_{ON1}-T_{ON5} and/or the slot times T_{SLOT1}-T_{SLOT5} and/or an execute block for generating the respective drive signals V_{DR1}-V_{DR5}. The pattern 1170 stored in the block 1150 may comprise a plurality of sections 1172. Each of the sections 1172 of the pattern 1170 may have a respective section number N_{S}. Each of the sections 1172 of the pattern 1170 may be stored in a plurality of memory locations 1160 of the block 1150. The data for each section 1172 of the pattern 1170 may define the on times T_{ON1}-T_{ON5} and the slot times T_{SLOT1}-T_{SLOT5} for the respective section (e.g., one cycle of operation of the driver module). For example, the pattern 1170 stored in the block 1150 may comprise a number N_{SECT} of the sections 1172 (e.g., cycles). The number N_{SECT} may be, for example, 32, such that the pattern 1170 has 32 sections 1172. The block 1150 may be larger than the block 1100, for example, to enable the storage of the pattern 1170 that comprises the plurality of section 1172, which for example, may enable the dithering the on times T_{ON1}-T_{ON5} of one or more of drive signals V_{DR1}-V_{DR5} (e.g., as compared to when the control circuit 226 is not dithering the on times T_{ON1}-T_{ON5} of the drive signals V_{DR1}-V_{DR5}). In some examples, the sections 1172 may be called frames and the pattern 1170 may be called a super-frame.

During the procedure 1050, the control circuit may use a variable n to keep track of the time slot that the control circuit is presently configuring. At 1062, the control circuit may initialize a variable n to one. At 1064, the control circuit may store a slot time T_{SLOT}[n] for the appropriate memory location for the nth time slot in each of the sections in the pattern in the block of memory (e.g., the edit block). For example, the first time that 1064 is executed during the procedure 1050, the control circuit may store the first slot time T_{SLOT1} in the memory locations 1160 for the first time slot in each of the sections 1172 of the pattern 1170 in the block 1150 of memory.

At 1066, the control circuit may determine whether the slot time T_{SLOT}[n] for the nth time slot is equal to zero. If so, the control circuit may store an on time of zero seconds in the appropriate memory location of each of the sections in the pattern in the block of memory at 1068. For example, when the slot time T_{SLOT}[n] for the nth time slot is equal to zero seconds during the first time that 1066 is executed during the procedure 1050, the control circuit may store the first on time T_{ON1} as an on time of zero seconds in the memory location 1160 for the first time slot in each of the sections 1172 of the pattern 1170 in the block 1150 of memory at 1068.

When the slot time T_{SLOT}[n] for the nth time slot is not equal to zero at 1066, the control circuit may determine whether the on time T_{ON}[n] for the nth time slot is less than the minimum on time T_{ON-MIN} at 1070. When the on time T_{ON}[n] for the nth time slot is not less than (e.g., is greater than or equal to) the minimum on time T_{ON-MIN} at 1070, the control circuit may determine whether the on time T_{ON}[n] for the nth time slot is an achievable on time (e.g., is a multiple of the adjustment amount Δ_{T-ON}) at 1072. If so, the control circuit may store the on time T_{ON}[n] in the memory locations 1160 for the nth time slot in each of the sections of the pattern in the block of memory at 1074.

When the on time T_{ON}[n] (e.g., the desired on time) for the nth time slot is not an achievable on time (e.g., is not a multiple of the adjustment amount Δ_{T-ON}) at 1072, the control circuit may configure a pattern in the block of memory for causing the control circuit to dither the on times for the nth time slot of the pulses between two values. At 1076, the control circuit may determine a next-highest achievable on time T_{ON-HI} and a next-lowest achievable on time T_{ON-LO}. For example, when the adjustment amount Δ_{T-ON} is one microsecond and the on time T_{ON}[n] is 192.5 microseconds, the control circuit may be configured to determine the next-highest achievable on time T_{ON-HI} as 193 microseconds and the next-lowest achievable on time T_{ON-LO} at 192 at 1076. At 1078, the control circuit may determine a number N_{HI} of the sections of the pattern during which the control circuit may adjust the on time T_{ON}[n] for the nth time slot to the next-highest achievable on time T_{ON-HI}. For example, the control circuit may calculate the number N_{HI} at 1078 as a function of the on time T_{ON}[n] for the nth time slot, the next-lowest achievable on time T_{ON-LO}, the adjustment amount Δ_{T-ON}, and the number N_{SECT} of the sections in the pattern, e.g.,

$${N}_{HI} = [ ( {T}_{ON} [ n ] - {T}_{ON - LO} ) / {Δ}_{T - ON} ] \cdot {N}_{SECT} .$$

At 1080, the control circuit may store the next-highest achievable on time T_{ON-HI} in the appropriate memory location for the nth time slot in each of the number N_{HI} of the sections in the pattern in the block of memory. The control circuit may be configured to equally space apart the number N_{HI} of the sections in the pattern (e.g., that include the next-highest achievable on time T_{ON-HI}) in the block of memory. For example, the control circuit may store the next-highest achievable on time T_{ON-HI} in the appropriate memory location for the nth time slot in the sections in the pattern in the block of memory in a particular order. For example, for the pattern 1170 having 32 sections 1172 as shown in FIG. 11B, the control circuit may be configured to store the next-highest achievable on time T_{ON-HI} in the appropriate memory location 1060 for the nth time slot in the sections 1172 in the pattern 1170 in the following order of sections (e.g., as referred to by the respective section number N_{S}): 0, 16, 8, 24, 4, 12, 20, 28, 2, 6, 10, 14, 18, 22, 26, 30, 1, 3, 4, 7, 9, 11, 13, 15, 17, 19, 21, 23, 25, 27, 29, 31. This ordering may ensure that the next-highest achievable on time T_{ON-HI} is equally distributed (e.g., symmetrically spaced) throughout the pattern in the block of memory.

At 1082, the control circuit may store the next-lowest achievable on time T_{ON-LO} in the appropriate memory location for the nth time slot in each of the remaining sections in the pattern in the block of memory (e.g., those that are not populated with the next-highest achievable on time T_{ON-HI}). For example, the control circuit may store the next-lowest achievable on time T_{ON-LO} in a number N_{LO} of the sections in the pattern (e.g., where N_{LO}=N_{SECT}−N_{HI}). As a result of controlling the on time T_{ON}[n] for the nth time slot to the next-highest achievable on time T_{ON-HI} for the number NHI of the sections in the pattern and to the next-lowest achievable on time T_{ON-LO} for the number N_{LO} of the sections in the pattern, the average of the on times for the nth time slot across the length of the pattern (e.g., across the number N_{SECT} of the sections of the pattern) may be approximately equal to the on time T_{ON}[n] (e.g., the desired on time).

As described herein, the control circuit may store the next-highest achievable on time T_{ON-HI} and the next-lowest achievable on time T_{ON-LO} in alternating sections in a block in the memory (e.g., as shown by the sections 1160 of the block 1150 that are associated with the on time T_{ON2} in FIG. 11B). Alternatively, the control circuit may store the next-highest achievable on time T_{ON-HI} and the next-lowest achievable on time T_{ON-LO} using a pattern where, for example, each of the achievable on times do not need to be equally represented in the pattern (e.g., to provide greater degree of control of the drive signal generated by the control circuit). For instance, if the pattern has 32 sections, the control circuit may be configured to store the next-highest achievable on time T_{ON-HI} in the first 16 sections and the next-lowest achievable on time T_{ON-LO} in the following 16 sections, and the pattern may then repeat. As noted, the number of sections that store the next-highest achievable on time T_{ON-HI} do not need to be equal to the number of sections that store the next-lowest achievable on time T_{ON-LO} (e.g., which provides greater control of the desired on time).

When the on time T_{ON}[n] for the nth time slot is less than the minimum on time T_{ON-MIN} at 1070, the control circuit may configure a pattern in the block of memory for causing the control circuit to dither the on times for the nth time slot of the pulses between the minimum on time T_{ON-MIN} and zero microseconds. In other words, the control circuit may either generate the pulse of the drive signal at the minimum on time T_{ON-MIN} or not generate the pulse of the drive signal in the nth time slot. At 1084, the control circuit may determine a number N_{ON} of the sections 1172 of the pattern 1170 during which the control circuit may generate the pulse at the minimum on time T_{ON-MIN} in the nth time slot. For example, the control circuit may calculate the number N_{ON} at 1084 as a function of the on time T_{ON}[n] for the nth time slot, the minimum on time T_{ON-MIN}, and the number N_{SECT} of the sections 1160 in the pattern, e.g.,

$${N}_{ON} = ( {T}_{ON} [ n ] / {T}_{ON - MIN} ) \cdot {N}_{SECT} .$$

At 1086, the control circuit may store the minimum on time T_{ON-MIN} in the appropriate memory location for the nth time slot in each of the number N_{ON} of the sections in the pattern in the block of memory. At 1088, the control circuit may store an on time of zero microseconds in the appropriate memory location for the nth time slot in each of the remaining sections in the pattern in the block of memory (e.g., those that are not populated with the minimum on time T_{ON-MIN}). For example, the control circuit may store the on time of zero microseconds in a number N_{OFF} of the sections in the pattern (e.g., where N_{OFF}=N_{SECT}−N_{ON}). As a result of controlling the on time T_{ON}[n] for the nth time slot to the minimum on time T_{ON-MIN} for the number N_{ON} of the sections in the pattern and to the on time of zero microseconds for the number N_{OFF} of the sections in the pattern, the average of the on times for the nth time slot across the length of the pattern (e.g., across the number N_{SECT} of the sections of the pattern) may be approximately equal to the on time T_{ON}[n] (e.g., the desired on time).

At 1090, the control circuit may determine if there are more slots to configure. If there are more slots to configure at 1090, the control circuit may increment the variable n at 1092 and store the slot time T_{SLOT}[n] for the next time slot at 1064. The control circuit may continue to store slot times and on times in the memory block until there are no more slots to configure. When there are no more slots to configure at 1090, the procedure 1050 may end at 1094.

When the light source is a linear light source, the control circuit may be configured to set the on times T_{ON1}-T_{ON5} of the respective drive signal V_{DR1}-V_{DR5} such each of the on times T_{ON1}-T_{ON5} is at least as long as a limited minimum on time T_{ON-MIN-L} (e.g., a linear-light-source minimum on time) during each of the sections of the pattern. The limited minimum on time T_{ON-MIN} may be sized to ensure that the emitters of emitters circuits near an end of the linear light source receive all pulses of the respective drive signal V_{DR1}-V_{DR5}. The limited minimum on time T_{ON-MIN} may be, for example, greater than the minimum on time T_{ON-MIN} (e.g., the limited minimum on time T_{ON-MIN} may be approximately 2.6 microseconds). In some examples, the limited minimum on time T_{ON-MIN-L} may be referred to as a restricted minimum on time T_{ON-MIN-R} since, for example, the control circuit may restrict the on time T_{ON1}-T_{ON5} of the respective drive signal V_{DR1}-V_{DR5} that are allocated to the sections in the pattern to be no less than the limited minimum on time T_{ON-MIN-L}. When the on time T_{ON1}-T_{ON5} of the one of the drive signals V_{DR1}-V_{DR5} is not at least as long as the limited minimum on time T_{ON-MIN-L} for sections of a pattern (e.g., all sections of the pattern), the control circuit may be configured to redistribute the on time T_{ON1}-T_{ON5} of the respective drive signal V_{DR1}-V_{DR5} across the sections of the pattern, such that the on time T_{ON1}-T_{ON5} of the respective drive signal V_{DR1}-V_{DR5} is greater than or equal to the limited minimum on time T_{ON-MIN-L} or zero seconds in the different sections of the pattern. Further, in some examples, such as when the redistribution of the on time results in a remainder, the control circuit may may be configured to minimize a number of sections of the pattern where the on times T_{ON1}-T_{ON5} of the respective drive signals V_{DR1}-V_{DR5} is less than the limited minimum on time T_{ON-MIN-L} (e.g., to one section of the pattern).

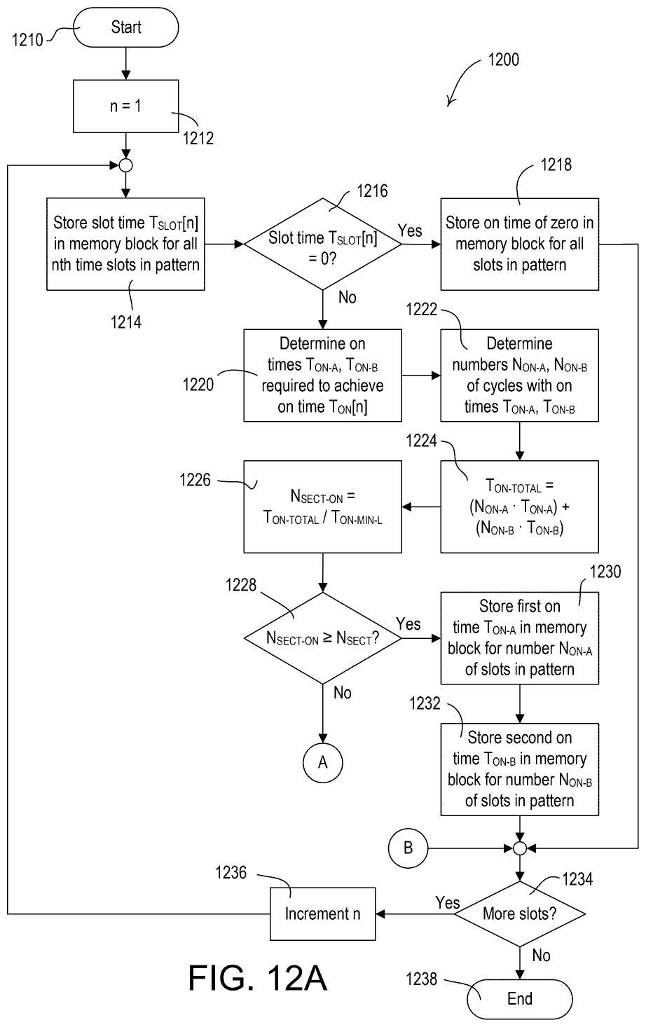

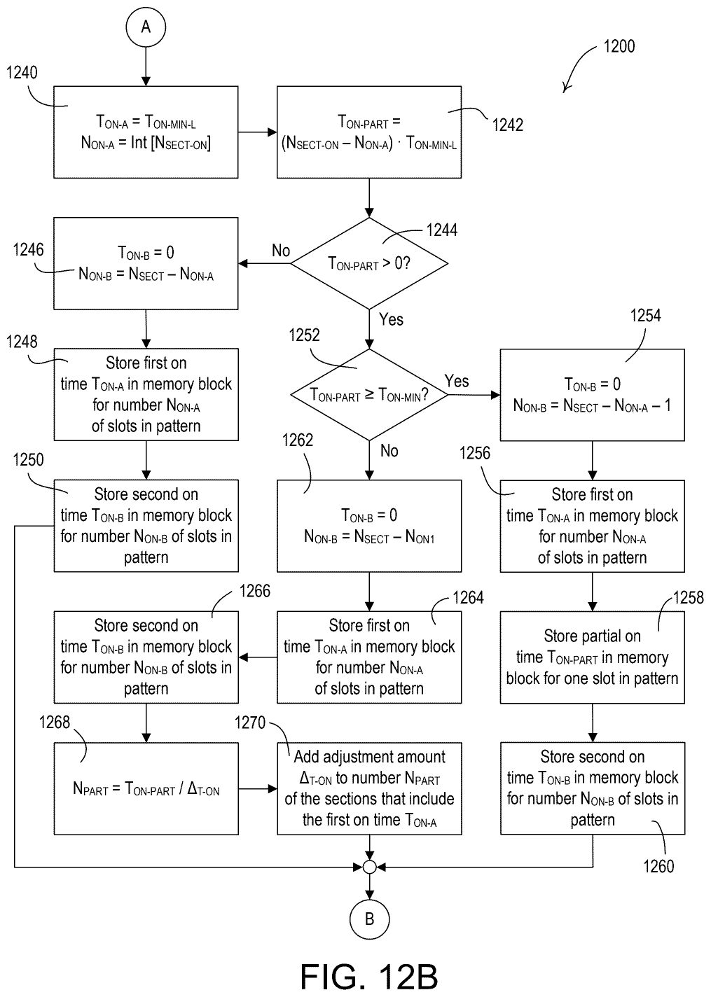

FIGS. 12A and 12B show a flowchart of another example procedure 1200 for controlling a light source at a load control device (e.g., one of the load control devices of FIG. 1, such as the dimmer switch 110, the LED driver 120, and/or the controllable light source 130, and/or the driver module 220 of FIG. 2) where at least one of the on times T_{ON1}-T_{ON5} of the respective drive signals V_{DR1}-V_{DR5} is adjusted to a value between two of the achievable on times. The control procedure 1050 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to generate drive signals V_{DR1}-V_{DR5} for controlling the respective LED drive circuits. The control circuit may be configured to generate the drive signals V_{DR1}-V_{DR5} to control a color of the cumulative light emitted by the light source towards a target color temperature T_{TRGT} (e.g., when operating in a color-temperature-control mode) or a target color value (e.g., when operating in a full-color-control mode). For example, the control circuit may execute the procedure 1200 at 1210 periodically and/or in response to receiving the message or user command comprising a color-temperature-adjustment command a full-color-adjustment command, or an intensity adjustment command. The control circuit may be configured to execute the procedure 1200, for example, at 818 of the procedure 800 shown in FIG. 8.

The control circuit may be configured to execute the procedure 1200 to configure one or more peripherals of the control circuit to generate the drive signals V_{DR1}-V_{DR5} based on the duty cycles d₁-d₅. In addition, the control circuit may be configured to execute the procedure 1200 to store a pattern (e.g., such as the pattern 1170) defining respective on times T_{ON1}-T_{ON5} and respective slot times T_{SLOT1}-T_{SLOT5} for generating the drive signals V_{DR1}-V_{DR5} (e.g., as determined at 816 of the procedure 800) in memory (e.g., the memory 277b). For example, the pattern may comprise a plurality of sections (e.g., such as the sections 1172) that occur during a number of consecutive cycles of operation of the load control device. Each of the sections of the pattern may define respective on times T_{ON1}-T_{ON5} and/or respective slot times T_{SLOT1}-T_{SLOT5} for one of the cycles of operation of the load control device. For example, the sections of the pattern that are associated with a particular on time T_{ON1}-T_{ON5} and respective slot times T_{SLOT1}-T_{SLOT5} (e.g., and associated with a particular drive signal and emitter circuit) may define different, discrete values (e.g., two different achievable on times) for the on time across different sections of the pattern (e.g., or cycles of operation of the load control device). As such, the control circuit may be configured to adjust (e.g., dither) the on time between two discrete values (e.g., achievable on times) that are spaced apart by the adjustment amount Δ_{T-ON} by storing a pattern that comprises a plurality of sections (e.g., steps) that occur during consecutive cycles of operation of the load control device. For example, the pattern may comprise a number N_{SECT} of the sections (e.g., 32 sections).

During the procedure 1200, the control circuit may use a variable n to keep track of the time slot that the control circuit is presently configuring. At 1212, the control circuit may initialize a variable n to one. At 1214, the control circuit may store a slot time T_{SLOT}[n] for the appropriate memory location for the nth time slot in each of the sections in the pattern in the block of memory (e.g., the edit block). For example, the first time that 1214 is executed during the procedure 1200, the control circuit may store the first slot time T_{SLOT1} in the memory locations 1160 for the first time slot in each of the sections 1172 of the pattern 1170 in the block 1150 of memory.

At 1216, the control circuit may determine whether the slot time T_{SLOT}[n] for the nth time slot is equal to zero seconds. If so, the control circuit may store an on time of zero seconds in the appropriate memory location of each of the sections in the pattern in the block of memory at 1218. For example, when the slot time T_{SLOT}[n] for the nth time slot is equal to zero seconds during the first time that 1216 is executed during the procedure 1200, the control circuit may store the first on time T_{ON1} as an on time of zero seconds in the memory location 1160 for the first time slot in each of the sections 1172 of the pattern 1170 in the block 1150 of memory at 1218.

When the slot time T_{SLOT}[n] for the nth time slot is not equal to zero at 1216, the control circuit may determine first and second on times T_{ON-A}, T_{ON-B} required to achieve the on time T_{ON}[n] for the nth time slot at 1220. At 1222, the control circuit may determine a first number N_{ON-A} of the sections of the pattern during which the control circuit may adjust the on time T_{ON}[n] for the nth time slot to the first on time T_{ON-A} and a second number N_{ON-B} of the sections of the pattern during which the control circuit may adjust the on time T_{ON}[n] for the nth time slot to the second on time T_{ON-B}.

In some cases, the on time T_{ON}[n] for the nth time slot is an achievable on time (e.g., is a multiple of the adjustment amount Δ_{T-ON}). When the on time T_{ON}[n] for the nth time slot is an achievable on time, the control circuit may set the first on time T_{ON-A} equal to the on time T_{ON}[n] for the nth time slot (e.g., and set the second on time T_{ON-B} equal to zero seconds) at 1220. In addition, the control circuit may set the first number N_{ON-A} of the sections of the pattern with the first on time T_{ON-A} equal to the number N_{SECT} of sections in the pattern (e.g., and set the second number N_{ON-B} of the sections of the pattern with the second on time T_{ON-B} equal to zero) at 1222. That is, when the on time T_{ON}[n] for the nth time slot is an achievable on time, the control circuit may set all of the sections of the pattern equal to the on time T_{ON}[n] for the nth time slot.

In other cases, the on time T_{ON}[n] for the nth time slot is not an achievable on time (e.g., is not a multiple of the adjustment amount Δ_{T-ON}). For example, when the on time T_{ON}[n] for the nth time slot is not an achievable on time, the control circuit may set the first on time T_{ON-A} equal to a next-highest achievable on time T_{ON-HI} and set the second on time T_{ON-B} equal to a next-lowest achievable on time T_{ON-LO} at 1220. For example, when the adjustment amount Δ_{T-ON} is one microsecond and the on time T_{ON}[n] is 192.5 microseconds, the control circuit may be configured to determine the next-highest achievable on time T_{ON-HI} as 193 microseconds and the next-lowest achievable on time T_{ON-LO} at 192 at 1220. In addition, when the on time T_{ON}[n] for the nth time slot is not an achievable on time, the control circuit may determine (e.g., calculate) the first number N_{ON-A} of the sections of the pattern with the first on time T_{ON-A} at 1220 as a function of the on time T_{ON}[n] for the nth time slot, the second on time T_{ON-B}, the adjustment amount Δ_{T-ON}, and the number N_{SECT} of the sections in the pattern, e.g.,

$${N}_{ON - A} = [ ( {T}_{ON} [ n ] - {T}_{ON - B} ) / {Δ}_{T - ON} ] \cdot {N}_{SECT} .$$

Further, the control circuit may set the second number N_{ON-B} of the sections of the pattern with the second on time T_{ON-B} at 1220 equal to the remaining number of sections in the pattern, e.g., the difference between the number N_{SECT} of the sections in the pattern and the first number N_{ON-A} of the sections of the pattern (e.g., N_{ON-B}=N_{SECT}−N_{ON-A}).

In other cases, the on time T_{ON}[n] for the nth time slot may be less than a minimum on time T_{ON-MIN} (e.g., an absolute minimum on time that is less than the limited minimum on time T_{ON-MIN-L}). For example, when the on time T_{ON}[n] for the nth time slot is less than the minimum on time T_{ON-MIN}, the control circuit may set the first on time T_{ON-A} equal to the minimum on time T_{ON-MIN} and set the second on time T_{ON-B} equal to zero seconds at 1220. In addition, when the on time T_{ON}[n] for the nth time slot is less than the minimum on time T_{ON-MIN}, the control circuit may determine (e.g., calculate) the first number N_{ON-A} of the sections of the pattern with the first on time T_{ON-A} at 1220 as a function of the on time T_{ON}[n] for the nth time slot, the minimum on time T_{ON-MIN}, and the number N_{SECT} of the sections in the pattern, e.g.,

$${N}_{ON} = ( {T}_{ON} [ n ] / {T}_{ON - MIN} ) \cdot {N}_{SECT} .$$

Further, the control circuit may set the second number N_{ON-B} of the sections of the pattern with the second on time T_{ON-B} at 1220 equal to the remaining number of sections in the pattern, e.g., the difference between the number N_{SECT} of the sections in the pattern and the first number N_{ON-A} of the sections of the pattern (e.g., N_{ON-B}=N_{SECT}−N_{ON-A}).

As previously mentioned, when the light source is a linear light source, the control circuit may be configured to set the on times T_{ON1}-T_{ON5} of the respective drive signal V_{DR1}-V_{DR5} such each of the on times T_{ON1}-T_{ON5} is at least as long as the limited minimum on time T_{ON-MIN-L} during each of the sections of the pattern (e.g., in as many of the sections as possible and unless the on time is set to zero seconds). The control circuit may be configured to determine whether the on time T_{ON}[n] for the nth time slot is greater than (e.g., greater than or equal to) the limited minimum on time T_{ON-MIN-L} within the sections (e.g., within all of the sections) of the pattern. For example, the control circuit may be configured to determine whether the on time T_{ON}[n] for the nth time slot is greater than or equal to the limited minimum on time T_{ON-MIN-L} for all of the sections of the pattern based on a total on time T_{ON-TOTAL} for the nth time slot during the pattern. At 1224, the control circuit may determine the total on time T_{ON-TOTAL} for the nth time slot during the pattern. For example, the control circuit may be configured to determine (e.g., calculate) the total on time T_{ON-TOTAL} by summing the on times T_{ON}[n] for the nth time slot from the sections of the pattern (e.g., from all of the sections of the pattern). In addition, the control circuit may be configured to determine (e.g., calculate) the total on time T_{ON-TOTAL} as a function of the first and second on times T_{ON-A}, T_{ON-B} and the first and second numbers N_{ON-A}, N_{ON-B}, e.g.,

$${T}_{ON - TOTAL} = ( {N}_{ON - A} \cdot {T}_{ON - A} ) + ( {N}_{ON - B} \cdot {T}_{ON - B} ) .$$

At 1226, the control circuit may determine a number N_{SECT-ON} of sections of the pattern during which the on time T_{ON}[n] for the nth time slot may be set equal to the limited minimum on time T_{ON-MIN-L}. For example, the control circuit may determine (e.g., calculate) the number N_{SECT-ON} of sections of the pattern as a function of the total on time T_{ON-TOTAL} and the limited minimum on time T_{ON-MIN-L}, e.g.,

$${N}_{SECT - ON} = {T}_{ON - TOTAL} / {T}_{ON - MIN - L} .$$

At 1228, the control circuit may be configured to determine whether the on time T_{ON}[n] for the nth time slot is greater than or equal to the limited minimum on time T_{ON-MIN-L} within all of the sections of the pattern by comparing the number N_{SECT-ON} of sections of the pattern during which the on time T_{ON}[n] for the nth time slot is greater than or equal to the limited minimum on time T_{ON-MIN-L} to the number of sections N_{SECT} in the pattern. For example, the control circuit may be configured to determine whether the on time T_{ON}[n] for the nth time slot is greater than or equal to the limited minimum on time T_{ON-MIN-L} within all of the sections of the pattern when the number N_{SECT-ON} is greater than or equal to the number of sections N_{SECT} in the pattern.

When the number N_{SECT-ON} is greater than or equal to the number of sections N_{SECT} in the pattern at 1228, the control circuit may store the first on time T_{ON-A} in the appropriate memory locations for the nth time slot in each of the first number N_{ON-A} of the sections in the pattern in the block of memory at 1230. In addition, the control circuit may store the second on time T_{ON-B} in the appropriate memory locations for the nth time slot in each of the second number N_{ON-B} of the sections in the pattern (e.g., the remaining sections in the pattern) in the block of memory at 1232. At 1234, the control circuit may determine if there are more slots to configure. If there are more slots to configure at 1234, the control circuit may increment the variable n at 1236 and store the slot time T_{SLOT}[n] for the next time slot at 1214. The control circuit may continue to store slot times and on times in the memory block until there are no more slots to configure. When there are no more slots to configure at 1234, the procedure 1200 may end at 1238.

Further, as noted herein, the control circuit may, at 1232, equally space apart the number N_{HI} of the sections in the pattern (e.g., that include the next-highest achievable on time T_{ON-HI}) in the block of memory, for example, as described with respect to 1072 through 1082 of the procedure 1030. As noted, this ordering may ensure that the next-highest achievable on time T_{ON-HI} is equally distributed (e.g., symmetrically spaced) throughout the pattern in the block of memory. However, in other examples, the control circuit may distribute the on times having different values differently throughout the sections in the pattern (e.g., by grouping sections having the same value together in the pattern).

Referring to FIG. 12B, when the number N_{SECT-ON} is not greater than or equal to the number of sections N_{SECT} in the pattern (e.g., the number N_{SECT-ON} is less than the number of sections N_{SECT} in the pattern) at 1228, the control circuit may be configured to define the pattern such each of the on times T_{ON}[n] for the nth time slot is at least as long as the limited minimum on time T_{ON-MIN-L} within each of the sections of the pattern (e.g., in as many of the sections as possible). At 1240, the control circuit may determine the first number N_{ON-A} of the sections of the pattern during which the control circuit may adjust the on time T_{ON}[n] to the limited minimum on time T_{ON-MIN-L}. For example, the control circuit may at 1240 set the first on time T_{ON-A} equal to the limited minimum on time T_{ON-MIN-L} and set the first number N_{ON-A} equal to the integer portion (e.g., the floor) of the number N_{SECT-ON} of sections of the pattern during which the on time T_{ON}[n] for the nth time slot may be equal to the limited minimum on time T_{ON-MIN-L} (e.g., as calculated at 1226). At 1242, the control circuit may determine a partial on time T_{ON-PART} that remains after the first number N_{ON-A} of sections of the pattern are set to the limited minimum on time T_{ON-MIN-L}. For example, the control circuit may be configured to determine (e.g., calculate) the partial on time T_{ON-PART} based on the number N_{SECT-ON}, the first number N_{ON-A}, and the limited minimum on time T_{ON-MIN-L}, e.g.,

$${T}_{ON - PART} = ( {N}_{SECT - ON} - {N}_{ON - A} ) \cdot {T}_{ON - MIN - L} .$$

For example, the control circuit may use the partial on time T_{ON-PART} to finish defining the pattern, for example, by setting the second number N_{ON-B} of the sections of the pattern during which the control circuit may adjust the on time T_{ON}[n] to zero seconds.

At 1244, the control circuit may determine whether the partial on time T_{ON-PART} is greater than zero seconds (e.g., whether there is a remainder of the total on time T_{ON-TOTAL} after the first number N_{ON-A} of sections of the pattern are set to the limited minimum on time T_{ON-MIN-L}). When the partial on time T_{ON-PART} is not greater than zero seconds (e.g., is equal to zero seconds) at 1244, the control circuit may at 1246 set the second on time T_{ON-B} equal to zero seconds and set the second number N_{ON-B} equal to the difference between the number of sections N_{SECT} in the pattern and the first number N_{ON-A} of the sections of the pattern during which the control circuit may adjust the on time T_{ON}[n] to the limited minimum on time T_{ON-MIN-L} (e.g., N_{ON-B}=N_{SECT}−N_{ON-A}). At 1248, the control circuit may store the first on time T_{ON-A} (e.g., the limited minimum on time T_{ON-MIN-L}) in the appropriate memory locations for the nth time slot in each of the first number N_{ON-A} of the sections in the pattern in the block of memory. In addition, the control circuit may store the second on time T_{ON-B} (e.g., zero seconds) in the appropriate memory locations for the nth time slot in each of the second number N_{ON-B} of the sections in the pattern (e.g., the remainder of the sections in the pattern) in the block of memory at 1250. As shown in FIG. 12A, if there are more slots to configure at 1234, the control circuit may increment the variable n at 1236 and store the slot time T_{SLOT}[n] for the next time slot at 1214. If there are no more slots to configure at 1234, the procedure 1200 may end at 1238.

Further, as noted herein, the control circuit may, at 1248 and 1250, equally space apart the number N_{HI} of the sections in the pattern (e.g., that include the next-highest achievable on time T_{ON-HI}) in the block of memory, for example, as described with respect to 1072 through 1082 of the procedure 1030. As noted, this ordering may ensure that the next-highest achievable on time T_{ON-HI} is equally distributed (e.g., symmetrically spaced) throughout the pattern in the block of memory. However, in other examples, the control circuit may distribute the on times having different values differently throughout the sections in the pattern (e.g., by grouping sections having the same value together in the pattern).

When the partial on time T_{ON-PART} is greater than zero seconds at 1244, the control circuit may determine whether the partial on time T_{ON-PART} is greater than (e.g., greater than or equal to) the minimum on time T_{ON-MIN} (e.g., the absolute minimum on time) at 1252. When the partial on time T_{ON-PART} is greater than or equal to the minimum on time T_{ON-MIN} at 1252, the control circuit may be configured to set the on time T_{ON}[n] for the nth time slot for one of the sections of the pattern equal to the partial on time T_{ON-PART}. At 1254, the control circuit may set the second on time T_{ON-B} equal to zero seconds and set the second number N_{ON-B} equal to one less than the difference between the number of sections N_{SECT} in the pattern and the first number N_{ON-A} of the sections of the pattern during which the control circuit may adjust the on time T_{ON}[n] to the limited minimum on time T_{ON-MIN-L} (e.g., N_{ON-B}=N_{SECT}−N_{ON-A}−1). At 1256, the control circuit may store the first on time T_{ON-A} (e.g., the limited minimum on time T_{ON-MIN-L}) in the appropriate memory locations for the nth time slot in each of the first number N_{ON-A} of the sections in the pattern in the block of memory. In addition, the control circuit may store the partial on time T_{ON-PART} in the appropriate memory location for the nth time slot in one of the sections in the pattern in the block of memory at 1258. Further, the control circuit may store the second on time T_{ON-B} (e.g., zero seconds) in the appropriate memory locations for the nth time slot in each of the second number N_{ON-B} of the sections in the pattern (e.g., the remainder of the sections in the pattern) in the block of memory at 1260. As shown in FIG. 12A, if there are more slots to configure at 1234, the control circuit may increment the variable n at 1236 and store the slot time T_{SLOT}[n] for the next time slot at 1214. If there are no more slots to configure at 1234, the procedure 1200 may end at 1238.

Further, as noted herein, the control circuit may, at 1256 and 1260, equally space apart the number N_{HI} of the sections in the pattern (e.g., that include the next-highest achievable on time T_{ON-HI}) in the block of memory, for example, as described with respect to 1072 through 1082 of the procedure 1030. As noted, this ordering may ensure that the next-highest achievable on time T_{ON-HI} is equally distributed (e.g., symmetrically spaced) throughout the pattern in the block of memory. Additionally, since control circuit may store the partial on time T_{ON-PART} within the memory in a manner that also ensures that it provides an even distribution of time across the pattern at 1258. However, in other examples, the control circuit may distribute the on times having different values differently throughout the sections in the pattern (e.g., by grouping sections having the same value together in the pattern).

When the partial on time T_{ON-PART} is not greater than or equal to the minimum on time T_{ON-MIN} (e.g., when the partial on time T_{ON-PART} is less than the minimum on time T_{ON-MIN}) at 1252, the control circuit may be configured to spread the partial on time T_{ON-PART} across one or more of the sections of the pattern that have on times T_{ON}[n] for the nth time slot set to the limited minimum on time T_{ON-MIN-L}. At 1262, the control circuit may set the second on time T_{ON-B} equal to zero seconds and set the second number N_{ON-B} equal to the difference between the number of sections N_{SECT} in the pattern and the first number N_{ON-A} of the sections of the pattern during which the control circuit may adjust the on time T_{ON}[n] to the limited minimum on time T_{ON-MIN-L} (e.g., N_{ON-B}=N_{SECT}−N_{ON-A}). At 1264, the control circuit may store the first on time T_{ON-A} (e.g., the limited minimum on time T_{ON-MIN-L}) in the appropriate memory locations for the nth time slot in each of the first number N_{ON-A} of the sections in the pattern in the block of memory. In addition, the control circuit may store the second on time T_{ON-B} (e.g., zero seconds) in the appropriate memory locations for the nth time slot in each of the second number N_{ON-B} of the sections in the pattern (e.g., the remainder of the sections in the pattern) in the block of memory at 1266. At 1268, the control circuit may determine a number N_{PART} of the sections of the pattern (e.g., of the first number N_{ON-A} of sections of the pattern) to which to add a portion of the partial on time T_{ON-PART} (e.g., where the portion of the partial on time T_{ON-PART} may be equal to the adjustment amount Δ_{T-ON}). For example, the control circuit may be configured to determine (e.g., calculate) at 1268 the number N_{PART} based on the partial on time T_{ON-PART} and the adjustment amount Δ_{T-ON} (e.g., N_{PART}=T_{ON-PART}/Δ_{T-ON}). At 1270, the control circuit may be configured to add the adjustment amount Δ_{T-ON} to the number N_{PART} of the sections of the pattern that have on times T_{ON}[n] for the nth time slot set to the first on time T_{ON-A} (e.g., the limited minimum on time T_{ON-MIN-L}). As shown in FIG. 12A, if there are more slots to configure at 1234, the control circuit may increment the variable n at 1236 and store the slot time T_{SLOT}[n] for the next time slot at 1214. If there are no more slots to configure at 1234, the procedure 1200 may end at 1238.

Further, as noted herein, the control circuit may, at 1264 and 1266, equally space apart the number N_{HI} of the sections in the pattern (e.g., that include the next-highest achievable on time T_{ON-HI}) in the block of memory, for example, as described with respect to 1072 through 1082 of the procedure 1030. As noted, this ordering may ensure that the next-highest achievable on time T_{ON-HI} is equally distributed (e.g., symmetrically spaced) throughout the pattern in the block of memory. However, in other examples, the control circuit may distribute the on times having different values differently throughout the sections in the pattern (e.g., by grouping sections having the same value together in the pattern).

Additionally, in some examples, if the partial on time T_{ON-PART} is greater than the minimum on time T_{ON-MIN} at 1252, the control circuit may be configured to equally distribute the partial on time T_{ON-PART} across the sections of the pattern that have on times T_{ON}[n] for the nth time slot set to the first on time T_{ON-A} (e.g., based on the process described with reference to 1268-1270). Accordingly, in this alternative, 1252 through 1260 of the procedure 1200 could be omitted and the procedure may progress from 1244 to 1262 if the partial on time T_{ON-PART} is greater than zero seconds (e.g., is equal to zero seconds) at 1244.

Additionally, in some examples, the control circuit may be configured to ignore the partial on time T_{ON-PART} (e.g., set the partial on time T_{ON-PART} to zero seconds). The control circuit may ignore the partial on time T_{ON-PART} when the partial on time T_{ON-PART} is less than the minimum on time T_{ON-MIN} at 1252, when the partial on time T_{ON-PART} is greater than or equal to the minimum on time T_{ON-MIN} at 1252, or in both instances. For instance, when the partial on time T_{ON-PART} is less than the minimum on time T_{ON-MIN} at 1252, the control circuit may set the partial on time T_{ON-PART} to zero seconds (e.g., as opposed to determining a number N_{PART} of the sections of the pattern and adding this number N_{PART} of the sections of the pattern at 1268 and 1270). Accordingly, in this alternative, 1268 and 1270 of the procedure 1200 would be omitted. For instance, when the partial on time T_{ON-PART} is greater than or equal to the minimum on time T_{ON-MIN} at 1252, the control circuit may set the partial on time T_{ON-PART} to zero seconds (e.g., as opposed to storing the partial on time T_{ON-PART} in a single memory block at 1258). Accordingly, in this alternative, 1254 of the procedure 1200 would be changed to mirror 1262, and 1260 could be omitted from the procedure 1200.

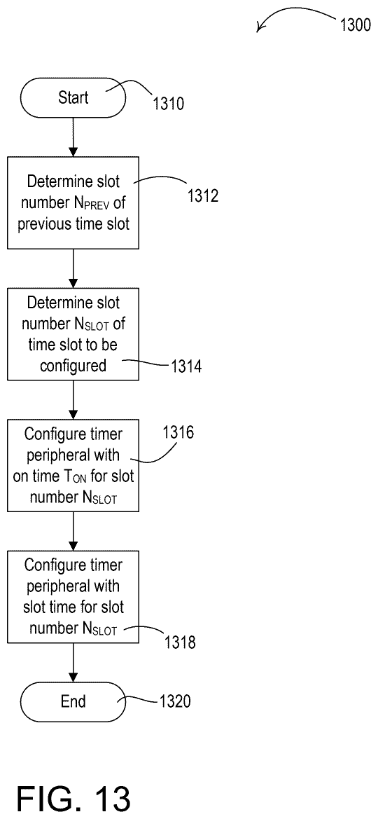

FIG. 13 is a flowchart of an example procedure 1300 for controlling a light source at a load control device (e.g., one of the load control devices of FIG. 1, such as the dimmer switch 110, the LED driver 120, and/or the controllable light source 130, and/or the driver module 220 of FIG. 2). The control procedure 1300 may be executed by a control circuit of the load control device (e.g., a control circuit of one of the load control devices of FIG. 1, and/or the control circuit 226 of the driver module 220 of FIG. 2). The light source may comprise a plurality of emitter circuits (e.g., up to five emitter circuits 211-215 as shown in FIG. 2). The load control device may comprise a plurality of LED drive circuits (e.g., the five LED drive circuits 221-225 as shown in FIG. 2) for controlling (e.g., individually controlling) the emitter circuits of the light source. The control circuit may be configured to use a timer peripheral to generate drive signals V_{DR1}-V_{DR5} for controlling the respective LED drive circuits. In addition, the control circuit may use a peripheral DMA controller to configure the timer peripheral for generating the drive signals V_{DR1}-V_{DR5}. The control circuit (e.g., the peripheral DMA controller) may be configured to execute the procedure 1300 to configured the timer peripheral with respective on times T_{ON1}-T_{ON5} and/or respective slot times T_{SLOT1}-T_{SLOT5} for generating the drive signals V_{DR1}-V_{DR5} (e.g., as determined during the procedure 900 shown in FIG. 9). The control circuit may start the procedure 1300 at 1310. For example, the control circuit (e.g., the peripheral DMA controller) may execute the procedure 1300 in response to a timer overflow event that may be generated when a timer count of one of the channels of the timer peripheral overflows.

At 1312, the control circuit (e.g., the peripheral DMA controller) may be configured to determine a slot number N_{PREV} of the previous time slot (e.g., the time slot of the timer channel for which the timer overflow event was generated at 1310). For example, at the timer overflow event for the first channel of the timer peripheral (e.g., at the end of the first time slot 401 and during the second time slot 402 as shown in FIG. 4A-4C), the control circuit may be configured to set the slot number N_{PREV} of the previous time slot equal to one at 1312.

At 1314, the control circuit (e.g., the peripheral DMA controller) may be configured to determine a slot number N_{SLOT} of the time slot to be configured. The control circuit may be configured to set the slot number N_{SLOT} of the time slot to be configured to be, for example, two time slots after the previous time slot that has the slot number N_{PREV} (e.g., as determined at 1312). For example, when the slot number N_{PREV} of the previous time slot is equal to one at 1314, the control circuit may be configured to set the slot number N_{SLOT} of the time slot to be configured to three. In addition, when the slot number of the previous time slot is equal to four or five at 1314, the control circuit may be configured to set the slot number N_{SLOT} of the time slot to be configured to one or two, respectively (e.g., since there the time slots are configured to repeat during each cycle of operation of the driver module 220).

The control circuit (e.g., the peripheral DMA controller) may configure the timer peripheral with the on time for the time slot having the slot number N_{SLOT} at 1316 and may configure the timer peripheral with the slot time for the time slot having the slot number N_{SLOT} at 1318, before the procedure 1300 ends at 1320. The control circuit may be configured to retrieve data (e.g., the on time and/or the slot time) for configuring the timer peripheral from a block (e.g., an execute block) in memory (e.g., the memory 227b). For example, when the slot number N_{SLOT} for the time slot to be configured is equal to three, the control circuit may configure the timer peripheral with the third on time T_{ON3} at 1316 and with the third slot time T_{SLOT3} at 1318.

What is claimed is:

1. A load control device for controlling a light source comprises a plurality of emitter circuits, the load control device comprising:
a first drive circuit configured to control a first emitter circuit of the light source, a second drive circuit configured to control a second emitter circuit of the light source, and a third drive circuit configured to control a third emitter circuit of the light source; and
a control circuit configured to generate first, second, and third drive signals for controlling each of the first, second, and third drive circuits, respectively, to adjust a present color of cumulative light emitted by the plurality of emitter circuits towards a target color, the control circuit configured to pulse-width modulate the first, second, and third drive signals on a periodic basis at an operating period, where each period of operation comprises at least three time slots; and
wherein the control circuit is configured to generate a first pulse in the first drive signal for at least a portion of a first time slot of the at least three time slots of each cycle of operation, generate a second pulse in the second drive signal for at least a portion of a second time slot of the at least three time slots of each cycle of operation, and generate a third pulse in the third drive signal for at least a portion of a third time slot of the at least three time slots of each cycle of operation, the control circuit configured to determine first, second, and third on times of the first, second, and third drive signals of the first, second, and third pulses, respectively, based on the target color.

2. The load control device of claim 1, wherein the control circuit is configured to generate the first, second, and third pulses to be characterized by the first, second, and third on times, respectively, and wherein each of the first, second, and third time slots are characterized by first, second, and third slot times, respectively.

3. The load control device of claim 2, wherein a peripheral direct-memory access controller is configured to reconfigure a timer peripheral for generation of at least one of the first, second, and third drive signals during a subsequent time slot.

4. The load control device of claim 3, further comprising:
a memory configured to store data for reconfiguring the timer peripheral;
wherein the peripheral direct-memory access controller is configured to retrieve data representing the first, second, and third on times of the first, second, and third pulses, respectively from the memory for reconfiguring the timer peripheral.

5. The load control device of claim 4, wherein the data retrieved from the memory represents the first, second, and third on times of the first, second, and third pulses, respectively, and the first, second, and third slot times of the first, second, and third time slots, respectively.

6. The load control device of claim 5, wherein, in response to a change in the target color, the control circuit is configured to store updated data in the memory for subsequent retrieval by the peripheral direct-memory access controller of the control circuit.

7. The load control device of claim 6, wherein the control circuit is configured to determine duty cycles for determining the first, second, and third on times of the first, second, and third pulses, respectively, in response to the target color.

8. The load control device of claim 7, wherein, when a target intensity level for controlling the cumulative light emitted by the light source is less than a high-end intensity level, the control circuit is configured to set the duty cycles such that a dead time exists during which the control circuit does not generate any of the first, second, and third pulses of the first, second, and third drive signals, respectively.

9. The load control device of claim 8, wherein, when the target intensity level is less than the high-end intensity level, the control circuit is configured to set the duty cycles such that the dead time exists during the one of the first, second, and third time slots that has the one of the first, second, and third pulses that has the shortest on time, respectively.

10. The load control device of claim 8, wherein, when the target intensity level is less than the high-end intensity level, the control circuit is configured to set the duty cycles such that at least one of the first, second, and third on times is less than at least one of the first, second, and third slot times, respectively.

11. The load control device of claim 7, wherein, when a target intensity level for controlling the cumulative light emitted by the light source is equal to a high-end intensity level, the control circuit is configured to set the duty cycles such that a sum of the first, second, and third on times of the first, second, and third pulses, respectively, is approximately equal to the operating period.

12. The load control device of claim 11, wherein, when the target intensity level is equal to the high-end intensity level, the control circuit is configured to set the duty cycles such that the sum of the first, second, and third on times are approximately equal to the first, second, and third slot times, respectively.

13. The load control device of claim 6, wherein, when one of the first, second, and third on times is less than a minimum slot time, the control circuit is configured to generate the first, second, and third drive signals, such that two of the first, second, and third pulses at least partially overlap.

14. The load control device of claim 13, wherein the one of the first, second, and third on times that is less than the minimum slot time is also less than a maximum overlap time.

15. The load control device of claim 2, wherein the control circuit is configured to use a timer peripheral to generate the first, second, and third drive signals; and
wherein, during the second time slot, the control circuit is configured to configure the timer peripheral for generation of the third drive signal during the third time slot.

16. (canceled)

17. The load control device of claim 15, wherein, during the second time slot, a peripheral direct-memory access controller of the control circuit reconfigures the timer peripheral for generation of the third drive signal during the third time slot.

18. The load control device of claim 17, wherein, during the second time slot, the peripheral direct-memory access controller of the control circuit is configured to reconfigure the timer peripheral for generation of the third drive signals during the third time slot in response to a timer overflow event during the first time slot.

19. The load control device of claim 2, wherein the control circuit is configured to adjust the first, second, and third on times of the first, second, and third pulses, respectively, from one period to a next period.

20. The load control device of claim 19, wherein the control circuit is configured to adjust the at one of the first, second, and third on times of the first, second, and third pulses, respectively, between two achievable on times from one period to the next period.

21. The load control device of claim 19, wherein the control circuit is configured to adjust the at one of the first, second, and third on times of the first, second, and third pulses, respectively, between a minimum on time and an on time of zero microseconds from one period to the next period.

22. The load control device of claim 2, wherein the control circuit is configured to repeat the generation the first, second, and third pulses to the first, second, and third time slots, respectively, during each period.

23. The load control device of claim 1, wherein the first, second, and third pulses are non-overlapping.

24. (canceled)

25. (canceled)

26. (canceled)

27. The load control device of claim 1, wherein the control circuit is configured to hold the operating period constant and adjust the first, second, and third on times by a minimum step size to generate the first, second, and third drive signals, respectively, based on the target color.

28. The load control device of claim 27, wherein the control circuit is configured to adjust at least one of the first, second, or third drive signals between two adjacent, achievable on times that are separated by the minimum step size during a number of consecutive cycles of operation based on the target color.

29. The load control device of claim 28, wherein the target color is associated with an on time that is not associated with an achievable on time as defined by the minimum step size.

30. The load control device of claim 28, wherein the control circuit is configured to store a pattern of on times associated with the first, second, and third drive signals in a memory of the load control device, wherein the pattern defines a plurality of sections, and wherein data stored in each section of the pattern represents the on times and the time slots for generating the first, second, and third drive signals during one period.

31. The load control device of claim 28, wherein the control circuit is configured to adjust the first, second, and third on times to discrete values that are spaced apart by the minimum step size, and wherein the target color is associated with an on time that is between two discrete values.

32-130. (canceled)
